(19) United States
(12) Patent Application Publication
(10) Pub. No.: US 2026/0244707 A1
(43) Pub. Date: Aug. 20, 2026

(54) AUTONOMOUS DATA ANALYTICS WITH REAL-TIME FEATURE SELECTION

(71) Applicant: ThoughtSpot, Inc., Mountain View, CA (US)

(72) Inventors: Manish Sonal, Hazaribagh (IN); Harsh Sinha, Bengaluru (IN); Pullakavi Janaki Phani Rahul, Hosur (IN); Akshay Mehra, Bengaluru (IN); Anuranjan Yadav, Bengaluru (IN)

(21) Appl. No.: 19/174,056

(22) Filed: Apr. 9, 2025

(30) Foreign Application Priority Data
Feb. 18, 2025 (IN) 202511013991

(51) Int. Cl. G06F 18/2113

(52) U.S. Cl. CPC G06F 18/2113

(57) ABSTRACT

Autonomous data analytics with real-time feature selection includes obtaining autonomous-analysis data in accordance with exploratory data portion identifiers and autonomous-analysis predicate data that indicates a predicate analytical object that represents a request for data analysis, wherein the autonomous-analysis data differs from requested results data responsive to the request for data analysis, and wherein obtaining the autonomous-analysis data includes obtaining, as exploratory data portion identifiers, a subset of data portion identifiers available in the data access and analysis system, the subset of data portion identifiers having a first defined maximum size, wherein obtaining the subset of data portion identifiers includes obtaining, by a relational analysis unit of the data access and analysis system, a first portion of the subset of data portion identifiers in accordance with the request for data analysis, data portion utility data stored in the data access and analysis system, and one or more defined utility heuristics.

### CROSS-REFERENCE TO RELATED APPLICATION(S)

This application claims priority to Indian Provisional Patent Application No. 202511013991, filed Feb. 18, 2025, the entire disclosure of which is hereby incorporated by reference.

### BACKGROUND

Advances in computer storage and database technology have led to exponential growth in the amount of data being created. Businesses are overwhelmed by the volume of the data stored in their computer systems. Existing database analytic tools are inefficient, costly to utilize, and require substantial configuration and training.

### SUMMARY

Disclosed herein are implementations of autonomous data analytics with real-time feature selection.

An aspect of the disclosure is a method of autonomous data analytics with real-time feature selection including obtaining, by an autonomous-analysis unit of a data access and analysis system, autonomous-analysis data in accordance with autonomous-analysis predicate data, wherein the autonomous-analysis predicate data indicates a predicate analytical object stored in the data access and analysis system as a representation of a request for data analysis with respect to data stored in a database accessible by the data access and analysis system, wherein the autonomous-analysis data differs from requested results data responsive to the request for data analysis, obtaining the autonomous-analysis data in accordance with the exploratory data portion identifiers, and outputting at least a portion of the autonomous-analysis data for presentation to a user. Obtaining the autonomous-analysis data may include obtaining, as exploratory data portion identifiers, a subset of data portion identifiers available in the data access and analysis system, the subset of data portion identifiers having a first defined maximum size. Obtaining the subset of data portion identifiers may include obtaining, by a relational analysis unit of the data access and analysis system, a first portion of the subset of data portion identifiers in accordance with the request for data analysis, data portion utility data stored in the data access and analysis system, and one or more defined utility heuristics.

Another aspect of the disclosure is a non-transitory computer-readable storage medium, comprising executable instructions that, when executed by a processor, facilitate performance of operations, comprising obtaining, by an autonomous-analysis unit of a data access and analysis system, autonomous-analysis data in accordance with autonomous-analysis predicate data, wherein the autonomous-analysis predicate data indicates a predicate analytical object stored in the data access and analysis system as a representation of a request for data analysis with respect to data stored in a database accessible by the data access and analysis system, wherein the autonomous-analysis data differs from requested results data responsive to the request for data analysis, obtaining the autonomous-analysis data in accordance with the exploratory data portion identifiers, and outputting at least a portion of the autonomous-analysis data for presentation to a user. Obtaining the autonomous-analysis data may include obtaining, as exploratory data portion identifiers, a subset of data portion identifiers available in the data access and analysis system, the subset of data portion identifiers having a first defined maximum size. Obtaining the subset of data portion identifiers may include obtaining, by a relational analysis unit of the data access and analysis system, a first portion of the subset of data portion identifiers in accordance with the request for data analysis, data portion utility data stored in the data access and analysis system, and one or more defined utility heuristics.

Another aspect of the disclosure is an apparatus for use in a data access and analysis system. The apparatus includes a non-transitory computer readable medium and a processor configured to execute instructions stored on the non-transitory computer readable medium to obtain autonomous-analysis data in accordance with autonomous-analysis predicate data, wherein the autonomous-analysis predicate data indicates a predicate analytical object stored in the data access and analysis system as a representation of a request for data analysis with respect to data stored in a database accessible by the data access and analysis system, wherein the autonomous-analysis data differs from requested results data responsive to the request for data analysis, obtain the autonomous-analysis data in accordance with the exploratory data portion identifiers, and output at least a portion of the autonomous-analysis data for presentation to a user. To obtain the autonomous-analysis data, the processor is configured to execute the instructions to obtain, as exploratory data portion identifiers a subset of data portion identifiers available in the data access and analysis system, the subset of data portion identifiers having a first defined maximum size. To obtain the subset of data portion identifiers, the processor is configured to execute the instructions to obtain a first portion of the subset of data portion identifiers in accordance with the request for data analysis, data portion utility data stored in the data access and analysis system, and one or more defined utility heuristics.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a block diagram of an example of a computing device.

FIG. 2 is a block diagram of an example of a computing system.

FIG. 3 is a block diagram of an example of a low-latency data access and analysis system.

FIG. 4 is a flow diagram of an example of autonomous data analytics with real-time feature selection in a data access and analysis system.

FIG. 5 is a flow diagram of an example of obtaining exploratory data in a data access and analysis system.

FIG. 6 is a flow diagram of an example of obtaining a set of accepted candidate data portion identifiers, a set of rejected candidate data portion identifiers, or both in a data access and analysis system.

FIG. 7 is a block diagram of an example of a subset of analytical objects and a co-occurrence frequency graph corresponding thereto.

### DETAILED DESCRIPTION

Businesses and other organizations store large amounts of data, such as business records, transaction records, and the like, in data storage systems, such as relational database systems that store data as records, or rows, having values, or fields, corresponding to respective columns in tables that can be interrelated using key values. Database structures are often normalized or otherwise organized to maximize data density and to maximize transactional data operations at the expense of increased complexity and reduced accessibility for analysis. Individual records and tables may have little or no utility without substantial correlation, interpretation, and analysis. The complexity of these data structures and systems, the large volumes of data that can be stored therein, and the processing of such data and requests to access such data, result in high utilization of system resources, such as computational and communications resources, and limit the accessibility and the utility of the systems and data stored therein.

To improve the accessibility and utility of these systems, and the data stored therein, system interfaces may be implemented. For example, a database, or a database management system, may implement a defined structured query language and one or more interfaces for obtaining, processing, and responding to code expressed in accordance with the defined structured query language. In another example, a system may implement one or more interfaces, such as graphical user interfaces or application programming interfaces, which may be utilized for specific, narrowly defined, purposes.

Implementing and utilizing such systems and interfaces may inefficiently utilize system resources, increase risk with respect to performance, reliability, security, and accuracy, and limit access to and the use of the data. Furthermore, the complexity of the data structures, and the large volume of the data (e.g., millions or billions of rows) stored therein may render access to or the use of some data impracticable or impossible to achieve by the human mind using the tools that are available for accessing these systems.

The data access and analysis system described herein improves the efficiency with which system resources are utilized to access and use data, reduces the risks associated with the access and use of data, and increases access to and the utility of the data. For example, the data access and analysis system described herein by automatically identifying and prioritizing data based on probabilistic utility and contextual co-occurrence, to create or surface autonomous-analysis data other than data expressly requested.

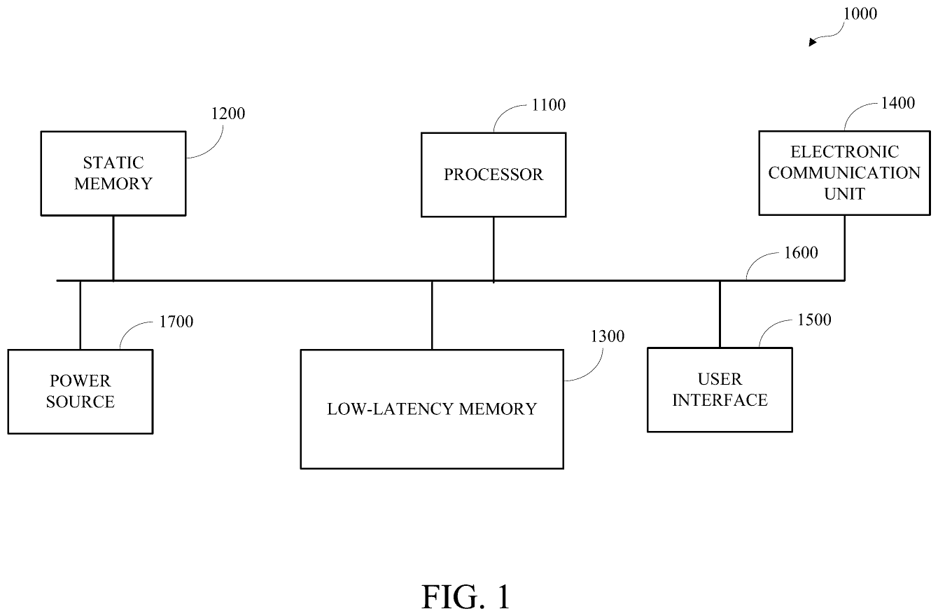

FIG. 1 is a block diagram of an example of a computing device 1000. One or more aspects of this disclosure may be implemented using the computing device 1000. The computing device 1000 includes a processor 1100, static memory 1200, low-latency memory 1300, an electronic communication unit 1400, a user interface 1500, a bus 1600, and a power source 1700. Although shown as a single unit, any one or more element of the computing device 1000 may be integrated into any number of separate physical units. For example, the low-latency memory 1300 and the processor 1100 may be integrated in a first physical unit and the user interface 1500 may be integrated in a second physical unit. Although not shown in FIG. 1, the computing device 1000 may include other aspects, such as an enclosure or one or more sensors.

The computing device 1000 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC.

The processor 1100 may include any device or combination of devices capable of manipulating or processing a signal or other information, including optical processors, quantum processors, molecular processors, or a combination thereof. The processor 1100 may be a central processing unit (CPU), such as a microprocessor, and may include one or more processing units, which may respectively include one or more processing cores. The processor 1100 may include multiple interconnected processors. For example, the multiple processors may be hardwired or networked, including wirelessly networked. In some implementations, the operations of the processor 1100 may be distributed across multiple physical devices or units that may be coupled directly or across a network. In some implementations, the processor 1100 may include a cache, or cache memory, for internal storage of operating data or instructions. The processor 1100 may include one or more special purpose processors, one or more digital signal processor (DSP), one or more microprocessors, one or more controllers, one or more microcontrollers, one or more integrated circuits, one or more an Application Specific Integrated Circuits, one or more Field Programmable Gate Array, one or more programmable logic arrays, one or more programmable logic controllers, firmware, one or more state machines, or any combination thereof.

The processor 1100 may be operatively coupled with the static memory 1200, the low-latency memory 1300, the electronic communication unit 1400, the user interface 1500, the bus 1600, the power source 1700, or any combination thereof. The processor may execute, which may include controlling, such as by sending electronic signals to, receiving electronic signals from, or both, the static memory 1200, the low-latency memory 1300, the electronic communication unit 1400, the user interface 1500, the bus 1600, the power source 1700, or any combination thereof to execute, instructions, programs, code, applications, or the like, which may include executing one or more aspects of an operating system, and which may include executing one or more instructions to perform one or more aspects described herein, alone or in combination with one or more other processors.

The static memory 1200 is coupled to the processor 1100 via the bus 1600 and may include non-volatile memory, such as a disk drive, or any form of non-volatile memory capable of persistent electronic information storage, such as in the absence of an active power supply. Although shown as a single block in FIG. 1, the static memory 1200 may be implemented as multiple logical or physical units.

The static memory 1200 may store executable instructions or data, such as application data, an operating system, or a combination thereof, for access by the processor 1100. The executable instructions may be organized into programmable modules or algorithms, functional programs, codes, code segments, or combinations thereof to perform one or more aspects, features, or elements described herein. The application data may include, for example, user files, database catalogs, configuration information, or a combination thereof. The operating system may be, for example, a desktop or laptop operating system; an operating system for a mobile device, such as a smartphone or tablet device; or an operating system for a large device, such as a mainframe computer.

The low-latency memory 1300 is coupled to the processor 1100 via the bus 1600 and may include any storage medium with low-latency data access including, for example, DRAM modules such as double data rate (DDR) synchronous dynamic random-access memory (SDRAM), Phase-Change Memory (PCM), flash memory, or a solid-state drive. Although shown as a single block in FIG. 1, the low-latency memory 1300 may be implemented as multiple logical or physical units. Other configurations may be used. For example, low-latency memory 1300, or a portion thereof, and processor 1100 may be combined, such as by using a system on a chip design.

The low-latency memory 1300 may store executable instructions or data, such as application data for low-latency access by the processor 1100. The executable instructions may include, for example, one or more application programs that may be executed by the processor 1100. The executable instructions may be organized into programmable modules or algorithms, functional programs, codes, code segments, and/or combinations thereof to perform various functions described herein.

The low-latency memory 1300 may be used to store data that is analyzed or processed using the systems or methods described herein. For example, storage of some or all data in low-latency memory 1300 instead of static memory 1200 may improve the execution speed of the systems and methods described herein by permitting access to data more quickly by an order of magnitude or greater (e.g., nanoseconds instead of microseconds).

The electronic communication unit 1400 is coupled to the processor 1100 via the bus 1600. The electronic communication unit 1400 may include one or more transceivers. The electronic communication unit 1400 may, for example, provide a connection or link to a network via a network interface. The network interface may be a wired network interface, such as Ethernet, or a wireless network interface. For example, the computing device 1000 may communicate with other devices via the electronic communication unit 1400 and the network interface using one or more network protocols, such as Ethernet, Transmission Control Protocol/Internet Protocol (TCP/IP), power line communication (PLC), Wi-Fi, infrared, ultra violet (UV), visible light, fiber optic, wire line, general packet radio service (GPRS), Global System for Mobile communications (GSM), code-division multiple access (CDMA), Long-Term Evolution (LTE), or other suitable protocols.

The user interface 1500 may include any unit capable of interfacing with a human user, such as a virtual or physical keypad, a touchpad, a display, a touch display, a speaker, a microphone, a video camera, a sensor, a printer, or any combination thereof. For example, a keypad can convert physical input of force applied to a key to an electrical signal that can be interpreted by computing device 1000. In another example, a display can convert electrical signals output by computing device 1000 to light. The purpose of such devices may be to permit interaction with a human user, for example by accepting input from the human user and providing output back to the human user. The user interface 1500 may include a display; a positional input device, such as a mouse, touchpad, touchscreen, or the like; a keyboard; or any other human and machine interface device. The user interface 1500 may be coupled to the processor 1100 via the bus 1600. In some implementations, the user interface 1500 can include a display, which can be a liquid crystal display (LCD), a cathode-ray tube (CRT), a light emitting diode (LED) display, an organic light emitting diode (OLED) display, an active-matrix organic light emitting diode (AMOLED), or other suitable display. In some implementations, the user interface 1500, or a portion thereof, may be part of another computing device (not shown). For example, a physical user interface, or a portion thereof, may be omitted from the computing device 1000 and a remote or virtual interface may be used, such as via the electronic communication unit 1400.

The bus 1600 is coupled to the static memory 1200, the low-latency memory 1300, the electronic communication unit 1400, the user interface 1500, and the power source 1700. Although a single bus is shown in FIG. 1, the bus 1600 may include multiple buses, which may be connected, such as via bridges, controllers, or adapters.

The power source 1700 provides energy to operate the computing device 1000. The power source 1700 may be a general-purpose alternating-current (AC) electric power supply, or power supply interface, such as an interface to a household power source. In some implementations, the power source 1700 may be a single use battery or a rechargeable battery to allow the computing device 1000 to operate independently of an external power distribution system. For example, the power source 1700 may include a wired power source; one or more dry cell batteries, such as nickel-cadmium (NiCad), nickel-zinc (NiZn), nickel metal hydride (NiMH), lithium-ion (Li-ion); solar cells; fuel cells; or any other device capable of powering the computing device 1000.

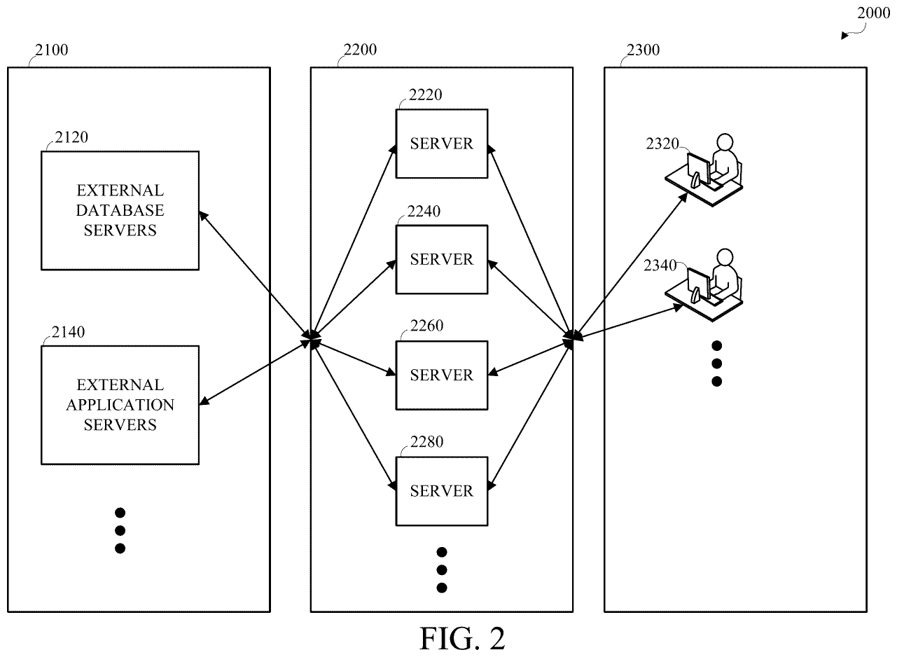

FIG. 2 is a block diagram of an example of a computing system 2000. As shown, the computing system 2000 includes an external data source portion 2100, an internal database analysis portion 2200, and a system interface portion 2300. The computing system 2000 may include other elements not shown in FIG. 2, such as computer network elements.

The external data source portion 2100 may be associated with, such as controlled by, an external person, entity, or organization (second party). The internal database analysis portion 2200 may be associated with, such as created by or controlled by, a person, entity, or organization (first party). The system interface portion 2300 may be associated with, such as created by or controlled by, the first party and may be accessed by the first party, the second party, third parties, or a combination thereof, such as in accordance with access and authorization permissions and procedures.

The external data source portion 2100 is shown as including external database servers 2120 and external application servers 2140. The external data source portion 2100 may include other elements not shown in FIG. 2. The external data source portion 2100 may include external computing devices, such as the computing device 1000 shown in FIG. 1, which may be used by or accessible to the external person, entity, or organization (second party) associated with the external data source portion 2100, including but not limited to external database servers 2120 and external application servers 2140. The external computing devices may include data regarding the operation of the external person, entity, or organization (second party) associated with the external data source portion 2100.

The external database servers 2120 may be one or more computing devices configured to store data in a format and schema determined externally from the internal database analysis portion 2200, such as by a second party associated with the external data source portion 2100, or a third party. For example, the external database server 2120 may use a relational database and may include a database catalog with a schema. In some embodiments, the external database server 2120 may include a non-database data storage structure, such as a text-based data structure, such as a comma separated variable structure or an extensible markup language formatted structure or file. For example, the external database servers 2120 can include data regarding the production of materials by the external person, entity, or organization (second party) associated with the external data source portion 2100, communications between the external person, entity, or organization (second party) associated with the external data source portion 2100 and third parties, or a combination thereof. Other data may be included. The external database may be a structured database system, such as a relational database operating in a relational database management system (RDBMS), which may be an enterprise database. In some embodiments, the external database may be an unstructured data source. The external data may include data or content, such as sales data, revenue data, profit data, tax data, shipping data, safety data, sports data, health data, meteorological data, or the like, or any other data, or combination of data, that may be generated by or associated with a user, an organization, or an enterprise and stored in a database system. For simplicity and clarity, data stored in or received from the external data source portion 2100 may be referred to herein as enterprise data.

The external application server 2140 may include application software, such as application software used by the external person, entity, or organization (second party) associated with the external data source portion 2100. The external application server 2140 may include data or metadata relating to the application software.

The external database servers 2120, the external application servers 2140, or both, shown in FIG. 2 may represent logical units or devices that may be implemented on one or more physical units or devices, which may be controlled or operated by the first party, the second party, or a third party.

The external data source portion 2100, or aspects thereof, such as the external database servers 2120, the external application servers 2140, or both, may communicate with the internal database analysis portion 2200, or an aspect thereof, such as one or more of the servers 2220, 2240, 2260, and 2280, via an electronic communication medium, which may be a wired or wireless electronic communication medium. For example, the electronic communication medium may include a local area network (LAN), a wide area network (WAN), a fiber channel network, the Internet, or a combination thereof.

The internal database analysis portion 2200 is shown as including servers 2220, 2240, 2260, and 2280. The servers 2220, 2240, 2260, and 2280 may be computing devices, such as the computing device 1000 shown in FIG. 1. Although four servers 2220, 2240, 2260, and 2280 are shown in FIG. 2, other numbers, or cardinalities, of servers may be used. For example, the number of computing devices may be determined based on the capability of individual computing devices, the amount of data to be processed, the complexity of the data to be processed, or a combination thereof. Other metrics may be used for determining the number of computing devices.

The internal database analysis portion 2200 may store data, process data, or store and process data. The internal database analysis portion 2200 may include a distributed cluster (not expressly shown) which may include two or more of the servers 2220, 2240, 2260, and 2280. The operation of the distributed cluster, such as the operation of the servers 2220, 2240, 2260, and 2280 individually, in combination, or both, may be managed by a distributed cluster manager. For example, the server 2220 may be the distributed cluster manager. In another example, the distributed cluster manager may be implemented on another computing device (not shown). The data and processing of the distributed cluster may be distributed among the servers 2220, 2240, 2260, and 2280, such as by the distributed cluster manager.

Enterprise data from the external data source portion 2100, such as from the external database server 2120, the external application server 2140, or both may be imported into the internal database analysis portion 2200. The external database server 2120, the external application server 2140, or both may be one or more computing devices and may communicate with the internal database analysis portion 2200 via electronic communication. The imported data may be distributed among, processed by, stored on, or a combination thereof, one or more of the servers 2220, 2240, 2260, and 2280. Importing the enterprise data may include importing or accessing the data structures of the enterprise data. Importing the enterprise data may include generating internal data, internal data structures, or both, based on the enterprise data. The internal data, internal data structures, or both may accurately represent and may differ from the enterprise data, the data structures of the enterprise data, or both. In some implementations, enterprise data from multiple external data sources may be imported into the internal database analysis portion 2200. For simplicity and clarity, data stored or used in the internal database analysis portion 2200 may be referred to herein as internal data. For example, the internal data, or a portion thereof, may represent, and may be distinct from, enterprise data imported into or accessed by the internal database analysis portion 2200.

The system interface portion 2300 may include one or more client devices 2320, 2340. The client devices 2320, 2340 may be computing devices, such as the computing device 1000 shown in FIG. 1. For example, one of the client devices 2320, 2340 may be a desktop or laptop computer and the other of the client devices 2320, 2340 may be a mobile device, smartphone, or tablet. One or more of the client devices 2320, 2340 may access the internal database analysis portion 2200. For example, the internal database analysis portion 2200 may provide one or more services, application interfaces, or other electronic computer communication interfaces, such as a web site, and the client devices 2320, 2340 may access the interfaces provided by the internal database analysis portion 2200, which may include accessing the internal data stored in the internal database analysis portion 2200.

In an example, one or more of the client devices 2320, 2340 may send a message or signal indicating a request for data, which may include a request for data analysis, to the internal database analysis portion 2200. The internal database analysis portion 2200 may receive and process the request, which may include distributing the processing among one or more of the servers 2220, 2240, 2260, and 2280, may generate a response to the request, which may include generating or modifying internal data, internal data structures, or both, and may output the response to the client device 2320, 2340 that sent the request. Processing the request may include accessing one or more internal data indexes, an internal database, or a combination thereof. The client device 2320, 2340 may receive the response, including the response data or a portion thereof, and may store, output, or both, the response, or a representation thereof, such as a representation of the response data, or a portion thereof, which may include presenting the representation via a user interface on a presentation device of the client device 2320, 2340, such as to a user of the client device 2320, 2340.

The system interface portion 2300, or aspects thereof, such as one or more of the client devices 2320, 2340, may communicate with the internal database analysis portion 2200, or an aspect thereof, such as one or more of the servers 2220, 2240, 2260, and 2280, via an electronic communication medium, which may be a wired or wireless electronic communication medium. For example, the electronic communication medium may include a local area network (LAN), a wide area network (WAN), a fiber channel network, the Internet, or a combination thereof.

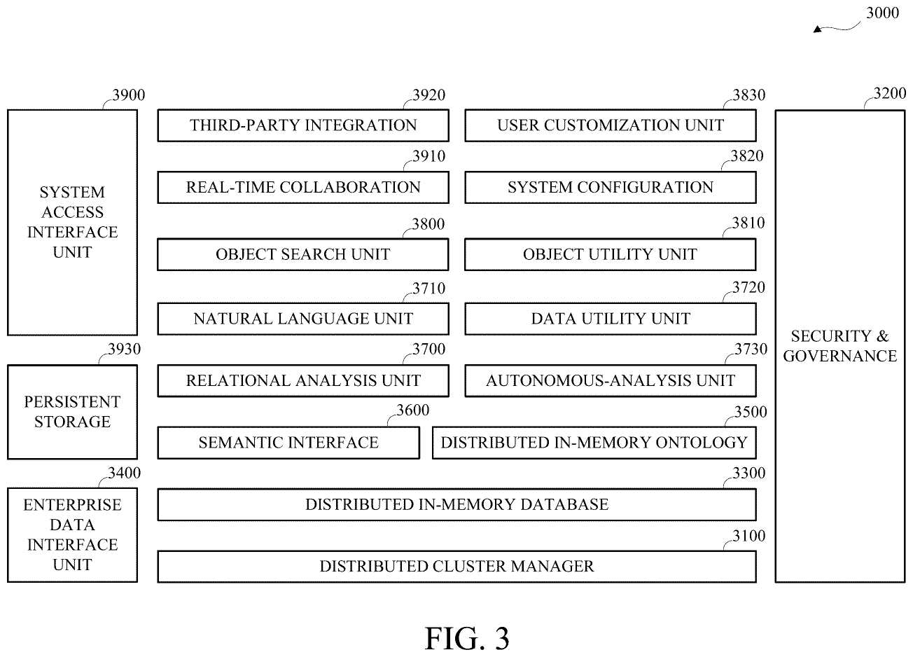

FIG. 3 is a block diagram of an example of a low-latency data access and analysis system 3000. The low-latency data access and analysis system 3000, or aspects thereof, may be similar to the internal database analysis portion 2200 shown in FIG. 2, except as described herein or otherwise clear from context. The low-latency data access and analysis system 3000, or aspects thereof, may be implemented on one or more computing devices, such as servers 2220, 2240, 2260, and 2280 shown in FIG. 2, which may be in a clustered or distributed computing configuration. As used herein, the terms “low-latency data access and analysis system,” “low-latency data analysis system,” and “database access and analysis system” indicate a computer implemented system, such as the low-latency data access and analysis system 3000 shown in FIG. 3, that obtains, stores, organizes, processes, automatically analyzes, and outputs data and visualizations thereof.

The low-latency data access and analysis system 3000, which may be a database access and analysis system, may store and maintain the internal data, or a portion thereof, such as low-latency data, in a low-latency memory device, such as the low-latency memory 1300 shown in FIG. 1, or any other type of data storage medium or combination of data storage devices with relatively fast (low-latency) data access, organized in a low-latency data structure. In some embodiments, the low-latency data access and analysis system 3000 may be implemented as one or more logical devices in a cloud-based configuration optimized for automatic database analysis.

As shown, the low-latency data access and analysis system 3000 includes a distributed cluster manager 3100, a security and governance unit 3200, a distributed in-memory database 3300, an enterprise data interface unit 3400, a distributed in-memory ontology unit 3500, a semantic interface unit 3600, a relational analysis unit 3700, a natural language processing unit 3710, a data utility unit 3720, an autonomous-analysis unit 3730, an object search unit 3800, an object utility unit 3810, a system configuration unit 3820, a user customization unit 3830, a system access interface unit 3900, a real-time collaboration unit 3910, a third-party integration unit 3920, and a persistent storage unit 3930, which may be collectively referred to as the components of the low-latency data access and analysis system 3000.

Although not expressly shown in FIG. 3, one or more of the components of the low-latency data access and analysis system 3000 may be implemented on one or more operatively connected physical or logical computing devices, such as in a distributed cluster computing configuration, such as the internal database analysis portion 2200 shown in FIG. 2. Although shown separately in FIG. 3, one or more of the components of the low-latency data access and analysis system 3000, or respective aspects thereof, may be combined or otherwise organized.

The low-latency data access and analysis system 3000 may include different, fewer, or additional components not shown in FIG. 3. The aspects or components implemented in an instance of the low-latency data access and analysis system 3000 may be configurable. For example, the autonomous-analysis unit 3730 may be omitted or disabled. One or more of the components of the low-latency data access and analysis system 3000 may be implemented in a manner such that aspects thereof are divided or combined into various executable modules or libraries in a manner which may differ from that described herein.

The low-latency data access and analysis system 3000 may implement an application programming interface (API), which may monitor, receive, or both, input signals or messages from external devices and systems, client systems, process received signals or messages, transmit corresponding signals or messages to one or more of the components of the low-latency data access and analysis system 3000, and output, such as transmit or send, output messages or signals to respective external devices or systems. The low-latency data access and analysis system 3000 may be implemented in a distributed computing configuration.

The distributed cluster manager 3100 manages the operative configuration of the low-latency data access and analysis system 3000. Managing the operative configuration of the low-latency data access and analysis system 3000 may include controlling the implementation of and distribution of processing and storage across one or more logical devices operating on one or more physical devices, such as the servers 2220, 2240, 2260, and 2280 shown in FIG. 2. The distributed cluster manager 3100 may generate and maintain configuration data for the low-latency data access and analysis system 3000, such as in one or more tables, identifying the operative configuration of the low-latency data access and analysis system 3000. For example, the distributed cluster manager 3100 may automatically update the low-latency data access and analysis system configuration data in response to an operative configuration event, such as a change in availability or performance for a physical or logical unit of the low-latency data access and analysis system 3000. One or more of the component units of low-latency data access and analysis system 3000 may access the data analysis system configuration data, such as to identify intercommunication parameters or paths.

The security and governance unit 3200 may describe, implement, enforce, or a combination thereof, rules and procedures for controlling access to aspects of the low-latency data access and analysis system 3000, such as the internal data of the low-latency data access and analysis system 3000 and the features and interfaces of the low-latency data access and analysis system 3000. The security and governance unit 3200 may apply security at an ontological level to control or limit access to the internal data of the low-latency data access and analysis system 3000, such as to columns, tables, rows, or fields, which may include using row-level security.

Although shown as a single unit in FIG. 3, the distributed in-memory database 3300 may be implemented in a distributed configuration, such as distributed among the servers 2220, 2240, 2260, and 2280 shown in FIG. 2, which may include multiple in-memory database instances. Each in-memory database instance may utilize one or more distinct resources, such as processing or low-latency memory resources, which differ from the resources utilized by the other in-memory database instances. In some embodiments, the in-memory database instances may utilize one or more shared resources, such as resources utilized by two or more in-memory database instances.

The distributed in-memory database 3300 may generate, maintain, or both, a low-latency data structure and data stored or maintained therein (low-latency data). The low-latency data may include principal data, which may represent enterprise data, such as enterprise data imported from an external enterprise data source, such as the external data source portion 2100 shown in FIG. 2. In some implementations, the distributed in-memory database 3300 may include system internal data representing one or more aspects, features, or configurations of the low-latency data access and analysis system 3000. The distributed in-memory database 3300 and the low-latency data stored therein, or a portion thereof, may be accessed using commands, messages, or signals in accordance with a defined structured query language associated with, such as implemented by, the distributed in-memory database 3300.

The low-latency data, or a portion thereof, may be organized as tables in the distributed in-memory database 3300. A table may be a data structure to organize or group the data or a portion thereof, such as related or similar data. A table may have a defined structure. For example, each table may define or describe a respective set of one or more columns.

A column may define or describe the characteristics of a discrete aspect of the data in the table. For example, the definition or description of a column may include an identifier, such as a name, for the column within the table, and one or more constraints, such as a data type, for the data corresponding to the column in the table. The definition or description of a column may include other information, such as a description of the column. The data in a table may be accessible or partitionable on a per-column basis. The set of tables, including the column definitions therein, and information describing relationships between elements, such as tables and columns, of the database may be defined or described by a database schema or design. The cardinality of columns of a table, and the definition and organization of the columns, may be defined by the database schema or design. Adding, deleting, or modifying a table, a column, the definition thereof, or a relationship or constraint thereon, may be a modification of the database design, schema, model, or structure.

The low-latency data, or a portion thereof, may be stored in the database as one or more rows or records in respective tables. Each record or row of a table may include a respective field or cell corresponding to each column of the table. A field may store a discrete data value. The cardinality of rows of a table, and the values stored therein, may be variable based on the data. Adding, deleting, or modifying rows, or the data stored therein may omit modification of the database design, schema, or structure. The data stored in respective columns may be identified or defined as a measure data, attribute data, or enterprise ontology data (e.g., metadata).

Measure data, or measure values, include quantifiable or additive numeric values, such as integer or floating-point values, which may include numeric values indicating sizes, amounts, degrees, or the like. A column defined as representing measure values may be referred to herein as a measure or fact. A measure may be a property on which quantitative operations (e.g., sum, count, average, minimum, maximum) may be performed to calculate or determine a result or output.

Attribute data, or attribute values, include non-quantifiable values, such as text or image data, which may indicate names and descriptions, quantifiable values designated, defined, or identified as attribute data, such as numeric unit identifiers, or a combination thereof. A column defined as including attribute values may be referred to herein as an attribute or dimension. For example, attributes may include text, identifiers, timestamps, or the like.

Enterprise ontology data may include data that defines or describes one or more aspects of the database, such as data that describes one or more aspects of the attributes, measures, rows, columns, tables, relationships, or other aspects of the data or database schema. For example, a portion of the database design, model, or schema may be represented as enterprise ontology data in one or more tables in the database.

Distinctly identifiable data in the low-latency data may be referred to herein as a data portion. For example, the low-latency data stored in the distributed in-memory database 3300 may be referred to herein as a data portion, a table from the low-latency data may be referred to herein as a data portion, a column from the low-latency data may be referred to herein as a data portion, a row or record from the low-latency data may be referred to herein as a data portion, a value from the low-latency data may be referred to herein as a data portion, a relationship defined in the low-latency data may be referred to herein as a data portion, enterprise ontology data describing the low-latency data may be referred to herein as a data portion, or any other distinctly identifiable data, or combination thereof, from the low-latency data may be referred to herein as a data portion. A respective data portion, such as a column, may be identified in the data access and analysis system by a corresponding, such as uniquely, data portion identifier.

The distributed in-memory database 3300 may create or add one or more data portions, such as a table, may read from or access one or more data portions, may update or modify one or more data portions, may remove or delete one or more data portions, or a combination thereof. Adding, modifying, or removing data portions may include changes to the data model of the low-latency data. Changing the data model of the low-latency data may include notifying one or more other components of the low-latency data access and analysis system 3000, such as by sending, or otherwise making available, a message or signal indicating the change. For example, the distributed in-memory database 3300 may create or add a table to the low-latency data and may transmit or send a message or signal indicating the change to the semantic interface unit 3600.

In some implementations, a portion of the low-latency data may represent a data model of an external enterprise database and may omit the data stored in the external enterprise database, or a portion thereof. For example, prioritized data may be cached in the distributed in-memory database 3300 and the other data may be omitted from storage in the distributed in-memory database 3300, which may be stored in the external enterprise database. In some implementations, requesting data from the distributed in-memory database 3300 may include requesting the data, or a portion thereof, from the external enterprise database.

The distributed in-memory database 3300 may receive one or more messages or signals indicating respective data queries for the low-latency data, or a portion thereof, which may include data queries for modified, generated, or aggregated data generated based on the low-latency data, or a portion thereof. For example, the distributed in-memory database 3300 may receive a data query from the semantic interface unit 3600, such as in accordance with a request for data. The data queries received by the distributed in-memory database 3300 may be agnostic to the distributed configuration of the distributed in-memory database 3300. A data query, or a portion thereof, may be expressed in accordance with the defined structured query language implemented by the distributed in-memory database 3300. In some implementations, a data query, or a portion thereof, may be expressed in accordance with a defined structured query language implemented by a defined database other than the distributed in-memory database 3300, such as an external database. In some implementations, a data query may be included, such as stored or communicated, in a data query data structure or container.

The distributed in-memory database 3300 may execute or perform one or more queries to generate or obtain response data responsive to the data query based on the low-latency data. Unless expressly described, or otherwise clear from context, descriptions herein of a table in the context of performing, processing, or executing a data query that include accessing, such as reading, writing, or otherwise using, a table, or data from a table, may refer to a table stored, or otherwise maintained, in the distributed in-memory database independently of the data query or may refer to tabular data obtained, such as generated, in accordance with the data query.

The distributed in-memory database 3300 may interpret, evaluate, or otherwise process a data query to generate one or more distributed-queries, which may be expressed in accordance with the defined structured query language. For example, an in-memory database instance of the distributed in-memory database 3300 may be identified as a query coordinator. The query coordinator may generate a query plan, which may include generating one or more distributed queries, based on the received data query. The query plan may include query execution instructions for executing one or more queries, or one or more portions thereof, based on the received data query by the one or more of the in-memory database instances. Generating the query plan may include optimizing the query plan. The query coordinator may distribute, or otherwise make available, the respective portions of the query plan, as query execution instructions, to the corresponding in-memory database instances.

The respective in-memory database instances may receive the corresponding query execution instructions from the query coordinator. The respective in-memory database instances may execute the corresponding query execution instructions to obtain, process, or both, data (intermediate results data) from the low-latency data. The respective in-memory database instances may output, or otherwise make available, the intermediate results data, such as to the query coordinator.

The query coordinator may execute a respective portion of query execution instructions (allocated to the query coordinator) to obtain, process, or both, data (intermediate results data) from the low-latency data. The query coordinator may receive, or otherwise access, the intermediate results data from the respective in-memory database instances. The query coordinator may combine, aggregate, or otherwise process the intermediate results data to obtain results data.

In some embodiments, obtaining the intermediate results data by one or more of the in-memory database instances may include outputting the intermediate results data to, or obtaining intermediate results data from, one or more other in-memory database instances, in addition to, or instead of, obtaining the intermediate results data from the low-latency data.

The distributed in-memory database 3300 may output, or otherwise make available, the results data to the semantic interface unit 3600.

The enterprise data interface unit 3400 may interface with, or communicate with, an external enterprise data system. For example, the enterprise data interface unit 3400 may receive or access enterprise data from or in an external system, such as an external database. The enterprise data interface unit 3400 may import, evaluate, or otherwise process the enterprise data to populate, create, or modify data stored in the low-latency data access and analysis system 3000. The enterprise data interface unit 3400 may receive, or otherwise access, the enterprise data from one or more external data sources, such as the external data source portion 2100 shown in FIG. 2, and may represent the enterprise data in the low-latency data access and analysis system 3000 by importing, loading, or populating the enterprise data as principal data in the distributed in-memory database 3300, such as in one or more low-latency data structures. The enterprise data interface unit 3400 may implement one or more data connectors, which may transfer data between, for example, the external data source and the distributed in-memory database 3300, which may include altering, formatting, evaluating, or manipulating the data.

The enterprise data interface unit 3400 may receive, access, or generate metadata that identifies one or more parameters or relationships for the principal data, such as based on the enterprise data, and may include the generated metadata in the low-latency data stored in the distributed in-memory database 3300. For example, the enterprise data interface unit 3400 may identify characteristics of the principal data such as, attributes, measures, values, unique identifiers, tags, links, keys, or the like, and may include metadata representing the identified characteristics in the low-latency data stored in the distributed in-memory database 3300. The characteristics of the data can be automatically determined by receiving, accessing, processing, evaluating, or interpreting the schema in which the enterprise data is stored, which may include automatically identifying links or relationships between columns, classifying columns (e.g., using column names), and analyzing or evaluating the data.

Although not shown separately in FIG. 3, the low-latency data access and analysis system 3000 implements a canonical, or system-defined, chronometry. The system-defined chronometry defines the measurement, storage, processing, organization, scale, expression, and representation of time and temporal data in the data access and analysis system 3000. For example, the system-defined chronometry may correspond with a Gregorian calendar, or a defined variant thereof. The system-defined chronometry defines one or more chronometric units, which may be nominal, or named, representations of respective temporal intervals. A reference chronometric unit, such as a ‘second’ chronometric unit, may represent a minimal temporal interval in the data access and analysis system. One or more aspects of the system-defined chronometry may be defined by the operating environment of the data access and analysis system, such as by a hardware component, an operating system, or a combination thereof. For example, a hardware component, such as a system clock (clock circuit) may define the temporal interval of the reference chronometric unit, and an operating system may define one or more other chronometric units with reference to the reference chronometric unit.

The data access and analysis system 3000 may define or describe one or more chronometric unit types, such as a ‘minute’ chronometric unit type, an ‘hour’ chronometric unit type, a ‘day’ chronometric unit type, a ‘week’ chronometric unit type, a ‘month’ chronometric unit type, a ‘quarter’ chronometric unit type, a ‘year’ chronometric unit type, or any other type of chronometric unit. A temporal point may be represented, such as stored or processed, in the data access and analysis system as an epoch value, which may be an integer value, such that each temporal point from the contiguous sequence of temporal points that comprises the temporal continuum corresponds with a respective epoch value. A temporal location may be represented in the data access and analysis system as an epoch value and may be expressed in the data access and analysis system using one or more chronometric units, or respective values thereof. The system-defined chronometry defines respective descriptors, such as a day-of-week-name, month-name, and the like. Data defining or describing the system-defined chronometry may be stored in the low-latency data access and analysis system as a chronometric dataset. In some implementations, the low-latency data access and analysis system may define or describe a domain-specific chronometry that differs from the system-defined chronometry. The chronometric units defined or described by the domain-specific chronometry, except for the reference chronometric unit, may differ from the chronometric units defined or described by the system-defined chronometry. Data defining or describing the domain-specific chronometry may be stored in the low-latency data access and analysis system as a chronometric dataset.

Distinctly identifiable operative data units or structures representing one or more data portions, one or more entities, users, groups, or organizations represented in the internal data, or one or more aggregations, collections, relations, analytical results, visualizations, or groupings thereof, may be represented in the low-latency data access and analysis system 3000 as objects. An object may include a unique identifier for the object, such as a fully qualified name, a globally unique identifier (GUID), or a universally unique identifier (UUID). An object may include a name, such as a displayable value, for the object.

For example, an object may represent a user, a group, an entity, an organization, a privilege, a role, a table, a column, a data relationship, a worksheet, a view, an access context, an answer, an insight, a pinboard, a tag, a comment, a trigger, a defined variable, a data source, an object-level security rule, a row-level security rule, or any other data capable of being distinctly identified and stored or otherwise obtained in the low-latency data access and analysis system 3000. An object may represent or correspond with a logical entity. Data describing an object may include data operatively or uniquely identifying data corresponding to, or represented by, the object in the low-latency data access and analysis system. For example, a column in a table in a database in, or accessible by, the low-latency data access and analysis system may be represented in the low-latency data access and analysis system as an object and the data describing or defining the object may include data operatively or uniquely identifying the column.

A worksheet (worksheet object), or worksheet table, may be a logical table, or a definition thereof, which may be a collection, a subset (such as a subset of columns from one or more tables), or both, of data from one or more data sources, such as columns in one or more tables, such as in the distributed in-memory database 3300, or in an external database. A worksheet, or a definition thereof, may include one or more data organization or manipulation definitions, such as join paths or worksheet-column definitions, which may be user defined. A worksheet may be a data structure that may contain one or more rules or definitions that may define or describe how a respective tabular set of data may be obtained, which may include defining one or more sources of data, such as one or more columns from the distributed in-memory database 3300, or from an external database. A worksheet may be a data source. For example, a worksheet may include references to one or more data sources, such as columns in one or more tables, such as in the distributed in-memory database 3300, or in an external database, and a request for data referencing the worksheet may access the data from the data sources referenced in the worksheet. In some implementations, a worksheet may omit aggregations of the data from the data sources referenced in the worksheet. A worksheet may be processed, or transformed, automatically, which may be similar to transforming a resolved request, or an analytical object, to obtain a data query, as described herein, except as is described herein or as is otherwise clear from context, to generate one or more data queries that may be executed by the corresponding data source to generate data, or content, corresponding to the worksheet.

For example, a worksheet may include one or more tables, or one or more columns thereof, associated with an organizing characteristic, or use case. A worksheet may reduce the complexity of the data model, or data models, storing the data, such as by combining data, using worksheet-specific names, descriptions, or both, of data elements, such as column names. A worksheet may reduce the complexity of the data model, or data models, storing the data, such as by using worksheet-specific classifications, or types, of data elements, such as columns including numeric data. For example, a column including numeric data may be a measure column in the data model and may be used as an attribute column in a worksheet. A worksheet may reduce the complexity of the data model, or data models, storing the data, such as by using worksheet-specific aggregation functions. A worksheet may reduce the complexity of the data model, or data models, storing the data, such as by using worksheet-specific formatting and currency symbols. A worksheet may reduce the complexity of the data model, or data models, storing the data, such as by using worksheet-specific identification of columns that contain geographical data. A worksheet may reduce the complexity of the data model, or data models, storing the data, such as by using worksheet-specific vocabulary, which may include mapping the worksheet-specific vocabulary to data. A worksheet may reduce the complexity of the data model, or data models, storing the data, such as by using worksheet-specific formulas for consistency and governance. A worksheet may reduce the complexity of the data model, or data models, storing the data, such as by using worksheet-specific user or group access to one or more portions or parts of the constituent data. A worksheet may reduce the complexity of the data model, or data models, storing the data, such as by using a worksheet-specific filtered set of data.

An answer (answer object), or report, may represent a defined, such as previously generated, request for data, such as a resolved request. An answer may include information describing a visualization of data responsive to the request for data.

A visualization (visualization object) may be a defined representation or expression of data, such as a visual representation of the data, for presentation to a user or human observer, such as via a user interface. Although described as a visual representation, in some implementations, a visualization may include non-visual aspects, such as auditory or haptic presentation aspects. A visualization may be generated to represent a defined set of data in accordance with a defined visualization type or template (visualization template object), such as in a chart, graph, or tabular form. Example visualization types may include, and are not limited to, choropleths, cartograms, dot distribution maps, proportional symbol maps, contour/isopleth/isarithmic maps, dasymetric map, self-organizing map, timeline, time series, connected scatter plots, Gantt charts, steam graph/theme river, arc diagrams, polar area/rose/circumplex charts, Sankey diagrams, alluvial diagrams, pie charts, histograms, tag clouds, bubble charts, bubble clouds, bar charts, radial bar charts, tree maps, scatter plots, line charts, step charts, area charts, stacked graphs, heat maps, parallel coordinates, spider charts, box and whisker plots, mosaic displays, waterfall charts, funnel charts, or radial tree maps. A visualization template may define or describe one or more visualization parameters, such as one or more color parameters. Visualization data for a visualization may include values of one or more of the visualization parameters of the corresponding visualization template.

A view (view object) may be a logical table, or a definition thereof, which may be a collection, a sub-set, or both, of data from one or more data sources, such as columns in one or more tables, such as in the distributed in-memory database 3300, or in an external database. For example, a view may be generated based on an answer, such as by storing the answer as a view. A view may define or describe a data aggregation. A view may be a data source. For example, a view may include references to one or more data sources, such as columns in one or more tables, such as in the distributed in-memory database 3300, or in an external database, which may include a definition or description of an aggregation of the data from a respective data source, and a request for data referencing the view may access the aggregated data, the data from the unaggregated data sources referenced in the worksheet, or a combination thereof. The unaggregated data from data sources referenced in the view defined or described as aggregated data in the view may be unavailable based on the view. A view may be a materialized view or an unmaterialized view. A request for data referencing a materialized view may obtain data from a set of data previously obtained (view-materialization) in accordance with the definition of the view and the request for data. A request for data referencing an unmaterialized view may obtain data from a set of data currently obtained in accordance with the definition of the view and the request for data.

A pinboard (pinboard object), liveboard (liveboard object), or dashboard, may be a defined collection or grouping of objects, such as visualizations, answers, or insights. Pinboard data for a pinboard may include information associated with the pinboard, which may be associated with respective objects included in the pinboard.

An access context (access-context object) may be a set or collection of data associated with, such as including, data expressing usage intent, such as a request for data, data responsive to data expressing usage intent, or a discretely related sequence or series of requests for data or other interactions with the low-latency data access and analysis system 3000, and a corresponding data structure for containing such data. For example, data expressing usage intent may be generated by the low-latency data access and analysis system 3000, or a component thereof, such as the system access interface unit 3900, such as in response to input, such as user input, obtained by the low-latency data access and analysis system 3000. In another example, data expressing usage intent may be obtained, received, or otherwise accessed, by the low-latency data access and analysis system 3000, or a component thereof, from an external device or system.

A definition may be a set of data describing the structure or organization of a data portion. For example, in the distributed in-memory database 3300, a column definition may define one or more aspects of a column in a table, such as a name of the column, a description of the column, a datatype for the column, a semantic data type, such as measure, attribute, or temporal, for the column, or any other information about the column that may be represented as discrete data.

A data source object may represent a source or repository of data accessible by the low-latency data access and analysis system 3000. A data source object may include data indicating an electronic communication location, such as an address, of a data source, connection information, such as protocol information, authentication information, or a combination thereof, or any other information about the data source that may be represented as discrete data. For example, a data source object may represent a table in the distributed in-memory database 3300, or in an external database, and include data for accessing the table from the database, such as information identifying the database, information identifying a schema within the database, and information identifying the table within the schema within the database. A data source object (external data source object) may represent an external data source. For example, an external data source object may include data indicating an electronic communication location, such as an address, of an external data source, connection information, such as protocol information, authentication information, or a combination thereof, or any other information about the external data source that may be represented as discrete data.

A sticker (sticker object) may be a description of a classification, category, tag, subject area, or other information that may be associated with one or more other objects such that objects associated with a sticker may be grouped, sorted, filtered, or otherwise identified based on the sticker. In the distributed in-memory database 3300 a tag may be a discrete data portion that may be associated with other data portions, such that data portions associated with a tag may be grouped, sorted, filtered, or otherwise identified based on the tag.

The distributed in-memory ontology unit 3500 generates, maintains, or both, information (ontological data) defining or describing the operative ontological structure of the objects represented in the low-latency data access and analysis system 3000, such as in the low-latency data stored in the distributed in-memory database 3300, which may include describing attributes, properties, states, or other information about respective objects and may include describing relationships among respective objects.

Objects may be referred to herein as primary objects, secondary objects, or tertiary objects. Other types of objects may be used.

Primary objects may include objects representing distinctly identifiable operative data units or structures representing one or more data portions in the distributed in-memory database 3300, or another data source in, or accessible by, the low-latency data access and analysis system 3000. For example, primary objects may be data source objects, table objects, column objects, relationship objects, or the like. Primary objects may include worksheets, views, filters, such as row-level-security filters and table filters, variables, or the like. Primary objects may be referred to herein as data objects or queryable objects.

Secondary objects may be objects representing distinctly identifiable operative data units or structures representing analytical data aggregations, collections, analytical results, visualizations, or groupings thereof, such as pinboard objects, answer objects, insights, visualization objects, resolved-request objects, and the like. Secondary objects may be referred to herein as analytical objects.

Tertiary objects may be objects representing distinctly identifiable operative data units or structures representing operational aspects of the low-latency data access and analysis system 3000, such as one or more entities, users, groups, or organizations represented in the internal data, such as user objects, user-group objects, role objects, sticker objects, and the like.

The distributed in-memory ontology unit 3500 may represent the ontological structure, which may include the objects therein, as a graph having nodes and edges. A node may be a representation of an object in the graph structure of the distributed in-memory ontology unit 3500. A node, representing an object, can include one or more components. The components of a node may be versioned, such as on a per-component basis. For example, a node can include a header component, a content component, or both. A header component may include information about the node. A content component may include the content of the node. An edge may represent a relationship between nodes, which may be directional.

In some implementations, the distributed in-memory ontology unit 3500 graph may include one or more nodes, edges, or both, representing one or more objects, relationships or both, corresponding to a respective internal representation of enterprise data stored in an external enterprise data storage unit, wherein a portion of the data stored in the external enterprise data storage unit represented in the distributed in-memory ontology unit 3500 graph is omitted from the distributed in-memory database 3300.

In some embodiments, the distributed in-memory ontology unit 3500 may generate, modify, or remove a portion of the ontology graph in response to one or more messages, signals, or notifications from one or more of the components of the low-latency data access and analysis system 3000. For example, the distributed in-memory ontology unit 3500 may generate, modify, or remove a portion of the ontology graph in response to receiving one or more messages, signals, or notifications from the distributed in-memory database 3300 indicating a change to the low-latency data structure. In another example, the distributed in-memory database 3300 may send one or more messages, signals, or notifications indicating a change to the low-latency data structure to the semantic interface unit 3600 and the semantic interface unit 3600 may send one or more messages, signals, or notifications indicating the change to the low-latency data structure to the distributed in-memory ontology unit 3500.

The distributed in-memory ontology unit 3500 may be distributed, in-memory, multi-versioned, transactional, consistent, durable, or a combination thereof. The distributed in-memory ontology unit 3500 is transactional, which may include implementing atomic concurrent, or substantially concurrent, updating of multiple objects. The distributed in-memory ontology unit 3500 is durable, which may include implementing a robust storage that prevents data loss subsequent to or as a result of the completion of an atomic operation. The distributed in-memory ontology unit 3500 is consistent, which may include performing operations associated with a request for data with reference to or using a discrete data set, which may mitigate or eliminate the risk of inconsistent results.

The distributed in-memory ontology unit 3500 may generate, output, or both, one or more event notifications. For example, the distributed in-memory ontology unit 3500 may generate, output, or both, a notification, or notifications, in response to a change of the distributed in-memory ontology. The distributed in-memory ontology unit 3500 may identify a portion of the distributed in-memory ontology (graph) associated with a change of the distributed in-memory ontology, such as one or more nodes depending from a changed node, and may generate, output, or both, a notification, or notifications indicating the identified relevant portion of the distributed in-memory ontology (graph). One or more aspects of the low-latency data access and analysis system 3000 may cache object data and may receive the notifications from the distributed in-memory ontology unit 3500, which may reduce latency and network traffic relative to systems that omit caching object data or omit notifications relevant to changes to portions of the distributed in-memory ontology (graph).

The distributed in-memory ontology unit 3500 may implement prefetching. For example, the distributed in-memory ontology unit 3500 may predictively, such as based on determined probabilistic utility, fetch one or more nodes, such as in response to access to a related node by a component of the low-latency data access and analysis system 3000.

The distributed in-memory ontology unit 3500 may implement a multi-version concurrency control graph data storage unit. Each node, object, or both, may be versioned. Changes to the distributed in-memory ontology may be reversible. For example, the distributed in-memory ontology may have a first state prior to a change to the distributed in-memory ontology, the distributed in-memory ontology may have a second state subsequent to the change, and the state of the distributed in-memory ontology may be reverted to the first state subsequent to the change, such as in response to the identification of an error or failure associated with the second state.

In some implementations, reverting a node, or a set of nodes, may omit reverting one or more other nodes. In some implementations, the distributed in-memory ontology unit 3500 may maintain a change log indicating a sequential record of changes to the distributed in-memory ontology (graph), such that a change to a node or a set of nodes may be reverted and one or more other changes subsequent to the reverted change may be reverted for consistency.

The distributed in-memory ontology unit 3500 may implement optimistic locking to reduce lock contention times. The use of optimistic locking permits improved throughput of data through the distributed in-memory ontology unit 3500.

The semantic interface unit 3600 may implement procedures and functions to provide a semantic interface between the distributed in-memory database 3300, or an external database, and one or more of the other components of the low-latency data access and analysis system 3000.

The semantic interface unit 3600 may implement ontological data management, data query generation, authentication and access control, object statistical data collection, or a combination thereof.

Ontological data management may include object lifecycle management, object data persistence, ontological modifications, or the like. Object lifecycle management may include creating one or more objects, reading or otherwise accessing one or more objects, updating or modifying one or more objects, deleting or removing one or more objects, or a combination thereof. For example, the semantic interface unit 3600 may interface or communicate with the distributed in-memory ontology unit 3500, which may store the ontological data, object data, or both, to perform object lifecycle management, object data persistence, ontological modifications, or the like.

For example, the semantic interface unit 3600 may receive, or otherwise access, a message, signal, or notification, such as from the distributed in-memory database 3300, or from an external database, indicating the creation or addition of a data portion, such as a table, in the low-latency data stored in the distributed in-memory database 3300, or in an external database, and the semantic interface unit 3600 may communicate with the distributed in-memory ontology unit 3500 to create an object in the ontology representing the added data portion. The semantic interface unit 3600 may transmit, send, or otherwise make available, a notification, message, or signal to the relational analysis unit 3700 indicating that the ontology has changed.

The semantic interface unit 3600 may receive, or otherwise access, a request message or signal, such as from the relational analysis unit 3700, indicating a request for information describing changes to the ontology (ontological updates request). The semantic interface unit 3600 may generate and send, or otherwise make available, a response message or signal to the relational analysis unit 3700 indicating the changes to the ontology (ontological updates response). The semantic interface unit 3600 may identify one or more data portions for indexing based on the changes to the ontology. For example, the changes to the ontology may include adding a table to the ontology, the table including multiple rows, and the semantic interface unit 3600 may identify each row as a data portion for indexing. The semantic interface unit 3600 may include information describing the ontological changes in the ontological updates response. The semantic interface unit 3600 may include one or more data query definitions, such as data query definitions for indexing data queries, for each data portion identified for indexing in the ontological updates response. For example, the data query definitions may include a sampling data query, which may be used to query the distributed in-memory database 3300, or an external database, for sample data from the added data portion, an indexing data query, which may be used to query the distributed in-memory database 3300, or an external database, for data from the added data portion, or both.

The semantic interface unit 3600 may receive, or otherwise access, internal signals or messages including data expressing usage intent, such as data indicating requests to access or modify the low-latency data stored in the distributed in-memory database 3300 (e.g., a request for data). The request to access or modify the low-latency data received by the semantic interface unit 3600 may include a resolved request (resolved-request data), such as in a resolved-request object, such as a resolved-request object generated by the relational analysis unit 3700. The resolved request data, which may be database and visualization agnostic, may be expressed or communicated as an ordered sequence of tokens, which may represent semantic data.

The resolved-request data may include tokenization binding data. The tokenization binding data corresponding to a respective token may include, for example, one or more of a column identifier indicating a column corresponding to the respective token, a data type identifier corresponding to the respective token, a table identifier indicating a table corresponding to the respective token, an indication of an aggregation corresponding to the respective token, or an indication of a join path associated with the respective token. Other tokenization binding data may be used.

The resolved-request data may include phrasing data indicating phrasing with respect to the sequence of tokens in the resolved request, wherein tokens, such as one or more sequential tokens, are included in a respective phrase. The phrasing data may include phrase type data for respective phrases. For some tokens, or sequences of tokens, the phrasing data may indicate that the sequence of tokens corresponds with a value stored in a data source, such as in a column in a table, wherein the phrasing data includes data uniquely identifying the data source, such as a column identifier.

A token is a unit of data in the low-latency data access and analysis system 3000 that represents, in accordance with one or more defined grammars implemented by the low-latency data access and analysis system 3000, a data portion accessed by or stored in the low-latency data access and analysis system 3000, an operation of the low-latency data access and analysis system 3000, an object represented in the low-latency data access and analysis system 3000, or a class or type of data portion, operation, or object in the low-latency data access and analysis system 3000. A token may be a value (token value), such as a string value, which may be a word, a character, a sequence of characters, a symbol, a combination of symbols, or the like. In some implementations, the token value may express a data pattern that defines or describes values, operations, or objects that the token represents. For example, the data pattern expressed by the token value may identify a data type, such as positive integer, such that positive integer values, or string values that may be represented as positive integer values, may be identified as matching the token. A token may be a defined data structure (token data structure) that includes a token value. A token data structure may include data other than the token value, such as token type data.

The defined grammars implemented by the low-latency data access and analysis system 3000 may define or describe the tokens. The defined grammars implemented by the low-latency data access and analysis system 3000 may define or describe token types or classes, such as ontological tokens, control-word tokens, pattern tokens, literal tokens, chronometric tokens, and a skip token. Other token types may be used.

An ontological token may represent a data portion in the low-latency data access and analysis system, such as an object represented in the low-latency data access and analysis system 3000, or a portion thereof, a table stored in the distributed in-memory database or stored in an external database, a column of a table stored in the distributed in-memory database or stored in an external database, or a value (constituent data) stored in a row and column of a table stored in the distributed in-memory database or stored in an external database. In some grammars implemented by the low-latency data access and analysis system 3000 the ontological tokens may include measure tokens representing measure data portions (measure columns), attribute tokens representing attribute data portions (attribute columns), and value tokens representing the respective values stored in the corresponding measure columns or attribute columns. For example, a worksheet object (analytical object) represented in the low-latency data access and analysis system 3000 may include a column that includes values generated based on values stored in one or more tables in the distributed in-memory database, and an ontological token may represent the column of the worksheet object.

A control-word token may be a character, a symbol, a word, or a defined ordered sequence of characters or symbols, defined or described in one or more grammars of the low-latency data access and analysis system 3000 as having one or more defined grammatical functions, which may be contextual. For example, the control-word token “sum” may be defined or described in one or more grammars of the low-latency data access and analysis system 3000 as indicating an additive aggregation. In another example, the control-word token “top” may be defined or described in one or more grammars of the low-latency data access and analysis system 3000 as indicating a maximal value from an ordered set. In another example, the control-word token “table” may be defined or described in one or more grammars of the low-latency data access and analysis system 3000 as indicating a table stored in the low-latency data access and analysis system 3000 or stored externally and accessed by the low-latency data access and analysis system 3000. The control-word tokens may include operator tokens, such as the equality operator token (“=”), delimiter tokens, which may be paired, such as opening and closing brackets (“[”, “]”). The control-word tokens may include stop-word tokens, such as “the” or “an”.

A pattern token may be a definition or a description of units of data in the low-latency data access and analysis system, which may be expressed as a data type, such as positive integer, defined or described in one or more grammars of the low-latency data access and analysis system 3000.

A literal, or constant, token may include a literal, or constant, value such as “100” or the Boolean value TRUE. The literal, or constant, tokens may include number-word tokens (numerals or named numbers), such as number-word tokens for the positive integers between zero and one million, inclusive, or for the numerator, denominator, or both of fractional values, or combinations thereof. For example, “one hundred twenty-eight and three-fifths”.

A chronometric token may represent a chronometric unit, such as a chronometric unit from the system-defined chronometry or a chronometric unit from a domain-specific chronometry defined or described in the low-latency data access and analysis system 3000. The chronometric tokens are automatically generated based on the respective chronometric datasets. For example, chronometric tokens corresponding to the chronometric units for the system-defined chronometry, such as “date”, “day”, “days”, “daily”, “week”, “weeks”, “weekly”, “month”, “months”, “monthly”, “quarter”, “quarters”, “quarterly”, “year”, “years”, “yearly”, and the like, may be automatically generated based on the chronometric dataset for the system-defined chronometry.

The skip token may represent discrete data portions, such as respective portions of a string that are unresolvable in accordance with the other tokens defined or described in a respective grammar of the low-latency data access and analysis system 3000.

The relational analysis unit 3700 may automatically generate respective tokens representing the attributes, the measures, the tables, the columns, the values, unique identifiers, tags, links, keys, or any other data portion, or combination of data portions, or a portion thereof.

For example, the relational analysis unit 3700 may tokenize, identify semantics, or both, based on input data, such as input data representing user input, to generate the resolved request. The resolved request may include an ordered sequence of tokens that represent the request for data corresponding to the input data, and may transmit, send, or otherwise make accessible, the resolved request to the semantic interface unit 3600. The semantic interface unit 3600 may process or respond to a received resolved request.

In some implementations, the relational analysis unit 3700 may generate, determine, identify, or otherwise obtain, the resolved request (resolved request data) in accordance with a current access context (access-context object). For example, the current access context may indicate one or more active, or available, data sources, such as one or more available tables or worksheets available for responding to, or otherwise processing, the request for data, and the relational analysis unit 3700 may generate, determine, identify, or otherwise obtain, the resolved request (resolved request data) in accordance with one or more active, or available, data sources, which may omit, avoid, or exclude, using data, or data portions, other than the data, or data portions, available from the one or more active, or available, data sources.

The semantic interface unit 3600 may process or transform the received resolved request, which may be, at least in part, incompatible with the distributed in-memory database 3300, or an external database, to generate one or more corresponding data queries that are compatible with the distributed in-memory database 3300, or an external database, which may include generating a proto-query representing the resolved request, generating a pseudo-query representing the proto-query, and generating the data query representing the pseudo-query.

The semantic interface unit 3600 may generate an analytical object, such as an answer object, representing the resolved request, which may include representing the data expressing usage intent, such as by representing the request for data indicated by the data expressing usage intent.

The semantic interface unit 3600 may generate a proto query based on the resolved request. A proto-query, which may be database agnostic, may be structured or formatted in a form, language, or protocol that differs from the defined structured query language of the distributed in-memory database 3300, or the external database. Generating the proto-query may include identifying visualization identification data, such as an indication of a type of visualization, associated with the request for data, and generating the proto-query based on the resolved request and the visualization identification data.

The semantic interface unit 3600 may transform the proto query to generate a pseudo-query. The pseudo-query, which may be database agnostic, may be structured or formatted in a form, language, or protocol that differs from the defined structured query language of the distributed in-memory database 3300, or the external database. Generating a pseudo-query may include applying a defined transformation, or an ordered sequence of transformations. Generating a pseudo-query may include incorporating row-level security filters in the pseudo-query.

The semantic interface unit 3600 may generate a data query based on the pseudo-query, such as by serializing the pseudo-query. The data query, or a portion thereof, may be structured or formatted using the defined structured query language of the distributed in-memory database 3300. In some implementations, a data query may be structured or formatted using a defined structured query language of another database, such as an external database or data source, which may differ from the defined structured query language of the distributed in-memory database 3300. Generating the data query may include using one or more defined rules for expressing the structure and content of a pseudo-query in the respective defined structured query language.

The semantic interface unit 3600 may communicate, or issue, the data query to the distributed in-memory database 3300, or the external database. In some implementations, processing or responding to a resolved request may include generating and issuing multiple data queries to the distributed in-memory database 3300, or the external database.

The semantic interface unit 3600 may receive results data from the distributed in-memory database 3300, or the external database, responsive to one or more resolved requests. The semantic interface unit 3600 may process, format, or transform the results data to obtain visualization data. For example, the semantic interface unit 3600 may identify a visualization for representing or presenting the results data, or a portion thereof, such as based on the results data or a portion thereof. For example, the semantic interface unit 3600 may identify a bar chart visualization for results data including one measure and attribute.

Although not shown separately in FIG. 3, the semantic interface unit 3600 may include a data visualization unit. In some embodiments, the data visualization unit may be a distinct unit, separate from the semantic interface unit 3600. In some embodiments, the data visualization unit may be included in the system access interface unit 3900. The data visualization unit, the system access interface unit 3900, or a combination thereof, may generate a user interface, or one or more portions thereof. For example, data visualization unit, the system access interface unit 3900, or a combination thereof, may obtain the results data, such as the visualization data, and may generate user interface elements (visualizations) representing the results data.

The semantic interface unit 3600 may implement object-level security, row-level security, or a combination thereof. In some implementations, the security and governance unit 3200 may implement, or partially implement, the object-level security, row-level security, or a combination thereof, in combination with the semantic interface unit 3600. Object-level security may include security associated with an object, such as a table, a column, a worksheet, an answer, or a pinboard. The object-level security may include column-level security, which includes user-based or group-based access control of columns of data in the low-latency data, the indexes, or both. Row-level security may include user-based or group-based access control of rows of data in the low-latency data, the indexes, or both. The semantic interface unit 3600 may implement one or more authentication procedures, access control procedures, or a combination thereof. The object-level security, row-level security, column-level security, a combination thereof, or a portion thereof, may be represented, expressed, defined, or described as access-control data. The semantic interface unit 3600, or one or more other components of the low-latency data access and analysis system 3000, may control, such as grant, restrict, or prevent, access to one or more features, functions, units of data, or combinations thereof, in accordance with the access-control data. For example, in response to a request for data that includes a user identifier, the semantic interface unit 3600, or one or more other components of the low-latency data access and analysis system 3000, may obtain access-control data for the user identifier and may obtain results data in accordance with the access-control data such that a unit of data, such as a row or a column, that is identified in the access-control data as accessible to the user identifier and is responsive to the request for data is included in the results data and such that a unit of data, such as a row or a column, that is identified in the access-control data as inaccessible to the user identifier, or for which the access-control data omits or excludes corresponding data indicating that the unit of data is accessible to the user identifier, is omitted or excluded from the results data.

The semantic interface unit 3600 may implement one or more user-data integration features. For example, the semantic interface unit 3600 may generate and output a user interface, or a portion thereof, for inputting, uploading, or importing user data, may receive user data, and may import the user data. For example, the user data may be enterprise data.

The semantic interface unit 3600 may implement object statistical data collection. Object statistical data may include, for respective objects, temporal access information, access frequency information, access recency information, access requester information, or the like. For example, the semantic interface unit 3600 may obtain object statistical data as described with respect to the data utility unit 3720, the object utility unit 3810, or both. The semantic interface unit 3600 may send, transmit, or otherwise make available, the object statistical data for data objects to the data utility unit 3720. The semantic interface unit 3600 may send, transmit, or otherwise make available, the object statistical data for analytical objects to the object utility unit 3810.

The semantic interface unit 3600 may implement or expose one or more services or application programming interfaces. For example, the semantic interface unit 3600 may implement one or more services for access by the system access interface unit 3900. In some implementations, one or more services or application programming interfaces may be exposed to one or more external devices or systems.

The semantic interface unit 3600 may generate and transmit, send, or otherwise communicate, one or more external communications, such as e-mail messages, such as periodically, in response to one or more events, or both. For example, the semantic interface unit 3600 may generate and transmit, send, or otherwise communicate, one or more external communications including a portable representation, such as a portable document format representation of one or more pinboards in accordance with a defined schedule, period, or interval. In another example, the semantic interface unit 3600 may generate and transmit, send, or otherwise communicate, one or more external communications in response to input data indicating an express request for a communication. In another example, the semantic interface unit 3600 may generate and transmit, send, or otherwise communicate, one or more external communications in response to one or more defined events, such as the expiration of a recency of access period for a user.

Although shown as a single unit in FIG. 3, the relational analysis unit 3700 may be implemented in a distributed configuration, which may include a primary relational analysis unit instance and one or more secondary relational analysis unit instances.

The relational analysis unit 3700 may generate, maintain, operate, or a combination thereof, one or more indexes, such as one or more of an ontological index, a constituent data index, a control-word index, a numeral index, or a constant index, based on the low-latency data stored in the distributed in-memory database 3300, or the external database, the low-latency data access and analysis system 3000, or both. An index may be a defined data structure, or combination of data structures, for storing tokens, terms, or string keys, representing a set of data from one or more defined data sources in a form optimized for searching. For example, an index may be a collection of index shards. In some implementations, an index may be segmented into index segments and the index segments may be sharded into index shards. In some implementations, an index may be partitioned into index partitions, the index partitions may be segmented into index segments and the index segments may be sharded into index shards.

Generating, or building, an index may be performed to create or populate a previously unavailable index, which may be referred to as indexing the corresponding data, and may include regenerating, rebuilding, or reindexing to update or modify a previously available index, such as in response to a change in the indexed data (constituent data).

The ontological index may be an index of data (ontological data) describing the ontological structure or schema of the low-latency data access and analysis system 3000, the low-latency data stored in the distributed in-memory database 3300, or the external database, or a combination thereof. For example, the ontological index may include data representing the table and column structure of the distributed in-memory database 3300, or the external database. The relational analysis unit 3700 may generate, maintain, or both, the ontological index by communicating with, such as requesting ontological data from, the distributed in-memory ontology unit 3500, the semantic interface unit 3600, or both. Each record in the ontological index may correspond to a respective ontological token, such as a token that identifies a column by name.

The control-word index may be an index of a defined set of control-word tokens. For example, the control-word index may include the control-word token “sum”, which may be identified in one or more grammars of the low-latency data access and analysis system 3000 as indicating an additive aggregation. The constant index may be an index of constant, or literal, tokens such as “100” or “true”. The numeral index may be an index of number word tokens (or named numbers), such as number word tokens for the positive integers between zero and one million, inclusive.

The constituent data index may be an index of the constituent data values stored in the low-latency data access and analysis system 3000, or the external database, such as in the distributed in-memory database 3300. The relational analysis unit 3700 may generate, maintain, or both, the constituent data index by communicating with, such as requesting data from, the distributed in-memory database 3300, or the external database. For example, the relational analysis unit 3700 may send, or otherwise communicate, a message or signal to the distributed in-memory database 3300 indicating a request to perform an indexing data query, the relational analysis unit 3700 may receive response data from the distributed in-memory database 3300 in response to the requested indexing data query, and the relational analysis unit 3700 may generate the constituent data index, or a portion thereof, based on the response data. For example, the constituent data index may index data objects.

An index shard may be used for token searching, such as exact match searching, prefix match searching, substring match searching, or suffix match searching. Exact match searching may include identifying tokens in the index shard that matches a defined target value. Prefix match searching may include identifying tokens in the index shard that include a prefix, or begin with a value, such as a character or string, which matches a defined target value. Substring match searching may include identifying tokens in the index shard that include a value, such as a character or string, which matches a defined target value. Suffix match searching may include identifying tokens in the index shard that include a suffix, or end with a value, such as a character or string, which matches a defined target value. In some implementations, an index shard may include multiple distinct index data structures. For example, an index shard may include a first index data structure optimized for exact match searching, prefix match searching, and suffix match searching, and a second index data structure optimized for substring match searching. Traversing, or otherwise accessing, managing, or using, an index may include identifying one or more of the index shards of the index and traversing the respective index shards. In some implementations, one or more indexes, or index shards, may be distributed, such as replicated on multiple relational analysis unit instances. For example, the ontological index may be replicated on each relational analysis unit instance.

The relational analysis unit 3700 may receive a request for data from the low-latency data access and analysis system 3000. For example, the relational analysis unit 3700 may receive data expressing usage intent indicating the request for data in response to input, such as user input, obtained via a user interface, such as a user interface generated, or partially generated, by the system access interface unit 3900, which may be a user interface operated on an external device, such as one of the client devices 2320, 2340 shown in FIG. 2. In some implementations, the relational analysis unit 3700 may receive the data expressing usage intent from the system access interface unit 3900 or from the semantic interface unit 3600. For example, the relational analysis unit 3700 may receive or access the data expressing usage intent in a request for data message or signal.

The relational analysis unit 3700 may process, parse, identify semantics, tokenize, or a combination thereof, the request for data to generate a resolved request, which may include identifying a database and visualization agnostic ordered sequence of tokens based on the data expressing usage intent. The data expressing usage intent, or request for data, may include request data, such as resolved-request data, unresolved request data, or a combination of resolved-request data and unresolved request data. The relational analysis unit 3700 may identify the resolved-request data. The relational analysis unit 3700 may identify the unresolved request data and may tokenize the unresolved request data.

Resolved-request data may be request data identified in the data expressing usage intent as resolved-request data. Each resolved-request data portion may correspond with a respective token in the low-latency data access and analysis system 3000. The data expressing usage intent may include information identifying one or more portions of the request data as resolved-request data.

Unresolved request data may be request data identified in the data expressing usage intent as unresolved request data, or request data for which the data expressing usage intent omits information identifying the request data as resolved-request data. Unresolved request data may include text or string data, which may include a character, sequence of characters, symbol, combination of symbols, word, sequence of words, phrase, or the like, for which information, such as tokenization binding data, identifying the text or string data as resolved-request data is absent or omitted from the request data. The data expressing usage intent may include information identifying one or more portions of the request data as unresolved request data. The data expressing usage intent may omit information identifying whether one or more portions of the request data are resolved-request data. The relational analysis unit 3700 may identify one or more portions of the request data for which the data expressing usage intent omits information identifying whether the one or more portions of the request data are resolved-request data as unresolved request data.

For example, the data expressing usage intent may include a request string and one or more indications that one or more portions of the request string are resolved-request data. One or more portions of the request string that are not identified as resolved-request data in the data expressing usage intent may be identified as unresolved request data. For example, the data expressing usage intent may include the request string “example text”; the data expressing usage intent may include information indicating that the first portion of the request string, “example”, is resolved-request data; and the data expressing usage intent may omit information indicating that the second portion of the request string, “text”, is resolved-request data.

In some implementations, in the absence of data otherwise indicating unresolved request data in the request for data, the relational analysis unit 3700 may constructively identify the request for data as including a constructive unresolved request data portion, such as subsequent to resolved request data in the request for data. The relational analysis unit 3700 may may obtain candidate resolved request data corresponding to the constructive unresolved request data portion by identifying one or more data portions or tokens available in the data access and analysis system in accordance with current access context data. For example, the current access context data may identify a subset of the data sources available in the data access and analysis system as active, or available, data sources, and the relational analysis unit 3700 may identify data portions (contextually available data portions), or values thereof, from the active, or available, data sources, such as in accordance with the defined data-analytics grammar implemented by the data access and analysis system, as candidate resolved request data corresponding to the constructive unresolved request data portion, which may include excluding, or omitting, data portions from data sources available in the data access and analysis system other than the active, or available, data sources from the candidate resolved request data.

The information identifying one or more portions of the request data as resolved-request data may include tokenization binding data indicating a previously identified token corresponding to the respective portion of the request data. The tokenization binding data corresponding to a respective token may include, for example, one or more of a column identifier indicating a column corresponding to the respective token, a data type identifier corresponding to the respective token, a table identifier indicating a table corresponding to the respective token, an indication of an aggregation corresponding to the respective token, or an indication of a join path associated with the respective token. Other tokenization binding data may be used. In some implementations, the data expressing usage intent may omit the tokenization binding data and may include an identifier that identifies the tokenization binding data.

The relational analysis unit 3700 may implement or access one or more grammar-specific tokenizers, such as a tokenizer for a defined data-analytics grammar or a tokenizer for a natural-language grammar. For example, the relational analysis unit 3700 may implement one or more of a formula tokenizer, a row-level-security tokenizer, a data-analytics tokenizer, or a natural language tokenizer. Other tokenizers may be used. In some implementations, the relational analysis unit 3700 may implement one or more of the grammar-specific tokenizers, or a portion thereof, by accessing another component of the low-latency data access and analysis system 3000 that implements the respective grammar-specific tokenizer, or a portion thereof. For example, the natural language processing unit 3710 may implement the natural language tokenizer and the relational analysis unit 3700 may access the natural language processing unit 3710 to implement natural language tokenization. In another example, the semantic interface unit 3600, the database, or both, may implement a tokenizer for a grammar for the defined structured query language compatible with or implemented by the database. In some implementations, the low-latency data access and analysis system 3000, such as the semantic interface unit 3600, may implement a tokenizer for a grammar for a defined structured query language compatible with or implemented by an external database.

A tokenizer, such as the data-analytics tokenizer, may parse text or string data (request string), such as string data included in a data expressing usage intent, in a defined read order, such as from left to right, such as on a character-by-character or symbol-by-symbol basis. For example, a request string may include a single character, symbol, or letter, and tokenization may include identifying one or more tokens matching, or partially matching, the input character.

Tokenization may include parsing the request string to identify one or more words or phrases. For example, the request string may include a sequence of characters, symbols, or letters, and tokenization may include parsing the sequence of characters in a defined order, such as from left to right, to identify distinct words or terms and identifying one or more tokens matching the respective words. In some implementations, word or phrase parsing may be based on one or more of a set of defined delimiters, such as a whitespace character, a punctuation character, or a mathematical operator.

The relational analysis unit 3700 may traverse one or more of the indexes to identify one or more tokens corresponding to a character, word, or phrase identified in the request string. Tokenization may include identifying multiple candidate tokens matching a character, word, or phrase identified in the request string. Candidate tokens may be ranked or ordered, such as based on probabilistic utility.

Tokenization may include match-length maximization. Match-length maximization may include ranking or ordering candidate matching tokens in descending magnitude order. For example, the longest candidate token, having the largest cardinality of characters or symbols, matching the request string, or a portion thereof, may be the highest ranked candidate token. For example, the request string may include a sequence of words or a semantic phrase, and tokenization may include identifying one or more tokens matching the input semantic phrase. In another example, the request string may include a sequence of phrases, and tokenization may include identifying one or more tokens matching the input word sequence. In some implementations, tokenization may include identifying the highest ranked candidate token for a portion of the request string as a resolved token for the portion of the request string.

The relational analysis unit 3700 may implement one or more finite state machines. For example, tokenization may include using one or more finite state machines. A finite state machine may model or represent a defined set of states and a defined set of transitions between the states. A state may represent a condition of the system represented by the finite state machine at a defined temporal point. A finite state machine may transition from a state (current state) to a subsequent state in response to input (e.g., input to the finite state machine). A transition may define one or more actions or operations that the relational analysis unit 3700 may implement. One or more of the finite state machines may be non-deterministic, such that the finite state machine may transition from a state to zero or more subsequent states.

The relational analysis unit 3700 may generate, instantiate, or operate a tokenization finite state machine, which may represent the respective tokenization grammar. Generating, instantiating, or operating a finite state machine may include operating a finite state machine traverser for traversing the finite state machine. Instantiating the tokenization finite state machine may include entering an empty state, indicating the absence of received input. The relational analysis unit 3700 may initiate or execute an operation, such as an entry operation, corresponding to the empty state in response to entering the empty state. Subsequently, the relational analysis unit 3700 may receive input data, and the tokenization finite state machine may transition from the empty state to a state corresponding to the received input data. In some embodiments, the relational analysis unit 3700 may initiate one or more data queries in response to transitioning to or from a respective state of a finite state machine. In the tokenization finite state machine, a state may represent a possible next token in the request string. The tokenization finite state machine may transition between states based on one or more defined transition weights, which may indicate a probability of transiting from a state to a subsequent state.

The tokenization finite state machine may determine tokenization based on probabilistic path utility. Probabilistic path utility may rank or order multiple candidate traversal paths for traversing the tokenization finite state machine based on the request string. The candidate paths may be ranked or ordered based on one or more defined probabilistic path utility metrics, which may be evaluated in a defined sequence. For example, the tokenization finite state machine may determine probabilistic path utility by evaluating the weights of the respective candidate transition paths, the lengths of the respective candidate transition paths, or a combination thereof. In some implementations, the weights of the respective candidate transition paths may be evaluated with high priority relative to the lengths of the respective candidate transition paths.

In some implementations, one or more transition paths evaluated by the tokenization finite state machine may include a bound state such that the candidate tokens available for tokenization of a portion of the request string may be limited based on the tokenization of a previously tokenized portion of the request string.

Tokenization may include matching a portion of the request string to one or more token types, such as a constant token type, a column name token type, a value token type, a control-word token type, a date value token type, a string value token type, or any other token type defined by the low-latency data access and analysis system 3000. A constant token type may be a fixed, or invariant, token type, such as a numeric value. A column name token type may correspond with a name of a column in the data model. A value token type may correspond with an indexed data value. A control-word token type may correspond with a defined set of control-words. A date value token type may be similar to a control-word token type and may correspond with a defined set of control-words for describing temporal information. A string value token type may correspond with an unindexed value.

Token matching may include ordering or weighting candidate token matches based on one or more token matching metrics. Token matching metrics may include whether a candidate match is within a defined data scope, such as a defined set of tables, wherein a candidate match outside the defined data scope (out-of-scope) may be ordered or weighted lower than a candidate match within the defined data scope (in-scope). Token matching metrics may include whether, or the degree to which, a candidate match increases query complexity, such as by spanning multiple roots, wherein a candidate match that increases complexity may be ordered or weighted lower than a candidate match that does not increase complexity or increases complexity to a lesser extent. Token matching metrics may include whether the candidate match is an exact match or a partial match, wherein a candidate match that is a partial may be ordered or weighted lower than a candidate match that is an exact match. In some implementations, the cardinality of the set of partial matches may be limited to a defined value.

Token matching metrics may include a token score (TokenScore), wherein a candidate match with a relatively low token score may be ordered or weighted lower than a candidate match with a relatively high token score. The token score for a candidate match may be determined based on one or more token scoring metrics. The token scoring metrics may include a finite state machine transition weight metric (FSMScore), wherein a weight of transitioning from a current state of the tokenization finite state machine to a state indicating a candidate matching token is the finite state machine transition weight metric. The token scoring metrics may include a cardinality penalty metric (CardinalityScore), wherein a cardinality of values (e.g., unique values) corresponding to the candidate matching token is used as a penalty metric (inverse cardinality), which may reduce the token score. The token scoring metrics may include an index utility metric (IndexScore), wherein a defined utility value, such as one, associated with an object, such as a column wherein the matching token represents the column or a value from the column, is the index utility metric. In some implementations, the defined utility values may be configured, such as in response to user input, on a per object (e.g., per column) basis. The token scoring metrics may include a usage metric (UBRScore). The usage metric may be determined based on a usage based ranking index, one or more usage ranking metrics, or a combination thereof. Determining the usage metric (UBRScore) may include determining a usage boost value (UBRBoost). The token score may be determined based on a defined combination of token scoring metrics. For example, determining the token score may be expressed as the following:

$$TokenScore = FSMScore * ( IndexScore + UBRScore * UBRBoost ) + Min ( CardinalityScore , 1 ) .$$

Token matching may include grouping candidate token matches by match type, ranking or ordering on a per-match type basis based on token score, and ranking or ordering the match types. For example, the match types may include a first match type for exact matches (having the highest match type priority order), a second match type for prefix matches on ontological data (having a match type priority order lower than the first match type), a third match type for substring matches on ontological data and prefix matches on data values (having a match type priority order lower than the second match type), a fourth match type for substring matches on data values (having a match type priority order lower than the third match type), and a fifth match type for matches omitted from the first through fourth match types (having a match type priority order lower than the fourth match type). Other match types and match type orders may be used.

Tokenization may include ambiguity resolution. Ambiguity resolution may include token ambiguity resolution, join-path ambiguity resolution, or both. In some implementations, ambiguity resolution may cease tokenization in response to the identification of an automatic ambiguity resolution error or failure.

Token ambiguity may correspond with identifying two or more exactly matching candidate matching tokens. Token ambiguity resolution may be based on one or more token ambiguity resolution metrics. The token ambiguity resolution metrics may include using available previously resolved token matching or binding data and token ambiguity may be resolved in favor of available previously resolved token matching or binding data, other relevant tokens resolved from the request string, or both. The token ambiguity resolution may include resolving token ambiguity in favor of integer constants. The token ambiguity resolution may include resolving token ambiguity in favor of control-words, such as for tokens at the end of a request for data, such as last, that are not being edited.

Join-path ambiguity may correspond with identifying matching tokens having two or more candidate join paths. Join-path ambiguity resolution may be based on one or more join-path ambiguity resolution metrics. The join-path ambiguity resolution metrics may include using available previously resolved join-path binding data and join-path ambiguity may be resolved in favor of available previously resolved join-paths. The join-path ambiguity resolution may include favoring join paths that include in-scope objects over join paths that include out-of-scope objects. The join-path ambiguity resolution metrics may include a complexity minimization metric, which may favor a join path that omits or avoids increasing complexity over join paths that increase complexity, such as a join path that may introduce a chasm trap.

The relational analysis unit 3700 may identify a resolved request based on the request string. The resolved request, which may be database and visualization agnostic, may be expressed or communicated as an ordered sequence of tokens representing the request for data indicated by the request string. The relational analysis unit 3700 may instantiate, or generate, one or more resolved-request objects. For example, the relational analysis unit 3700 may create or store a resolved-request object corresponding to the resolved request in the distributed in-memory ontology unit 3500. The relational analysis unit 3700 may transmit, send, or otherwise make available, the resolved request to the semantic interface unit 3600.

In some implementations, the relational analysis unit 3700 may transmit, send, or otherwise make available, one or more resolved requests, or portions thereof, to the semantic interface unit 3600 in response to finite state machine transitions. For example, the relational analysis unit 3700 may instantiate a data-analysis object in response to a first transition of a finite state machine. The relational analysis unit 3700 may include a first data-analysis object instruction in the data-analysis object in response to a second transition of the finite state machine. The relational analysis unit 3700 may send the data-analysis object including the first data-analysis object instruction to the semantic interface unit 3600 in response to the second transition of the finite state machine. The relational analysis unit 3700 may include a second data-analysis object instruction in the data-analysis object in response to a third transition of the finite state machine. The relational analysis unit 3700 may send the data-analysis object including the data-analysis object instruction, or a combination of the first data-analysis object instruction and the second data-analysis object instruction, to the semantic interface unit 3600 in response to the third transition of the finite state machine. The data-analysis object instructions may be represented using any annotation, instruction, text, message, list, pseudo-code, comment, or the like, or any combination thereof that may be converted, transcoded, or translated into structured data-analysis instructions for accessing, retrieving, analyzing, or a combination thereof, data from the low-latency data, which may include generating data based on the low-latency data.

The relational analysis unit 3700 may provide an interface to permit the creation of user-defined syntax. For example, a user may associate a string with one or more tokens. Accordingly, when the string is entered, the pre-associated tokens are returned in lieu of searching for tokens to match the input.

The relational analysis unit 3700 may include a localization unit (not expressly shown). The localization, globalization, regionalization, or internationalization, unit may obtain source data expressed in accordance with a source expressive-form and may output destination data representing the source data, or a portion thereof, and expressed using a destination expressive-form. The data expressive-forms, such as the source expressive-form and the destination expressive-form, may include regional or customary forms of expression, such as numeric expression, temporal expression, currency expression, alphabets, natural-language elements, measurements, or the like. For example, the source expressive-form may be expressed using a canonical-form, which may include using a natural-language, which may be based on English, and the destination expressive-form may be expressed using a locale-specific form, which may include using another natural-language, which may be a natural-language that differs from the canonical-language. In another example, the destination expressive-form and the source expressive-form may be locale-specific expressive-forms and outputting the destination expressive-form representation of the source expressive-form data may include obtaining a canonical-form representation of the source expressive-form data and obtaining the destination expressive-form representation based on the canonical-form representation. Although, for simplicity and clarity, the grammars described herein, such as the data-analytics grammar and the natural language search grammar, are described with relation to the canonical expressive-form, the implementation of the respective grammars, or portions thereof, described herein may implement locale-specific expressive-forms. For example, the data-analytics tokenizer may include multiple locale-specific data-analytics tokenizers.

The natural language processing unit 3710 may receive input data including a natural language string, such as a natural language string generated in accordance with user input. The natural language string may represent a data request expressed in an unrestricted natural language form, for which data identified or obtained prior to, or in conjunction with, receiving the natural language string by the natural language processing unit 3710 indicating the semantic structure, correlation to the low-latency data access and analysis system 3000, or both, for at least a portion of the natural language string is unavailable or incomplete. Although not shown separately in FIG. 3, in some implementations, the natural language string may be generated or determined based on processing an analog signal, or a digital representation thereof, such as an audio stream or recording or a video stream or recording, which may include using speech-to-text conversion.

The natural language processing unit 3710 may analyze, process, or evaluate the natural language string, or a portion thereof, to generate or determine the semantic structure, correlation to the low-latency data access and analysis system 3000, or both, for at least a portion of the natural language string. For example, the natural language processing unit 3710 may identify one or more words or terms in the natural language string and may correlate the identified words to tokens defined in the low-latency data access and analysis system 3000. In another example, the natural language processing unit 3710 may identify a semantic structure for the natural language string, or a portion thereof. In another example, the natural language processing unit 3710 may identify a probabilistic intent for the natural language string, or a portion thereof, which may correspond to an operative feature of the low-latency data access and analysis system 3000, such as retrieving data from the internal data, analyzing data the internal data, or modifying the internal data.

The natural language processing unit 3710 may send, transmit, or otherwise communicate request data indicating the tokens, relationships, semantic data, probabilistic intent, or a combination thereof or one or more portions thereof, identified based on a natural language string to the relational analysis unit 3700.

The data utility unit 3720 may receive, process, and maintain user-agnostic utility data, such as system configuration data, user-specific utility data, such as utilization data, or both user-agnostic and user-specific utility data. The utility data may indicate whether a data portion, such as a column, a record, an insight, or any other data portion, has high utility or low utility within the system, such as among the users of the system. For example, the utility data may indicate that a defined column is a high-utility column or a low-utility column. The data utility unit 3720 may store the utility data, such as using the low-latency data structure. For example, in response to a user using, or accessing, a data portion, data utility unit 3720 may store utility data indicating the usage, or access, event for the data portion, which may include incrementing a usage event counter associated with the data portion. In some embodiments, the data utility unit 3720 may receive the information indicating the usage, or access, event for the data portion from the autonomous-analysis unit 3730, and the usage, or access, event for the data portion may indicate that the usage is associated with an insight.

As used herein, the term “utility” refers to a computer accessible data value, or values, representative of the usefulness of an aspect of the low-latency data access and analysis system, such as a data portion, an object, or a component of the low-latency data access and analysis system with respect to improving the efficiency, accuracy, or both, of the low-latency data access and analysis system. Unless otherwise expressly indicated, or otherwise clear from context, utility is relative within a defined data domain or scope. For example, the utility of an object with respect to a user may be high relative to the utility of other objects with respect to the user. Express utility indicates expressly specified, defined, or configured utility, such as user or system defined utility. Probabilistic utility indicates utility calculated or determined using utility data and expresses a statistical probability of usefulness for a respective aspect of the low-latency data access and analysis system. Unless otherwise expressly indicated, or otherwise clear from context, utility is access context specific. For example, the utility of an object with respect to the access context of a user may be high relative to the utility of the object with respect to the respective access contexts of other users.

The data utility unit 3720 may receive a signal, message, or other communication, indicating a request for utility information. The request for utility information may indicate an object or data portion. The data utility unit 3720 may determine, identify, or obtain utility data associated with the identified object or data portion. The data utility unit 3720 may generate and send utility response data responsive to the request that may indicate the utility data associated with the identified object or data portion.

The data utility unit 3720 may generate, maintain, operate, or a combination thereof, one or more indexes, such as one or more of a usage (or utility) index, a resolved-request index, or a phrase index, based on the low-latency data stored in the distributed in-memory database 3300, or the external database, the low-latency data access and analysis system 3000, or both.

The autonomous-analysis unit 3730 may automatically identify one or more insights, which may be data other than data expressly requested by a user, and which may be identified and prioritized, or both, based on probabilistic utility.

The object search unit 3800 may generate, maintain, operate, or a combination thereof, one or more object indexes, which may be based on the analytical objects represented in the low-latency data access and analysis system 3000, or a portion thereof, such as pinboards, answers, and worksheets. An object index may be a defined data structure, or combination of data structures, for storing analytical-object data in a form optimized for searching. Although shown as a single unit in FIG. 3, the object search unit 3800 may interface with a distinct, separate, object indexing unit (not expressly shown).

The object search unit 3800 may include an object-index population interface, an object-index search interface, or both. The object-index population interface may obtain and store, load, or populate analytical-object data, or a portion thereof, in the object indexes. The object-index search interface may efficiently access or retrieve analytical-object data from the object indexes such as by searching or traversing the object indexes, or one or more portions thereof. In some implementations, the object-index population interface, or a portion thereof, may be a distinct, independent unit.

The object-index population interface may populate, update, or both the object indexes, such as periodically, such as in accordance with a defined temporal period, such as thirty minutes. Populating, or updating, the object indexes may include obtaining object indexing data for indexing the analytical objects represented in the low-latency data access and analysis system 3000. For example, the object-index population interface may obtain the analytical-object indexing data, such as from the distributed in-memory ontology unit 3500. Populating, or updating, the object indexes may include generating or creating an indexing data structure representing an object. The indexing data structure for representing an object may differ from the data structure used for representing the object in other components of the low-latency data access and analysis system 3000, such as in the distributed in-memory ontology unit 3500.

The object indexing data for an analytical object may be a subset of the object data for the analytical object. The object indexing data for an analytical object may include an object identifier for the analytical object uniquely identifying the analytical object in the low-latency data access and analysis system 3000, or in a defined data domain within the low-latency data access and analysis system 3000. The low-latency data access and analysis system 3000 may uniquely, unambiguously, distinguish an object from other objects based on the object identifier associated with the object. The object indexing data for an analytical object may include data non-uniquely identifying the object. The low-latency data access and analysis system 3000 may identify one or more analytical objects based on the non-uniquely identifying data associated with the respective objects, or one or more portions thereof. In some implementations, an object identifier may be an ordered combination of non-uniquely identifying object data that, as expressed in the ordered combination, is uniquely identifying. The low-latency data access and analysis system 3000 may enforce the uniqueness of the object identifiers.

Populating, or updating, the object indexes may include indexing the analytical object by including or storing the object indexing data in the object indexes. For example, the object indexing data may include data for an analytical object, the object indexes may omit data for the analytical object, and the object-index population interface may include or store the object indexing data in an object index. In another example, the object indexing data may include data for an analytical object, the object indexes may include data for the analytical object, and the object-index population interface may update the object indexing data for the analytical object in the object indexes in accordance with the object indexing data.

Populating, or updating, the object indexes may include obtaining object utility data for the analytical objects represented in the low-latency data access and analysis system 3000. For example, the object-index population interface may obtain the object utility data, such as from the object utility unit 3810. The object-index population interface may include the object utility data in the object indexes in association with the corresponding objects.

In some implementations, the object-index population interface may receive, obtain, or otherwise access the object utility data from a distinct, independent, object utility data population unit, which may read, obtain, or otherwise access object utility data from the object utility unit 3810 and may send, transmit, or otherwise provide, the object utility data to the object search unit 3800. The object utility data population unit may send, transmit, or otherwise provide, the object utility data to the object search unit 3800 periodically, such as in accordance with a defined temporal period, such as thirty minutes.

The object-index search interface may receive, access, or otherwise obtain data expressing usage intent with respect to the low-latency data access and analysis system 3000, which may represent a request to access data in the low-latency data access and analysis system 3000, which may represent a request to access one or more analytical objects represented in the low-latency data access and analysis system 3000. The object-index search interface may generate one or more object-index queries based on the data expressing usage intent. The object-index search interface may send, transmit, or otherwise make available the object-index queries to one or more of the object indexes.

The object-index search interface may receive, obtain, or otherwise access object search results data indicating one or more analytical objects identified by searching or traversing the object indexes in accordance with the object-index queries. The object-index search interface may sort or rank the object search results data based on probabilistic utility in accordance with the object utility data for the analytical objects in the object search results data. In some implementations, the object-index search interface may include one or more object search ranking metrics with the object-index queries and may receive the object search results data sorted or ranked based on probabilistic utility in accordance with the object utility data for the objects in the object search results data and in accordance with the object search ranking metrics.

For example, the data expressing usage intent may include a user identifier, and the object search results data may include object search results data sorted or ranked based on probabilistic utility for the user. In another example, the data expressing usage intent may include a user identifier and one or more search terms, and the object search results data may include object search results data sorted or ranked based on probabilistic utility for the user identified by searching or traversing the object indexes in accordance with the search terms.

The object-index search interface may generate and send, transmit, or otherwise make available the sorted or ranked object search results data to another component of the low-latency data access and analysis system 3000, such as for further processing and display to the user.

The object utility unit 3810 may receive, process, and maintain user-specific object utility data for objects represented in the low-latency data access and analysis system 3000. The user-specific object utility data may indicate whether an object has high utility or low utility for the user.

The object utility unit 3810 may store the user-specific object utility data, such as on a per-object basis, a per-activity basis, or both. For example, in response to data indicating an object access activity, such as a user using, viewing, or otherwise accessing, an object, the object utility unit 3810 may store user-specific object utility data indicating the object access activity for the object, which may include incrementing an object access activity counter associated with the object, which may be a user-specific object access activity counter. In another example, in response to data indicating an object storage activity, such as a user storing an object, the object utility unit 3810 may store user-specific object utility data indicating the object storage activity for the object, which may include incrementing a storage activity counter associated with the object, which may be a user-specific object storage activity counter. The user-specific object utility data may include temporal information, such as a temporal location identifier associated with the object activity. Other information associated with the object activity may be included in the object utility data.

The object utility unit 3810 may receive a signal, message, or other communication, indicating a request for object utility information. The request for object utility information may indicate one or more objects, one or more users, one or more activities, temporal information, or a combination thereof. The request for object utility information may indicate a request for object utility data, object utility counter data, or both.

The object utility unit 3810 may determine, identify, or obtain object utility data in accordance with the request for object utility information. The object utility unit 3810 may generate and send object utility response data responsive to the request that may indicate the object utility data, or a portion thereof, in accordance with the request for object utility information.

For example, a request for object utility information may indicate a user, an object, temporal information, such as information indicating a temporal span, and an object activity, such as the object access activity. The request for object utility information may indicate a request for object utility counter data. The object utility unit 3810 may determine, identify, or obtain object utility counter data associated with the user, the object, and the object activity having a temporal location within the temporal span, and the object utility unit 3810 may generate and send object utility response data including the identified object utility counter data.

In some implementations, a request for object utility information may indicate multiple users, or may omit indicating a user, and the object utility unit 3810 may identify user-agnostic object utility data aggregating the user-specific object utility data. In some implementations, a request for object utility information may indicate multiple objects, may omit indicating an object, or may indicate an object type, such as answer, pinboard, or worksheet, and the object utility unit 3810 may identify the object utility data by aggregating the object utility data for multiple objects in accordance with the request. Other object utility aggregations may be used.

The system configuration unit 3820 implements or applies one or more low-latency data access and analysis system configurations to enable, disable, or configure one or more operative features of the low-latency data access and analysis system 3000. The system configuration unit 3820 may store data representing or defining the one or more low-latency data access and analysis system configurations. The system configuration unit 3820 may receive signals or messages indicating input data, such as input data generated via a system access interface, such as a user interface, for accessing or modifying the low-latency data access and analysis system configurations. The system configuration unit 3820 may generate, modify, delete, or otherwise maintain the low-latency data access and analysis system configurations, such as in response to the input data. The system configuration unit 3820 may generate or determine output data, and may output the output data, for a system access interface, or a portion or portions thereof, for the low-latency data access and analysis system configurations, such as for presenting a user interface for the low-latency data access and analysis system configurations. Although not shown in FIG. 3, the system configuration unit 3820 may communicate with a repository, such as an external centralized repository, of low-latency data access and analysis system configurations; the system configuration unit 3820 may receive one or more low-latency data access and analysis system configurations from the repository, and may control or configure one or more operative features of the low-latency data access and analysis system 3000 in response to receiving one or more low-latency data access and analysis system configurations from the repository.

The user customization unit 3830 may receive, process, and maintain user-specific utility data, user defined configuration data, user defined preference data, or a combination thereof. The user-specific utility data may indicate whether a data portion, such as a column, a record, autonomous-analysis (autoanalysis) data, or any other data portion or object, has high utility or low utility to an identified user. For example, the user-specific utility data may indicate that a defined column is a high-utility column or a low-utility column. The user customization unit 3830 may store the user-specific utility data, such as using the low-latency data structure. The user-specific utility data may include, feedback data, such as feedback indicating user input expressly describing or representing the utility of a data portion or object in response to utilization of the data portion or object, such as positive feedback indicating high utility or negative feedback indicating low utility. The user customization unit 3830 may store the feedback in association with a user identifier. The user customization unit 3830 may store the feedback in association with the access context in which feedback was obtained. The user customization data, or a portion thereof, may be stored in an in-memory storage unit of the low-latency data access and analysis system. In some implementations, the user customization data, or a portion thereof, may be stored in the persistent storage unit 3930.

The system access interface unit 3900 may interface with, or communicate with, a system access unit (not shown in FIG. 3), which may be a client device, a user device, or another external device or system, or a combination thereof, to provide access to the internal data, features of the low-latency data access and analysis system 3000, or a combination thereof. For example, the system access interface unit 3900 may receive signals, message, or other communications representing interactions with the internal data, such as data expressing usage intent and may output response messages, signals, or other communications responsive to the received requests.

The system access interface unit 3900 may generate data for presenting a user interface, or one or more portions thereof, for the low-latency data access and analysis system 3000. For example, the system access interface unit 3900 may generate instructions for rendering, or otherwise presenting, the user interface, or one or more portions thereof and may transmit, or otherwise make available, the instructions for rendering, or otherwise presenting, the user interface, or one or more portions thereof to the system access unit, for presentation to a user of the system access unit. For example, the system access unit may present the user interface via a web browser, or a web application, and the instructions may be in the form of Hypertext Markup Language (HTML), JavaScript, or the like.

In an example, the system access interface unit 3900 may include a data-analytics field user interface element in the user interface. The data-analytics field user interface element may be an unstructured string user input element or field. The system access unit may display the unstructured string user input element. The system access unit may receive input data, such as user input data, corresponding to the unstructured string user input element. The system access unit may transmit, or otherwise make available, the unstructured string user input to the system access interface unit 3900. The user interface may include other user interface elements, and the system access unit may transmit, or otherwise make available, other user input data to the system access interface unit 3900.

The system access interface unit 3900 may obtain the user input data, such as the unstructured string, from the system access unit. The system access interface unit 3900 may transmit, or otherwise make available, the user input data to one or more of the other components of the low-latency data access and analysis system 3000.

In some embodiments, the system access interface unit 3900 may obtain the unstructured string user input as a sequence of individual characters or symbols, and the system access interface unit 3900 may sequentially transmit, or otherwise make available, individual or groups of characters or symbols of the user input data to one or more of the other components of the low-latency data access and analysis system 3000.

In some embodiments, system access interface unit 3900 may obtain the unstructured string user input as a sequence of individual characters or symbols, the system access interface unit 3900 may aggregate the sequence of individual characters or symbols, and may sequentially transmit, or otherwise make available, a current aggregation of the received user input data to one or more of the other components of the low-latency data access and analysis system 3000, in response to receiving respective characters or symbols from the sequence, such as on a per-character or per-symbol basis.

The real-time collaboration unit 3910 may receive signals or messages representing input received in accordance with multiple users, or multiple system access devices, associated with a collaboration context or session, may output data, such as visualizations, generated or determined by the low-latency data access and analysis system 3000 to multiple users associated with the collaboration context or session, or both. The real-time collaboration unit 3910 may receive signals or messages representing input received in accordance with one or more users indicating a request to establish a collaboration context or session, and may generate, maintain, or modify collaboration data representing the collaboration context or session, such as a collaboration session identifier. The real-time collaboration unit 3910 may receive signals or messages representing input received in accordance with one or more users indicating a request to participate in, or otherwise associate with, a currently active collaboration context or session, and may associate the one or more users with the currently active collaboration context or session. In some implementations, the input, output, or both, of the real-time collaboration unit 3910 may include synchronization data, such as temporal data, that may be used to maintain synchronization, with respect to the collaboration context or session, among the low-latency data access and analysis system 3000 and one or more system access devices associated with, or otherwise accessing, the collaboration context or session.

The third-party integration unit 3920 may include an electronic communication interface, such as an application programming interface (API), for interfacing or communicating between an external, such as third party, application or system, and the low-latency data access and analysis system 3000. For example, the third-party integration unit 3920 may include an electronic communication interface to transfer data between the low-latency data access and analysis system 3000 and one or more external applications or systems, such as by importing data into the low-latency data access and analysis system 3000 from the external applications or systems or exporting data from the low-latency data access and analysis system 3000 to the external applications or systems. For example, the third-party integration unit 3920 may include an electronic communication interface for electronic communication with an external exchange, transfer, load (ETL) system, which may import data into the low-latency data access and analysis system 3000 from an external data source or may export data from the low-latency data access and analysis system 3000 to an external data repository. In another example, the third-party integration unit 3920 may include an electronic communication interface for electronic communication with external machine learning analysis software, which may export data from the low-latency data access and analysis system 3000 to the external machine learning analysis software and may import data into the low-latency data access and analysis system 3000 from the external machine learning analysis software. The third-party integration unit 3920 may transfer data independent of, or in conjunction with, the system access interface unit 3900, the enterprise data interface unit 3400, or both.

The persistent storage unit 3930 may include an interface for storing data on, accessing data from, or both, one or more persistent data storage devices or systems. For example, the persistent storage unit 3930 may include one or more persistent data storage devices, such as the static memory 1200 shown in FIG. 1. Although shown as a single unit in FIG. 3, the persistent storage unit 3930 may include multiple components, such as in a distributed or clustered configuration. The persistent storage unit 3930 may include one or more internal interfaces, such as electronic communication or application programming interfaces, for receiving data from, sending data to, or both other components of the low-latency data access and analysis system 3000. The persistent storage unit 3930 may include one or more external interfaces, such as electronic communication or application programming interfaces, for receiving data from, sending data to, or both, one or more external systems or devices, such as an external persistent storage system. For example, the persistent storage unit 3930 may include an internal interface for obtaining key-value tuple data from other components of the low-latency data access and analysis system 3000, an external interface for sending the key-value tuple data to, or storing the key-value tuple data on, an external persistent storage system, an external interface for obtaining, or otherwise accessing, the key-value tuple data from the external persistent storage system, and an internal key-value tuple data for sending, or otherwise making available, the key-value tuple data to other components of the low-latency data access and analysis system 3000. In another example, the persistent storage unit 3930 may include a first external interface for storing data on, or obtaining data from, a first external persistent storage system, and a second external interface for storing data on, or obtaining data from, a second external persistent storage system.

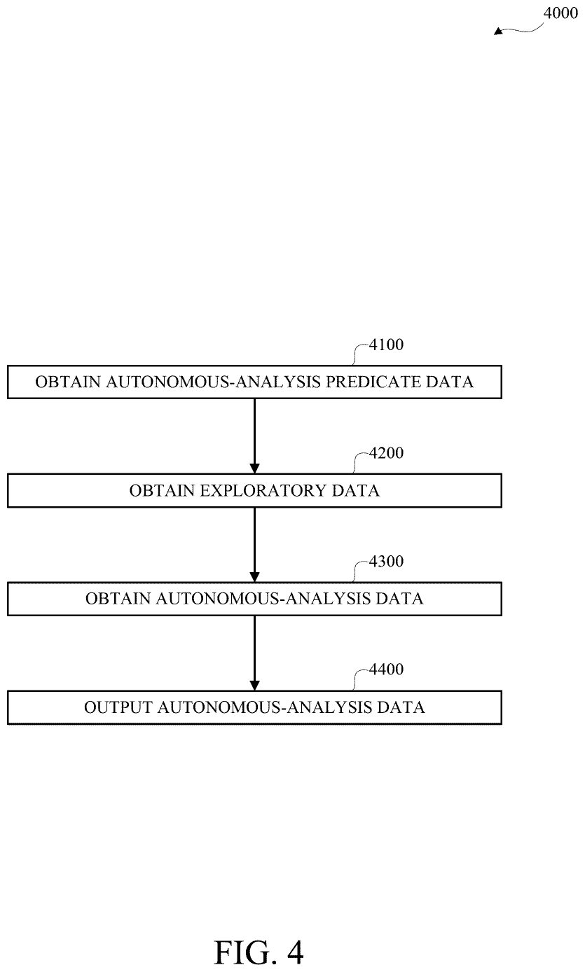

FIG. 4 is a flow diagram of an example of autonomous data analytics with real-time feature selection 4000 in a data access and analysis system. Autonomous data analytics with real-time feature selection 4000 may be implemented in a data access and analysis system, such as the data access and analysis system 3000 shown in FIG. 3. For example, autonomous data analytics with real-time feature selection 4000, or a portion thereof, may be implemented in an autonomous-analysis unit of the data access and analysis system, such as the autonomous-analysis unit 3730 shown in FIG. 3.

As shown in FIG. 4, autonomous data analytics with real-time feature selection 4000 includes obtaining autonomous-analysis predicate data (at 4100), obtaining exploratory data (at 4200), obtaining autonomous-analysis data (at 4300), and outputting the autonomous-analysis data (at 4400).

The data access and analysis system, or a component thereof, such as a semantic interface of the data access and analysis system, such as the semantic interface unit 3600 shown in FIG. 3, or an autonomous-analysis unit of the data access and analysis system, such as the autonomous-analysis unit 3730 shown in FIG. 3, obtains the autonomous-analysis predicate data (at 4100). An autonomous-analysis predicate data may be a basis for performing autonomous data analytics with real-time feature selection, such as a current context, or a portion thereof, one or more analytical objects (predicate analytical objects), one or more resolved requests, one or more data queries, or a combination thereof. For example, the autonomous-analysis unit may receive, obtain, or otherwise access, a current context, such as from a system access interface unit of the data access and analysis system, such as the system access interface unit 3900 shown in FIG. 3, from a relational analysis unit of the data access and analysis system, such as the relational analysis unit 3700 shown in FIG. 3, or from another component of the data access and analysis system. The current context may include data representing a request for data from the data access and analysis system, such as a resolved request or a data query, which may correspond with previously generated autonomous-analysis data, and the current context, or a portion thereof, such as the resolved request or the data query, may be identified as the autonomous-analysis predicate data. The autonomous-analysis predicate data may include data identifying one or more data source objects, such as a table or columns. The autonomous-analysis predicate data may include requestor data, such as data indicating a current user, group, organization, or a combination thereof. In some implementations, the autonomous-analysis predicate data obtained (at 4100) may include utility data, or a portion thereof.

In an example, the autonomous-analysis predicate data includes, or indicates, a predicate analytical object (first analytical object) stored in the data access and analysis system as a representation of a request for data analysis with respect to data stored in a database accessible by the data access and analysis system. The request for data analysis may be expressed in the predicate analytical object as resolved-request data. The data access and analysis system, or a component thereof, may obtain requested results data responsive to the request for data analysis. The requested results data responsive to the request for data analysis differs from the autonomous-analysis data obtained by autonomous data analytics with real-time feature selection 4000.

In some implementations, the autonomous-analysis predicate data (or the ontological data) includes data indicating an analytical object (second analytical object) stored in the data access and analysis system as a representation of a defined subset of analytical objects, including the predicate analytical object, stored in the data access and analysis system.

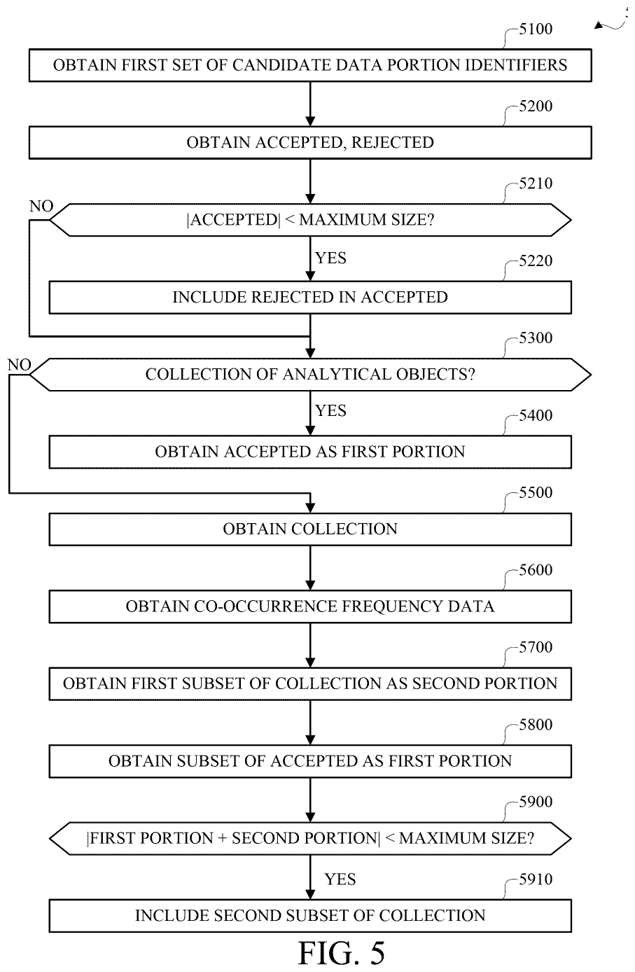

The data access and analysis system, or a component thereof, such as a semantic interface of the data access and analysis system, such as the semantic interface unit 3600 shown in FIG. 3, or an autonomous-analysis unit of the data access and analysis system, such as the autonomous-analysis unit 3730 shown in FIG. 3, obtains the exploratory data (at 4200). An example of obtaining exploratory data is shown in FIG. 5.

The data access and analysis system, or a component thereof, such as the autonomous-analysis unit, obtains the exploratory data, such as from the semantic interface, and obtains the autonomous-analysis data (at 4300).

Obtaining the autonomous-analysis data (at 4300) may include identifying one or more types of autonomous-analysis. A respective type of autonomous-analysis may correspond with one or more defined autonomous-analysis policies. The data access and analysis system may include one or more defined ‘outlier’ autonomous-analysis policies for obtaining outlier type autonomous-analysis data (outlier autonomous-analysis). The data access and analysis system may include one or more defined ‘cross-correlation’ autonomous-analysis policies for obtaining cross-correlation type autonomous-analysis data (cross-correlation autonomous-analysis). The data access and analysis system may include one or more defined ‘trend’ autonomous-analysis policies for obtaining trend type autonomous-analysis data (trend autonomous-analysis). The data access and analysis system may include one or more defined ‘comparative’ autonomous-analysis policies for obtaining comparative type autonomous-analysis data (comparative autonomous-analysis). Other autonomous-analysis policies and types may be used. The autonomous-analysis policies may be algorithms, such as machine learning algorithms or models, or solutions thereof, which may automatically update or self-tune based on one or more characteristics of the low-latency data, the utility data, or a combination thereof. One or more of outlier autonomous-analysis, cross-correlation autonomous-analysis, trend autonomous-analysis, and comparative autonomous-analysis, or respective portions thereof, may performed substantially concurrently, such as in parallel. For example, obtaining the autonomous-analysis data (insights), may include generating the autonomous-analysis data based on the autonomous-analysis predicate data, the exploratory data, and one or more of the defined autonomous-analysis policies, such as by obtaining first autonomous-analysis data based on a first defined autonomous-analysis policy and second autonomous-analysis data based on a second defined autonomous-analysis policy.

Obtaining the autonomous-analysis data (at 4300) may include generating one or more exploratory data queries based on the autonomous-analysis predicate data and the exploratory data portions indicated by the exploratory data portion identifiers (obtained at 4200), obtaining the exploratory results data based on the exploratory data queries, and obtaining the autonomous-analysis data based on the exploratory results data. For example, the exploratory results data may be obtained from a distributed in-memory database of the data access and analysis system, such as the distributed in-memory database 3300 shown in FIG. 3. In another example, the exploratory results data may be obtained from an external database accessible by the data access and analysis system.

Obtaining the exploratory results data may include obtaining exploratory results, or an exploratory result set, for a respective exploratory data query, which may correspond with a respective exploratory data portion indicated by the exploratory data portion identifiers (obtained at 4200), by sending, or otherwise making available, the exploratory data query to the database and obtaining, or otherwise accessing, the corresponding exploratory results generated by the database responsive to the exploratory data query. An exploratory data query, corresponding exploratory data sources, exploratory results, or a combination thereof, may be referred to herein as a drill path. For example, the data query included in the autonomous-analysis predicate data may indicate grouping corresponding results data based on a first attribute, and the exploratory data query may indicate grouping the exploratory results based on a combination of the first attribute and an exploratory attribute. Obtaining the exploratory data may include obtaining multiple sets of exploratory results based on a respective exploratory attribute.

Obtaining the autonomous-analysis data may include obtaining outlier autonomous-analysis data (outliers or anomalies) based on one or more outlier autonomous-analysis policies, the autonomous-analysis predicate data, and the exploratory data. For a respective exploratory attribute, or exploratory chronometric attribute, the autonomous-analysis unit may generate a corresponding exploratory data query. The exploratory data query may indicate one or more measures, such as one or more of the exploratory measures, one or more of the measures indicated in the autonomous-analysis predicate data, or a combination thereof, one or more attributes or chronometric attributes indicated in the autonomous-analysis predicate data, and the respective exploratory attribute or exploratory chronometric attribute. In some implementations, the data query indicated in the autonomous-analysis predicate data may be used as an exploratory data query.

The autonomous-analysis unit may send, transmit, or otherwise make available, the exploratory data query to the database (distributed in-memory database or external database), and may receive, obtain, or otherwise access, an exploratory results set responsive to the exploratory data query, such as from the database. The autonomous-analysis unit may cache the exploratory results data in an in-memory data storage unit of the autonomous-analysis unit.

In some implementations, the autonomous-analysis unit may determine whether exploratory results data corresponding to, or satisfying, the respective exploratory data query is available (cached) in the in-memory cache of the autonomous-analysis unit, and may use the cached exploratory results data and omit obtaining exploratory results data from the database for the respective exploratory data query, in response to a determination that the exploratory results data is cached.

The autonomous-analysis unit may identify the outlier autonomous-analysis data based on the exploratory results data. For example, the autonomous-analysis unit may identify respective outlier autonomous-analysis data based on a respective exploratory results set. Obtaining outlier autonomous-analysis data may include identifying measure values that are statistically exceptional from the exploratory results data.

For example, the autonomous-analysis predicate data may include the resolved request ‘precipitation by year’, or a corresponding data query. The exploratory attribute ‘State’ may be identified (at 4200), an exploratory data query corresponding to ‘precipitation by year by state’ may be generated and used to obtain exploratory results representing precipitation values grouped by year and by State, and exceptional precipitation values, for a year and State, may be identified as outliers. An outlier may indicate an attribute value and a measure value from the data distribution of the exploratory results data.

Obtaining outlier autonomous-analysis data may include using a linear regression-based outlier autonomous-analysis policy, such an Ordinary Least Squares based outlier autonomous-analysis policy. Obtaining outlier autonomous-analysis data may include using a z-score based outlier autonomous-analysis policy. Obtaining outlier autonomous-analysis data using a z-score based outlier autonomous-analysis policy may include identifying a current value from the exploratory results data as an outlier by determining an average of corresponding values from the exploratory results data, identifying a multiple of a standard deviation from the average, and identifying the current value as an outlier in response to a determination that the difference between the current value and the average exceeds, such as is greater than, the multiple of the standard deviation. A multiplier for determining the multiple of the standard deviation may be automatically identified. For example, the multiplier may be proportional to the cardinality of the exploratory results data. For example, the exploratory results data may have a cardinality, such as number of rows, less than twenty and the multiplier may be two, the exploratory results data may have a cardinality greater than or equal to twenty and less than five-hundred and the multiplier may be 3, the exploratory results data may have a cardinality greater than or equal to five-hundred and less than ten-thousand and the multiplier may be 4, or the exploratory results data may have a cardinality greater than or equal to ten-thousand and the multiplier may be 5. A relatively large multiplier may correspond with identifying relatively few, such as zero, outliers. A relatively small multiplier may correspond with identifying a greater cardinality of outliers relative to the relatively large multiplier. In some implementations, obtaining outlier autonomous-analysis data may include iteratively relaxing, or reducing, the multiplier, such as in a range from a maximum value to a minimum value, to identify a cardinality of outliers that satisfies a defined minimum threshold. In some implementations, the multiplier may be expressly identified, such as based on user input.

In some implementations, obtaining outlier autonomous-analysis data (outliers or anomalies) based on one or more outlier autonomous-analysis policies, such as a comparative outlier autonomous-analysis policy, the autonomous-analysis predicate data, and the exploratory data, may include the autonomous-analysis unit generating an exploratory data query indicating one or more expressions, equations, or formulas (exploratory expressions) for obtaining one or more derived, or calculated, exploratory data aggregations, such as one or more exploratory measure aggregations, in the exploratory results data.

For example, the autonomous-analysis predicate data may include the resolved request ‘precipitation by year’, or a corresponding data query. The exploratory attribute ‘State’ may be identified (at 4200) as an exploratory attribute data portion identifier, and, in accordance with the comparative outlier autonomous-analysis policy, the autonomous-analysis unit may generate an exploratory data query corresponding to ‘precipitation by year by state’ and including a first exploratory expression for obtaining a first exploratory measure aggregation and a second exploratory expression for obtaining a second exploratory measure aggregation. The first exploratory expression for obtaining the first exploratory measure aggregation data may be an expression for obtaining data (first exploratory measure aggregation data), such as a column including values, indicating an absolute value of a difference (absolute difference value) between a precipitation value for a respective state with respect to a first year (first chronometric attribute value), such as a most recent year, and a precipitation value for the respective state with respect to a second year, such as a next most recent year. The second exploratory expression for obtaining the second exploratory measure aggregation may be an expression for obtaining data, such as a column including values, indicating a percentage value of the difference (percentage difference value) between the precipitation value for the respective state with respect to the first year and the precipitation value for the respective state with respect to the second year (second chronometric attribute value). In some implementations, the first year and the second year may be configured. The exploratory data query may be used to obtain exploratory results data representing precipitation values grouped by year and by State with corresponding absolute difference values and percentage difference values. The exploratory results data may be sorted, such as in descending order of absolute difference values. Exceptional precipitation values, for a year and State, may be identified as outliers. An outlier may indicate an attribute value and a measure value from the data distribution of the exploratory results data. In accordance with the comparative outlier autonomous-analysis policy, the autonomous-analysis unit may identify a subset of, such as rows from, the exploratory results data as outliers, by evaluating the exploratory results data, such as in descending order of absolute difference values (descending order of the first exploratory measure aggregation data), to identify a minimum number, count, or cardinality of rows from the exploratory results data that is less than or equal to a defined maximum number, count, or cardinality of rows (θ), such as ten (θ=10), and for which a sum of the corresponding precipitation values from the first year from the respective rows is greater than or equal to half (0.50 or 50%) of a sum of the corresponding precipitation values from the first year from the rows from the exploratory results data, wherein the exploratory results data includes a number, count, or cardinality of rows (N), or a sum of the precipitation values corresponding to the second year from the respective rows is greater than or equal to half of a sum of the precipitation values corresponding to the second year from the rows from the exploratory results data, which may be expressed as the following:

$$( {\sum }_{i}^{n < N} ( {Precipitation}_{y ear 1 i} ) \geq 0.50 {\sum }_{i}^{N} ( {Precipitation}_{y ear 1 i} ) ‖ {\sum }_{i}^{n < N} ( {Precipitation}_{y ear 2 i} ) \geq 0.50 {\sum }_{i}^{N} ( {Precipitation}_{y ear 2 i} ) ) .$$

Obtaining the autonomous-analysis data (at 4300) may include ranking or scoring the outliers and corresponding autonomous-analysis datasets. The outliers identified based on a respective exploratory results data portion may be sorted, ranked, or scored (exploratory results data portion-specific score). For example, the outliers may be sorted, ranked, or scored based on the magnitude of the difference between the value of the outlier data portion and the respective expected value, average, or other scoring metric. A combined set of outliers may be ranked, sorted, or scored based on the exploratory results data portion specific score (exploratory results data portion-agnostic ranking).

Obtaining the autonomous-analysis data may include obtaining trend autonomous-analysis data (trends) based on one or more trend autonomous-analysis policies, the autonomous-analysis predicate data, and the exploratory results data. The autonomous-analysis unit may generate an exploratory data query for trend autonomous-analysis for respective distinct combinations of a measure, such as one of the exploratory measures or one of the measures indicated in the autonomous-analysis predicate data, and a chronometric attribute, such as one of the exploratory chronometric attributes or one of chronometric attributes indicated in the autonomous-analysis predicate data.

The autonomous-analysis unit may send, transmit, or otherwise make available, the exploratory data query to the database, and may receive, obtain, or otherwise access, an exploratory results set responsive to the exploratory data query, such as from the database. The autonomous-analysis unit may cache the exploratory results data in an in-memory data storage unit of the autonomous-analysis unit.

In some implementations, the autonomous-analysis unit may determine whether exploratory results data corresponding to, or satisfying, the respective exploratory data query is available (cached) in the in-memory cache of the autonomous-analysis unit, and may use the cached exploratory results data and omit obtaining exploratory results data from the database for the respective exploratory data query, in response to a determination that the exploratory results data is cached.

The autonomous-analysis unit may identify the trend autonomous-analysis data based on the exploratory results data. For example, the autonomous-analysis unit may identify respective trend autonomous-analysis data based on a respective exploratory results set. Obtaining trend autonomous-analysis data may include identifying a statistical trend of values of a measure for a value of an attribute over time from the exploratory results data. A trend may indicate an attribute value and a temporal sequence of measure values from the data distribution of the exploratory results data.

For example, the autonomous-analysis predicate data may include the resolved request ‘precipitation by state’, or a corresponding data query. The exploratory chronometric attribute corresponding to ‘Year’ may be identified (at 4200), an exploratory data query corresponding to ‘precipitation by state by year’ may be generated and used to obtain exploratory results representing precipitation values grouped by State and by year, and trends of the precipitation values (measure value), among years (temporal value), by State (attribute value), may be identified as trends.

The autonomous-analysis unit may generate a trend analysis model, such as a linear regression model, based on the exploratory results data. The autonomous-analysis unit may determine whether a threshold metric of the trend analysis model, such as a probability value (p_value) of a linear regression model, satisfies a defined criterion, such as is at least, such as greater than or equal to, a defined minimum value. The threshold metric may be less than the defined minimum value, the trend analysis model may be rejected, such as omitted from use, and trend autonomous-analysis data for the respective combination of exploratory measure and exploratory chronometric attribute may be unavailable. The threshold metric may satisfy the defined criterion, the trend analysis model may be accepted, the respective combination of exploratory measure and exploratory chronometric attribute may be identified as a trend, and a slope and intercept may be identified for the trend analysis model.

Obtaining the autonomous-analysis data (at 4300) may include ranking or scoring the trends and the corresponding autonomous-analysis datasets. The trends identified based on a respective exploratory results data portion may be sorted, ranked, or scored (exploratory results data portion-specific score). For example, the trends may be sorted, ranked, or scored based on a trend ranking basis. A combined set of trends may be ranked, sorted, or scored based on the exploratory results data portion specific score (exploratory results data portion-agnostic ranking).

Obtaining the autonomous-analysis data may include obtaining cross-correlation autonomous-analysis data (cross-correlations) based on one or more cross-correlation autonomous-analysis policies, the autonomous-analysis predicate data, and the exploratory results data. The autonomous-analysis unit may generate an exploratory data query for cross-correlation autonomous-analysis for respective distinct combinations of a distinct pair of measures, such as measures from the exploratory measures or from the measures indicated in the autonomous-analysis predicate data, and one or more chronometric attribute, such as one of the exploratory chronometric attributes or one of chronometric attributes indicated in the autonomous-analysis predicate data.

For example, an exploratory data query may be generated based on an attribute, a first measure, a second measure, and a chronometric attribute associated with the first measure and the second measure. In another example, an exploratory data query may be generated based on an attribute, a first measure, a chronometric attribute associated with the first measure, a second measure, and a chronometric attribute associated with the second measure.

The autonomous-analysis unit may send, transmit, or otherwise make available, the exploratory data query to the database, and may receive, obtain, or otherwise access, an exploratory results set responsive to the exploratory data query, such as from the database. The autonomous-analysis unit may cache the exploratory results data in an in-memory data storage unit of the autonomous-analysis unit.

In some implementations, the autonomous-analysis unit may determine whether exploratory results data corresponding to, or satisfying, the respective exploratory data query is available (cached) in the in-memory cache of the autonomous-analysis unit, and may use the cached exploratory results data and omit obtaining exploratory results data from the database for the respective exploratory data query, in response to a determination that the exploratory results data is cached.

The autonomous-analysis unit may identify the cross-correlation autonomous-analysis data based on the exploratory results data. For example, the autonomous-analysis unit may identify respective cross-correlation autonomous-analysis data based on a respective exploratory results set. Obtaining cross-correlation autonomous-analysis data may include identifying a statistical correlation, such as bivariate correlation, of a value of a first measure, from the pair of measures, with respect to a value of an attribute, at a value of a chronometric attribute relative to a value of a second measure, from the pair of measures, at a value of a chronometric attribute from the exploratory results data. For example, the autonomous-analysis predicate data obtained (at 4100) may include a resolved request, or a corresponding data query, which includes a ‘precipitation’ measure, a ‘State’ attribute, and a ‘precipitation-date’ chronometric attribute. An exploratory measure ‘temperature’ may be identified (at 4200). An exploratory data query corresponding to ‘precipitation and temperature by state by year’ may be generated and used to obtain exploratory results representing precipitation values (measure value) and temperature values (measure value) grouped by State (attribute value) and by year (temporal value). A cross-correlation may indicate an attribute value, a first temporal sequence of measure values, a second, correlated, temporal sequence of measure values from the data distribution, or distributions, of the exploratory results data, and a correlation lag.

In some implementations, obtaining cross-correlation autonomous-analysis data may include identifying a statistical correlation, such as bivariate correlation, of a value of a first measure, from the pair of measures, with respect to a value of an attribute, at a value of a first chronometric attribute relative to a value of a second measure, from the pair of measures, at a value of a second chronometric attribute from the exploratory results data. For example, the autonomous-analysis predicate data obtained (at 4100) may include a resolved request, or a corresponding data query, which includes a ‘precipitation’ measure, a ‘State’ attribute, and a ‘precipitation-date’ chronometric attribute. An exploratory measure, ‘temperature’, and an exploratory chronometric attribute, ‘temperature-date’, may be identified (at 4200). A first exploratory data query corresponding to ‘precipitation by state by precipitation-year’ may be generated and used to obtain first exploratory results representing precipitation values grouped by State and by precipitation-year, and a second exploratory data query corresponding to ‘temperature by state by temperature-year’ may be generated and used to obtain first exploratory results representing temperature values grouped by State and by temperature-year. In some implementations, identifying a cross-correlation may include determining a coefficient of correlation indicating a probabilistic likelihood of correlation.

Cross-correlation may include aligning, or identifying a basis for aligning, a distribution of values of a first measure, from a pair of measures, with a distribution of values of a second measure, from the pair of measures, with respect to a value of an attribute, wherein the respective measure values are distributed in the temporal domain. A difference between temporal locations corresponding to the distribution of values of the first measure and temporal locations corresponding to the distribution of values of the second measure may be identified as a lag. For example, the correlation may be determined based on a value of a measure corresponding to a value of a date-attribute and a value of another measure corresponding to the value of the date-attribute, or a temporally equivalent value of another date-attribute, which may correspond with zero lag. In another example, the correlation may be determined based on a value of a measure corresponding to a value of a date-attribute and a value of another measure corresponding to another value of the date-attribute, or of another date-attribute, which may correspond with a non-zero lag. The maximal correlation may be determined for a range of lag values, such as from zero lag to a defined maximum lag.

In some implementations, the magnitude of the temporal difference between adjacent lag values (lag step size) may be determined based on the autonomous-analysis predicate data. For example, the autonomous-analysis predicate data may indicate a chronometric unit determining an aggregate measure value. For example, the resolved request ‘precipitation by month’ indicates a request for aggregations of month-wise groups of precipitation values, and the lag step size may be identified as corresponding to a month. In some implementations, the magnitude of the temporal difference between adjacent lag values (lag step size) may be determined based on the exploratory results data. For example, the resolved request ‘precipitation by date’ indicates a request for aggregations of precipitation values based on temporal groupings and omits an indication of a chronometric unit for the temporal grouping. Generating the exploratory results data includes determining a chronometric unit for the temporal grouping. For example, the chronometric unit for the temporal grouping may be identified by determining a chronometric unit magnitude, or step size, such that grouping the source data used for generating the exploratory date in accordance with the chronometric unit generates a cardinality of groups or categories that is with a defined range. The chronometric unit used for grouping the exploratory results data may be used as the lag step size. In some implementations, the chronometric unit associated with the exploratory results corresponding to a first date-attribute may differ from the chronometric unit associated with the exploratory results corresponding to a second date-attribute, and the larger chronometric unit may be used as the lag step size.

Obtaining the autonomous-analysis data (at 4300) may include ranking or scoring the cross-correlations and the corresponding autonomous-analysis datasets. The cross-correlations identified based on a respective exploratory results data portion may be sorted, ranked, or scored (exploratory results data portion-specific score). For example, the cross-correlations may be sorted, ranked, or scored based on a cross-correlation ranking basis. A combined set of cross-correlations may be ranked, sorted, or scored based on the exploratory results data portion specific score (exploratory results data portion-agnostic ranking).

Obtaining the autonomous-analysis data may include obtaining comparative autonomous-analysis data (comparatives) based on one or more comparative autonomous-analysis policies, the autonomous-analysis predicate data, two or more comparative tuples, and the exploratory results data.

Obtaining the autonomous-analysis predicate data (at 4100) may include obtaining data indicating two or more comparative tuples, such as comparative tuples identified in response to user input selecting the comparative tuples. A comparative tuple may include an attribute value of an attribute, such as an attribute value from results data corresponding to a resolved request, or data query, indicated in the autonomous-analysis predicate data. The comparative tuples may include a measure value of a measure, such as a measure value from results data corresponding to a resolved request, or data query, indicated in the autonomous-analysis predicate data. The comparative tuples may indicate a request for comparative autonomous data analytics of the comparative tuples.

For example, a first comparative tuple may include a first attribute value of an attribute and a first measure value of a measure, corresponding to the first attribute value. A second comparative tuple may include a second attribute value of the attribute and a second measure value of the measure, corresponding to the second attribute value. The comparative tuples may indicate a request for comparative autonomous data analytics of a difference between the first measure value, associated with the first attribute value, and the second measure value, associated with the second attribute value.

Although two comparative tuples are described herein, three or more comparative tuples may be used. For example, the comparative tuples may include three comparative tuples. The first comparative tuple may include a first attribute value of an attribute and a first measure value of a measure, corresponding to the first attribute value. The second comparative tuple may include a second attribute value of the attribute and a second measure value of the measure, corresponding to the second attribute value. The third comparative tuple may include a third attribute value of the attribute and a third measure value of the measure, corresponding to the third attribute value. The comparative tuples may indicate a request for comparative autonomous data analytics of differences among the first measure value, associated with the first attribute value, the second measure value, associated with the second attribute value, and the third measure value, associated with the third attribute value.

Although two values of a measure and two values of an attribute are described herein, values of two or more attributes, two or more measures, or both, may be used. For example, the first comparative tuple may include a first attribute value of a first attribute, a second attribute value of a second attribute, and a first measure value, of a measure, corresponding to the first attribute value and the second attribute value. The second comparative tuple may include a third attribute value of the first attribute, a fourth attribute value of the second attribute, and a second measure value, of a measure, corresponding to the third attribute value and the fourth attribute value. The comparative tuples may indicate a request for comparative autonomous data analytics of a difference between the first measure value, associated with the first attribute value and the second attribute value, and the second measure value, associated with the third attribute value and the fourth attribute value.

The autonomous-analysis unit may generate an exploratory data query for comparative autonomous-analysis based on the resolved request, or data query, indicated in the autonomous-analysis predicate data, the comparative tuples, and one or more exploratory attributes. For example, an exploratory data query may be generated based on a first attribute, such as an attribute from the autonomous-analysis predicate data, a first value of the first attribute from the comparative tuples, a second value of the attribute from the comparative tuples, a measure, such as a measure from the autonomous-analysis predicate data, and an exploratory attribute. Respective data queries may be generated and used to obtain respective exploratory results on a per-exploratory attribute basis.

The autonomous-analysis unit may send, transmit, or otherwise make available, the exploratory data query to the database, and may receive, obtain, or otherwise access, an exploratory results set responsive to the exploratory data query, such as from the database. The autonomous-analysis unit may cache the exploratory results data in an in-memory data storage unit of the autonomous-analysis unit.

In some implementations, the autonomous-analysis unit may determine whether exploratory results data corresponding to, or satisfying, the respective exploratory data query is available (cached) in the in-memory cache of the autonomous-analysis unit, and may use the cached exploratory results data and omit obtaining exploratory results data from the database for the respective exploratory data query, in response to a determination that the exploratory results data is cached.

The autonomous-analysis unit may identify the comparative autonomous-analysis data based on the exploratory results data. For example, the autonomous-analysis unit may identify respective comparative autonomous-analysis data based on a respective exploratory results set.

Obtaining comparative autonomous-analysis data may include determining a difference between the value of the measure corresponding to the first value of the comparative attribute and the value of the measure corresponding to the second value of the comparative attribute. For example, the autonomous-analysis predicate data may include the resolved request ‘precipitation by year’, or a corresponding data query. A first comparative tuple may indicate a first year (comparative attribute value) and a first precipitation value (measure value). A second comparative tuple may indicate a second year (comparative attribute value) and a second precipitation value (measure value). The request for comparative autonomous data analytics may indicate a request to identify a basis for a difference between the first precipitation value and the second precipitation value.

Obtaining comparative autonomous-analysis data may include, on a per-exploratory attribute value basis, determining a difference between a value of the measure, corresponding to the first value of the comparative attribute and a respective value of the exploratory attribute, and a value of the measure, corresponding to the second value of the comparative attribute and the respective value of the exploratory attribute. For example, the autonomous-analysis predicate data may include the resolved request ‘precipitation by year’, or a corresponding data query. A first comparative tuple may indicate a first year (comparative attribute value) and a first precipitation value (measure value). A second comparative tuple may indicate a second year (comparative attribute value) and a second precipitation value (measure value). The exploratory attribute corresponding to ‘State’ may be identified (at 4200), an exploratory data query corresponding to ‘precipitation by state for the first year and the second year’ may be generated and used to obtain exploratory results representing precipitation values grouped by State and by year for the first year and the second year, and differences in the precipitation values between the first year and the second year on a state-by-state basis may be determined. In some implementations, the exploratory results may include a value indicating the difference in the precipitation values between the first year and the second year for a respective State.

Obtaining comparative autonomous-analysis data may include, on a per-exploratory attribute basis, identifying a subset (contributors) of the values of the exploratory attribute, the contributors including exploratory attribute values corresponding to differences of measure values associated with the respective exploratory attribute values, such as in descending magnitude order with respect to the differences of measure values.

For example, the autonomous-analysis predicate data may include the resolved request ‘precipitation by year’, or a corresponding data query. A first comparative tuple may indicate a first year (comparative attribute value) and a first precipitation value (measure value). A second comparative tuple may indicate a second year (comparative attribute value) and a second precipitation value (measure value). The exploratory attribute corresponding to ‘State’ may be identified (at 4200), an exploratory data query corresponding to ‘precipitation by state for the first year and the second year’ may be generated and used to obtain exploratory results representing precipitation values grouped by State and by year for the first year and the second year, and differences in the precipitation values between the first year and the second year on a state-by-state basis may be determined. The difference between the precipitation value for the first year for a first State and the precipitation value for the second year and the first state may be the highest magnitude precipitation value difference among the precipitation value differences corresponding to states and years. The difference between the precipitation value for the first year for a second State and the precipitation value for the second year and the second state may be the second-highest magnitude precipitation value difference among the precipitation value differences corresponding to states and years. The first State and the Second State may be identified as the contributors.

Obtaining comparative autonomous-analysis data may include, on a per-exploratory attribute basis, determining, for a respective contributor, for a respective measure value, a corresponding share value indicating a ratio of the exploratory attribute-specific measure value, associated with a value of the comparative attribute and a value of the exploratory attribute, to the exploratory attribute-agnostic measure value, associated with the value of the comparative attribute. Obtaining comparative autonomous-analysis data may include determining a difference between respective share values for the contributors, indicating a relative portion of the difference of the comparative measure values that corresponds to the respective exploratory attribute. Obtaining comparative autonomous-analysis data may include, on a per-exploratory attribute basis, identifying exceptional share value differences (share value exceptions), such as using a z-score analysis of the share value differences. Obtaining comparative autonomous-analysis data may include, on a per-exploratory attribute basis, may include identifying contributors corresponding to share value exceptions as comparative insights.

For example, the autonomous-analysis predicate data may include the resolved request ‘precipitation by year’, or a corresponding data query. A first comparative tuple may indicate a first year (comparative attribute value), such as 1999 and a first precipitation value (measure value), such as 47091. A second comparative tuple may indicate a second year (comparative attribute value), such as 2000, and a second precipitation value (measure value), such as 54243. The exploratory attribute corresponding to ‘State’ may be identified (at 4200), an exploratory data query corresponding to ‘precipitation by state for the first year and the second year’ may be generated and used to obtain exploratory results representing precipitation values grouped by State and by year for the first year and the second year, and differences in the precipitation values between the first year and the second year on a state-by-state basis may be determined. The difference between a precipitation value, such as 1618, for the first year, 1999, for a first State, such as Hawaii, and the precipitation value, such as 1864, for the second year, 2000, and the first state may be the second highest magnitude precipitation value difference, approximately 246, among the precipitation value differences corresponding to states and years. The share value for Hawaii for 1999 is approximately 0.034. The share value for Hawaii for 2000 is approximately 0.034. The share value difference for precipitation in Hawaii between 1999 and 2000 is 0. The difference between a precipitation value, 1528, for the first year for a second State, such as Louisiana, and the precipitation value, 1869, for the second year and the second state may be the highest magnitude precipitation value difference, approximately 341, among the precipitation value differences corresponding to states and years. The share value for Louisiana for 1999 is 0.032. The share value for Louisiana for 2000 is approximately 0.034. The share value difference for precipitation in Louisiana between 1999 and 2000 is approximately 0.002. The first State, Hawaii, and the second State, Louisiana, may be identified as the contributors. Louisiana may be identified as a contributor and as corresponding to a share value exception and may be identified as a comparative insight.

Obtaining the autonomous-analysis data (at 4300) may include ranking or scoring the comparatives and the corresponding autonomous-analysis datasets. The comparatives identified based on a respective exploratory results data portion may be sorted, ranked, or scored (exploratory results data portion-specific score). For example, the comparatives may be sorted, ranked, or scored based on a comparative ranking basis. A combined set of comparatives may be ranked, sorted, or scored based on the exploratory results data portion specific score (exploratory results data portion-agnostic ranking).

The autonomous-analysis data, such as an insight or an autonomous-analysis dataset, generated based on an exploratory result set and a defined autonomous-analysis policy may include a respective context, which may be generated for the autonomous-analysis dataset, an autonomous-analysis data query, which may be based on the exploratory data query and the defined autonomous-analysis policy, corresponding results data, or a combination thereof.

The autonomous-analysis data may be output (at 4400). For example, a defined cardinality of outlier autonomous-analysis datasets may be output, such as in rank, score, or order of the outlier autonomous-analysis datasets identified (at 4300), a defined cardinality of trend autonomous-analysis datasets may be output, such as in rank, score, or order of the trend autonomous-analysis datasets identified (at 4300), a defined cardinality of cross-correlation autonomous-analysis datasets may be output, such as in rank, score, or order of the cross-correlation autonomous-analysis datasets identified (at 4300), a defined cardinality of comparative autonomous-analysis datasets may be output, such as in rank, score, or order of the comparative autonomous-analysis datasets identified (at 4300), or a combination thereof, may be output (at 4400).

Outputting the autonomous-analysis data (at 4400) may include generating a visualization, a natural-language narrative, or a combination thereof, for a respective autonomous-analysis dataset.

Generating the visualization for the respective autonomous-analysis dataset may include identifying a visualization template, identifying one or more visualization parameter values in accordance with the visualization template, and generating the visualization based on the identified visualization parameter values in accordance with the visualization template.

The natural-language narrative, or description, may be a text string that describes the respective autonomous-analysis dataset, the corresponding visualization, the corresponding autonomous-analysis type, the utility thereof, or a combination thereof. The natural-language narrative may be generated based on the autonomous-analysis dataset in accordance with a defined natural-language narrative template, which may be associated with the corresponding autonomous-analysis type.

The visualizations, natural-language narratives, or both for the autonomous-analysis data may be output, such as sent, transmitted, or otherwise made available, to the system access interface unit for presentation to a user, such as via a user interface.

Outputting the autonomous-analysis data (at 4400) may include generating a data query, an answer object, or both, representing the autonomous-analysis data. The data query, the answer object, or both, may be stored in the data access and analysis system, such as in an in-memory data storage unit of the data access and analysis system or in a persistent storage unit of the data access and analysis system, such as the persistent storage unit 3930 shown in FIG. 3.

FIG. 5 is a flow diagram of an example of obtaining exploratory data 5000 in a data access and analysis system. Obtaining exploratory data 5000 may be implemented in a data access and analysis system, such as the data access and analysis system 3000 shown in FIG. 3. For example, obtaining exploratory data 5000, or a portion thereof, may be implemented in an autonomous-analysis unit of the data access and analysis system, such as the autonomous-analysis unit 3730 shown in FIG. 3.

Obtaining exploratory data 5000 includes obtaining the exploratory data in accordance with autonomous-analysis predicate data, such as the autonomous-analysis predicate data obtained as shown (at 4100) in FIG. 4, including a request for data analysis, wherein the requested data analysis differs from the autonomous data analysis.

Obtaining exploratory data 5000 includes obtaining a subset of data portion identifiers available in the data access and analysis system as exploratory data portion identifiers identifying data portions, such as columns, available in the data access and analysis system, as data portions of utility (exploratory data portions), such as a column of utility (exploratory columns). An exploratory data portion identifier may be identified in response to a determination that a probabilistic utility for the corresponding data portion satisfies a defined utility criterion.

In some implementations, the data access and analysis system, or a component thereof, may identify a defined maximum size (nx or first defined maximum size) for the subset of data portion identifiers, indicating a defined maximum number, count, or cardinality, of data portion identifiers to obtain as the subset of data portion identifiers.

To obtain the exploratory data, the data access and analysis system, or a component thereof, such as the semantic interface, may send, transmit, or otherwise make available autonomous-analysis predicate data, such as the autonomous-analysis predicate data obtained as shown (at 4100) in FIG. 4, or one or more portions thereof, to another component of the data access and analysis system, such as a relational analysis unit of the data access and analysis system, such as the relational analysis unit 3700 shown in FIG. 3.

To obtain the exploratory data, the data access and analysis system, or a component thereof, such as the relational analysis unit, may obtain resolved-request data from the predicate analytical object expressing the request for data analysis.

To obtain the exploratory data, the data access and analysis system, or a component thereof, such as the relational analysis unit, may obtain filtered resolved-request data that includes the resolved-request data other than one or more defined components, such as phrases, thereof, such as ranking phrases, cardinality phrases, or ranking cardinality phrases, such as “top 10”. For example, the resolved-request data may include the string, or a correspond sequence of tokens, “top 10 precipitation days last year” and the filtered resolved-request data may include the string, or a correspond sequence of tokens, “precipitation days last year.”

In some implementations, the data access and analysis system, or a component thereof, such as the relational analysis unit, may determine whether the filtered resolved-request data indicates a measure data portion or measure data portions. In some implementations, in response to a determination that the data indicating a measure data portion is absent, omitted, or unavailable, from the filtered resolved-request data, obtaining exploratory data 5000, autonomous data analytics with real-time feature selection as shown in FIG. 4, or both, may be otherwise omitted or skipped.

In some implementations, in response to a determination that the filtered resolved-request data indicates a measure data portion or measure data portions the data access and analysis system, or a component thereof, such as the relational analysis unit, may identify a maximum number, count, or cardinality, of exploratory attribute data portion identifiers to obtain.

In some implementations, in response to a determination that the filtered resolved-request data indicates a measure data portion or measure data portions the data access and analysis system, or a component thereof, such as the relational analysis unit, may identify a maximum number, count, or cardinality, of exploratory chronometric (date) data portion identifiers to obtain.

In some implementations, in response to a determination that the filtered resolved-request data indicates a measure data portion or measure data portions the data access and analysis system, or a component thereof, such as the relational analysis unit, may identify a chronometric (date) data portion index value indicated in the filtered resolved-request data.

Obtaining exploratory data 5000 includes obtaining a first set of candidate data portion identifiers (at 5100), filtering the first set of candidate data portion identifiers (at 5200), determining whether a size of the set of accepted candidate data portion identifiers (|accepted|) is less than the first defined maximum size (at 5210), including in the set of accepted candidate data portion identifiers a subset of the set of rejected candidate data portion identifiers (at 5220), determining whether a collection of analytical objects includes the predicate analytical object (at 5300), including the accepted candidate data portion identifiers in the first portion of the subset of data portion identifiers available in the data access and analysis system (at 5400), obtaining a collection of data portion identifiers indicated in ontological data for respective analytical objects from the subset of analytical objects (at 5500), co-occurrence frequency data (at 5600), obtaining the second portion of the subset of data portion identifiers available in the data access and analysis system (at 5700), obtaining the first portion of the subset of data portion identifiers available in the data access and analysis system (at 5800), determining whether a sum of a size of the first portion and a size of the second portion is less than the first defined maximum size (at 5900), and including in the subset of data portion identifiers a second subset of the collection of data portion identifiers in descending co-occurrence frequency score order (at 5910).

The data access and analysis system, or a component thereof, such as the relational analysis unit, obtains a first portion of the subset of data portion identifiers available in the data access and analysis system in accordance with the request for data analysis, data portion utility data stored in the data access and analysis system, and one or more defined data utility heuristics.

To obtain the first portion of the subset of data portion identifiers available in the data access and analysis system, the data access and analysis system, or a component thereof, such as the relational analysis unit, obtains the first set of candidate data portion identifiers (at 5100).

To obtain the first set of candidate data portion identifiers (at 5100), the data access and analysis system, or a component thereof, such as the relational analysis unit, generates a request, message, or other signal, to obtain the first set of candidate data portion identifiers. In some implementations, the data access and analysis system, or a component thereof, such as the relational analysis unit, includes the filtered resolved-request data in the request for the first set of candidate data portion identifiers. In some implementations, the data access and analysis system, or a component thereof, such as the semantic interface, includes data indicating the maximum number, count, or cardinality, of exploratory attribute data portion identifiers to obtain in the request for the first set of candidate data portion identifiers. In some implementations, the data access and analysis system, or a component thereof, such as the relational analysis unit, includes data indicating the maximum number, count, or cardinality, of exploratory chronometric (date) data portion identifiers to obtain in the request for the first set of candidate data portion identifiers. In some implementations, the data access and analysis system, or a component thereof, such as the relational analysis unit, includes the chronometric (date) data portion index value in the request for the first set of candidate data portion identifiers.

In some implementations, the data access and analysis system, or a component thereof, such as the relational analysis unit, may identify a defined target size (n), such as twenty-five (n=25), for the first set of candidate data portion identifiers available in the data access and analysis system, indicating a defined target number, count, or cardinality, of data portion identifiers to obtain as the first set of candidate data portion identifiers.

In some implementations, the data access and analysis system, or a component thereof, such as the relational analysis unit, includes data indicating the defined target size (n) in the request for the first set of candidate data portion identifiers.

To obtain the first set of candidate data portion identifiers (at 5100), the data access and analysis system, or a component thereof, such as the semantic interface, sends, transmits, or otherwise makes available, the request, message, or other signal, to obtain the first set of candidate data portion identifiers to another component of the data access and analysis system, such as a data utility unit of the data access and analysis system, such as the data utility unit 3720 shown in FIG. 3.

The data utility unit may identify one or more data portions of utility (candidate exploratory data portions) in accordance with the request for data analysis indicated in the request, message, or other signal, to obtain the first set of candidate data portion identifiers.

The data utility unit may identify one or more data portions of utility (candidate exploratory data portions) for the first set of candidate data portion identifiers in accordance with data portion utility data stored in the data access and analysis system. For example, the autonomous-analysis predicate data may include resolved request data corresponding to previously generated results data, such as requested results data; the resolved request data may include measure data, such as measure tokens or measure objects corresponding to columns stored in, or accessible by, the data access and analysis system that are identified as measure columns, and the data utility unit may identify one or more attributes (candidate exploratory attributes, available attributes, or drill attributes), such as attribute tokens or attribute objects corresponding to columns stored in, or accessible by, the data access and analysis system identified as attribute columns, one or more measures (candidate exploratory measures, available measures, or drill measures), such as measure tokens or measure objects corresponding to columns stored in, or accessible by, the data access and analysis system identified as measure columns, or a combination thereof.

One or more of the candidate exploratory data portions indicated by the first set of candidate data portion identifiers may be identified based on ontological data, such as a schema graph, describing data portions, such as columns and tables, of the low-latency data, and relationships among the data portions. For example, one or more of the candidate exploratory data portions may be identified from one or more tables (exploratory tables or exploratory data sources), other than the tables indicated by the autonomous-analysis predicate data, which may be identified based on ontological data indicating relationships between the exploratory tables and the tables indicated by the autonomous-analysis predicate data.

The candidate exploratory data portions indicated by the first set of candidate data portion identifiers may be ordered, ranked, or weighted based on the corresponding utility data. In some implementations, the candidate exploratory attributes may be ordered, ranked, or weighted with respect to other candidate exploratory attributes and the candidate exploratory measures may be ordered, ranked, or weighted with respect to other candidate exploratory measures. The utility data may be user-specific, group-specific, organization-specific, or a combination thereof.

For example, the data utility unit may identify features (for probabilistic data modeling) corresponding to the respective portions of the data source, such as the resolved request, indicated in the autonomous-analysis predicate data. For example, the autonomous-analysis predicate data may include a table object as the data source, and respective columns of the table may be identified as respective features. In another example, the autonomous-analysis predicate data may include a resolved request, such as a resolved request including the ordered sequence of tokens ‘yearly’ ‘precipitation’, and each of the respective data portions, ‘yearly’ and ‘precipitation’, may be identified as features. Phrase information for the autonomous-analysis predicate data may be identified as features. For example, the autonomous-analysis predicate data may include the resolved request including the ordered sequence of tokens ‘yearly’ ‘precipitation’, and the phrase type ‘measure by attribute’ (e.g., ‘precipitation’ by ‘year’) may be identified as an attribute. In another example, a pairwise combination of constraints, such as a combination of a user identifier and a column identifier may be a feature. In some implementations, the graph-distance of a candidate exploratory data portion from the data portions indicated in the autonomous-analysis predicate data may be included as negative weights for the determination of the probability of utility. For example, a first column from a first table, wherein the first table is indicated in the autonomous-analysis predicate data, may have a relatively low graph-distance weight, such as zero, a second column from a second table, which may have an edge connecting the second table to the first table in the ontological-graph, may have a graph-distance weight that is higher than the graph-distance weight of the first column, wherein a higher graph-distance weight indicates a lower probability of utility, and a third column from a third table, which may have an edge connecting the third table to the second table in the ontological-graph, may have a graph-distance weight that is higher than the graph-distance weight of the second column.

The data utility unit may identify a respective probability distribution for candidate exploratory data portions for a respective identified feature. The data utility unit may generate a combined probability distribution by combining the respective probability distribution for the respective identified features using a machine learning model. For example, the data utility unit may output, such as write, or otherwise make available, a file including the identified features, and a machine learning model generation process may read, or otherwise access, the file including the identified features, and may generate the combined probability distribution. The data utility unit may identify the candidate exploratory data portions based on the combined probability distribution. The data utility unit may identify the candidate exploratory data portions as an ordered, weighted, or both, list of candidate exploratory data portions, wherein the respective order, weight, or both, indicates a probabilistic likelihood of utility for a respective candidate exploratory data portion based on the autonomous-analysis predicate data. The data utility unit may output, send, or otherwise make available, the ordered, weighted, or both, set or list of candidate exploratory data portions to the relational analysis unit. The set or list of candidate exploratory data portions may include data indicating a data portion type, such as attribute, measure, or chronometric attribute, for the respective data portions. The attribute data portions include the chronometric attribute portions, except as described herein or otherwise clear from context.

The data access and analysis system, or a component thereof, such as the data utility unit, sends, transmits, or otherwise makes available, data indicating the candidate exploratory data portions, which may be ordered, sorted, ranked, weighted, or a combination thereof, as the first set of candidate data portion identifiers, to a component of the data access and analysis system, such as the relational analysis unit. In some implementations, the data indicating the candidate exploratory data portions (the first set of candidate data portion identifiers) may include the number, count, or cardinality of candidate exploratory data portions (data portions of utility) corresponding to the defined target size (n) for the first set of candidate data portion identifiers. In some implementations, the data indicating the candidate exploratory data portions (the first set of candidate data portion identifiers) may include data utility data indicating the probability of utility for respective candidate exploratory data portions, or the corresponding candidate data portion identifiers.

To obtain the first set of candidate data portion identifiers (at 5100), the data access and analysis system, or a component thereof, such as the relational analysis unit, receives, reads, obtains, or otherwise accesses, data indicating the first set of candidate data portion identifiers in accordance with, or responsive to, the request for data analysis and the data portion utility data.

To obtain the first portion of the subset of data portion identifiers available in the data access and analysis system, the data access and analysis system, or a component thereof, such as the relational analysis unit, filters the first set of candidate data portion identifiers in accordance with the one or more defined data utility heuristics (heuristic-based modification).

Filtering the first set of candidate data portion identifiers includes obtaining a set of accepted candidate data portion identifiers, a set of rejected candidate data portion identifiers, or both, (at 5200), determining whether a size (number, count, or cardinality) of the set of accepted candidate data portion identifiers (|accepted) is less than the first defined maximum size (nx) (at 5210), and including in the set of accepted candidate data portion identifiers a subset of the set of rejected candidate data portion identifiers in descending data utility order (at 5220).

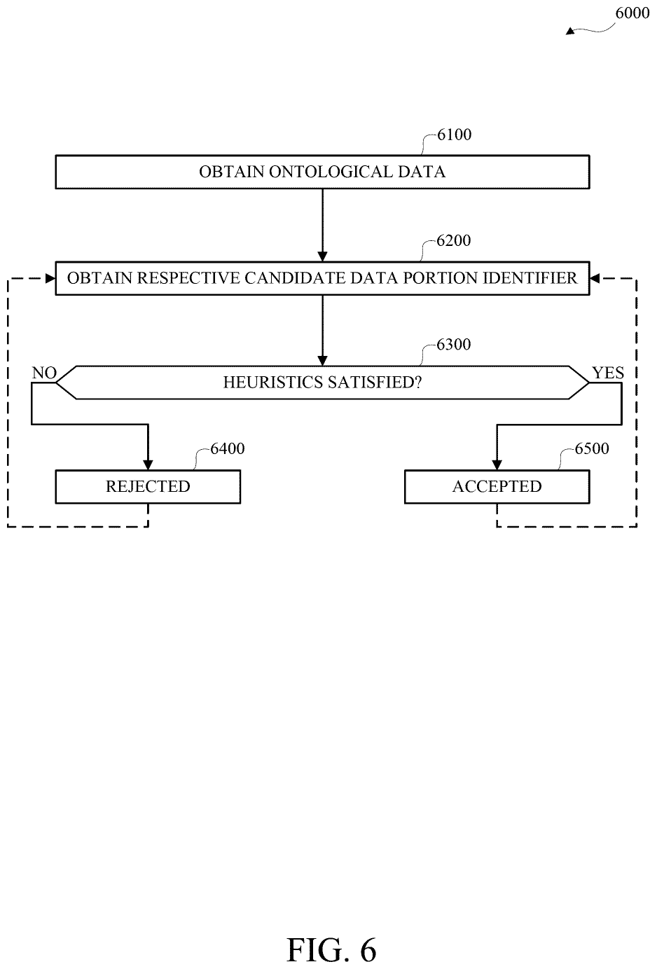

An example of obtaining the set of accepted candidate data portion identifiers, the set of rejected candidate data portion identifiers, or both, (at 5200), is shown in FIG. 6.

The data access and analysis system, or a component thereof, such as the relational analysis unit, determines whether the size (number, count, or cardinality) of the set of accepted candidate data portion identifiers (|accepted|) is less than the first defined maximum size (nx) (at 5210).

In response to determining that the size (number, count, or cardinality) of the set of accepted candidate data portion identifiers (|accepted|) is less than the first defined maximum size (nx) (at 5210), the data access and analysis system, or a component thereof, such as the relational analysis unit, includes a subset of the set of rejected candidate data portion identifiers, in descending data utility order, in the in the set of accepted candidate data portion identifiers (at 5220). The subset of the set of rejected candidate data portion identifiers has a size that is a difference between the size of the set of accepted candidate data portion identifiers (prior to including the subset of the set of rejected candidate data portion identifiers) and the first defined maximum size, such that the size of the set of accepted candidate data portion identifiers (subsequent to including the subset of the set of rejected candidate data portion identifiers) is the first defined maximum size.

In some implementations, the relational analysis unit sends, transmits, or otherwise makes available the set of accepted candidate data portion identifiers to another component of the data access and analysis system, such as the semantic interface.

In response to determining that the size (number, count, or cardinality) of the set of accepted candidate data portion identifiers (|accepted|) is the first defined maximum size (nx) (at 5210), or subsequent to including the subset of the set of rejected candidate data portion identifiers (at 5220), the data access and analysis system, or a component thereof, such as the semantic interface, determines whether the autonomous-analysis predicate data omits a second analytical object stored in the data access and analysis system as a representation of a subset, or collection, of analytical objects stored in the data access and analysis system, wherein the subset of analytical objects includes the predicate analytical object (at 5300).

In some implementations, instead of, or in addition to, determining whether the autonomous-analysis predicate data omits the second analytical object, the data access and analysis system, or a component thereof, such as the semantic interface, determines whether ontological data stored in the data access and analysis system omits a second analytical object stored in the data access and analysis system as a representation of a subset, or collection, of analytical objects stored in the data access and analysis system, wherein the subset of analytical objects includes the predicate analytical object (at 5300).

In response to determining that the autonomous-analysis predicate data (or the ontological data) omits a second analytical object stored in the data access and analysis system as a representation of a defined subset, or collection, of analytical objects stored in the data access and analysis system, wherein the subset of analytical objects includes the predicate analytical object (no at 5300), the data access and analysis system, or a component thereof, such as the semantic interface, includes the accepted candidate data portion identifiers in the first portion of the subset of data portion identifiers available in the data access and analysis system (at 5400). Subsequent to including the accepted candidate data portion identifiers in the first portion of the subset of data portion identifiers available in the data access and analysis system (at 5400) obtaining exploratory data 5000 may be otherwise omitted or skipped.

In response to determining that the autonomous-analysis predicate data (or the ontological data) includes, or indicates, the second analytical object stored in the data access and analysis system as a representation of a defined subset, or collection, of analytical objects stored in the data access and analysis system, wherein the subset of analytical objects includes the predicate analytical object (no at 5300), the data access and analysis system, or a component thereof, such as the semantic interface, obtains a collection of data portion identifiers indicated in ontological data for respective analytical objects from the subset of analytical objects (at 5500).

In some implementations, obtaining the collection of data portion identifiers (at 5500) may include the data access and analysis system, or a component thereof, such as the semantic interface, obtaining, such as from the relational analysis unit or another component of the data access and analysis system, a set of contextually available data portion identifiers for one or more contextually available data portions available in the data access and analysis system in accordance with the autonomous-analysis predicate data and the defined data-analytics grammar implemented by the data access and analysis system. The set of contextually available data portion identifiers includes the data portion identifiers that are included in the set of accepted candidate data portion identifiers.

In some implementations, obtaining the collection of data portion identifiers (at 5500) includes the data access and analysis system, or a component thereof, such as the semantic interface, obtaining, such as from a distributed in-memory ontology unit of the data access and analysis system, such as the distributed in-memory ontology unit 3500 shown in FIG. 3, ontological data for the analytical objects from the subset of analytical objects. The data access and analysis system, or a component thereof, such as the semantic interface, obtains, or identifies, a collection of data portion identifiers indicated in the ontological data for the respective analytical objects from the subset of analytical objects.

The data access and analysis system, or a component thereof, such as the semantic interface, generates, or otherwise obtains, co-occurrence frequency data (at 5600) for the collection of data portion identifiers. To obtain the co-occurrence frequency data for the collection of data portion identifiers, the data access and analysis system, or a component thereof, such as the semantic interface, may generate a co-occurrence frequency graph wherein nodes of the co-occurrence frequency graph represent the data portion identifiers from the collection of data portion identifiers and edges, or edge wights, of the co-occurrence frequency graph represent the number, count, or cardinality of analytical objects from the subset of analytical objects wherein a respective pair of data portion identifiers occurs (co-occurrence).

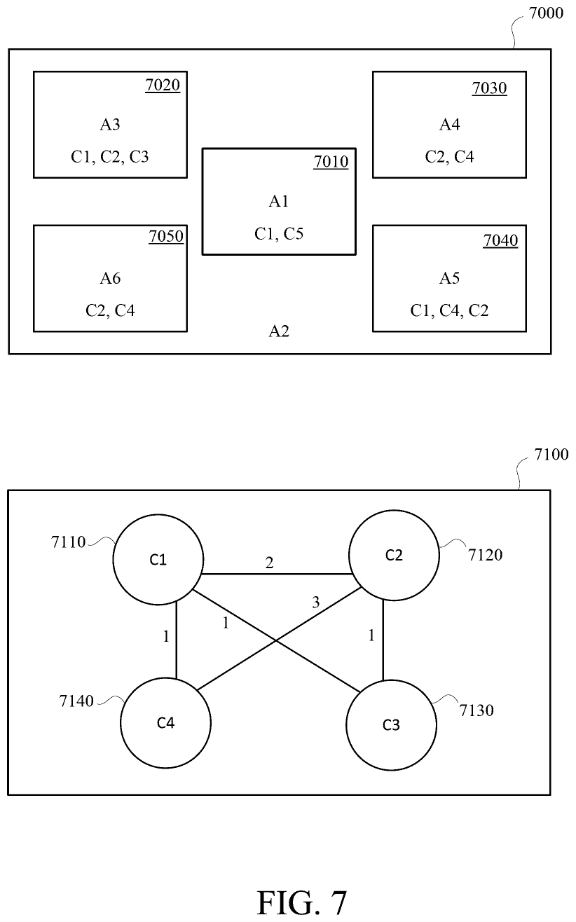

An example of a subset of analytical objects and a corresponding co-occurrence frequency graph is shown in FIG. 7.

In some implementations, the data access and analysis system, or a component thereof, such as the semantic interface, may remove, delete, or exclude data portion identifiers included in the ontological data for the predicate analytical object (A1) from the collection of data portion identifiers. For example, the data access and analysis system, or a component thereof, such as the semantic interface, may determine that the ontological data for the predicate analytical object (A1) indicates the first data portion (column) identifier (C1) and the data access and analysis system, or a component thereof, such as the semantic interface, may remove, delete, or exclude the first data portion (column) identifier (C1) from the collection of data portion identifiers. In some implementations, one or more of the data portion identifiers included in the ontological data for the predicate analytical object (A1) correspond to visualized data portions, wherein a visualization of the predicate analytical object (A1) includes a visualization of the visualized data portions, one or more of the data portion identifiers included in the ontological data for the predicate analytical object (A1) correspond to unvisualized data portions, wherein the visualization of the predicate analytical object (A1) omits a visualization of the unvisualized data portions, the data access and analysis system, or a component thereof, such as the semantic interface, removes, deletes, or excludes the visualized data portion identifiers from the collection of data portion identifiers and retains the unvisualized data portion identifiers in the collection of data portion identifiers.

In some implementations, removing, deleting, or excluding data portion identifiers included in the ontological data for the predicate analytical object (A1) from the collection of data portion identifiers may include determining whether the ontological data for the predicate analytical object (A1) indicates that a respective data portion identifier included in the ontological data for the predicate analytical object (A1) is filtered, in the predicate analytical object (A1), on one value or on more than one value.

In response to determining that the ontological data for the predicate analytical object (A1) indicates that a respective data portion identifier included in the ontological data for the predicate analytical object (A1) is filtered, in the predicate analytical object (A1), on one value, the data access and analysis system, or a component thereof, such as the semantic interface, removes, deletes, or excludes the respective data portion identifier from the collection of data portion identifiers. For example, the predicate analytical object (A1) may include the phrase “precipitation type=rain”, indicating a respective data portion identifier corresponding to a “precipitation type” column and filtered by the value “rain”, and the data access and analysis system, or a component thereof, such as the semantic interface, removes, deletes, or excludes the respective data portion identifier from the collection of data portion identifiers.

In response to determining that the ontological data for the predicate analytical object (A1) indicates that a respective data portion identifier included in the ontological data for the predicate analytical object (A1) is filtered, in the predicate analytical object (A1), on more than one value, the data access and analysis system, or a component thereof, such as the semantic interface, omits, skips, or avoids, removing, deleting, or excluding the respective data portion identifier from the collection of data portion identifiers. For example, the predicate analytical object (A1) may include the phrase “precipitation type=rain, snow”, indicating a respective data portion identifier corresponding to the “precipitation type” column and filtered by the value “rain” or the value “snow”, and the data access and analysis system, or a component thereof, such as the semantic interface, omits, skips, or avoids, removing, deleting, or excluding the respective data portion identifier from the collection of data portion identifiers.

To obtain the co-occurrence frequency data for the collection of data portion identifiers, the data access and analysis system, or a component thereof, such as the semantic interface, generates, calculates, determines, or otherwise obtains, co-occurrence pairs, wherein a respective co-occurrence pair from the co-occurrence pairs includes a first data portion identifier from the collection of data portion identifiers and a second data portion identifier from the collection of data portion identifiers. The co-occurrence pairs are unique and unordered.

To obtain the co-occurrence frequency data for the collection of data portion identifiers, the data access and analysis system, or a component thereof, such as the semantic interface, generates, calculates, determines, or otherwise obtains, co-occurrence frequency values for the respective co-occurrence pairs, such as in accordance with the co-occurrence frequency graph for the subset of analytical objects. The co-occurrence frequency value for a respective co-occurrence pair (corresponding co-occurrence frequency value) is a sum of the co-occurrences of the respective co-occurrence pair, such as is represented in the co-occurrence frequency graph as an edge weight.

To obtain the co-occurrence frequency data for the collection of data portion identifiers, the data access and analysis system, or a component thereof, such as the semantic interface, generates, calculates, determines, or otherwise obtains, obtaining co-occurrence frequency scores for the data portion identifiers from the collection of data portion identifiers, such as in accordance with the co-occurrence frequency graph for the subset of analytical objects. The co-occurrence frequency score for a respective data portion identifier (corresponding co-occurrence frequency score) from the collection of data portion identifiers indicates a sum of the co-occurrence frequency values for the co-occurrence pairs that include the respective data portion identifier, such as is represented in the co-occurrence frequency graph.

To obtain the co-occurrence frequency data for the collection of data portion identifiers, the data access and analysis system, or a component thereof, such as the semantic interface, ranks, orders, or sorts the co-occurrence frequency scores, and the corresponding data portion identifiers, in descending co-occurrence frequency score order.

In some implementations, the data access and analysis system, or a component thereof, such as the semantic interface, determines whether the predicate analytical object indicates a visualized chronometric (date) data portion. In response to determining that the predicate analytical object indicates a visualized chronometric (date) data portion, the data access and analysis system, or a component thereof, such as the semantic interface, may remove, delete, or exclude chronometric (date) data portion identifiers from the collection of data portion identifiers, the accepted candidate data portion identifiers, or both.

The data access and analysis system, or a component thereof, such as the semantic interface, obtains the second portion of the subset of data portion identifiers available in the data access and analysis system (at 5700) by including, in the second portion, a first subset of the collection of data portion identifiers in descending co-occurrence frequency score order, the first subset of the collection of data portion identifiers having a second defined maximum size, such as sixty percent of the first defined maximum size (0.6 nx).

The data access and analysis system, or a component thereof, such as the semantic interface, obtains the first portion of the subset of data portion identifiers available in the data access and analysis system (at 5800) by including, in the first portion, a subset of the accepted candidate data portion identifiers, in descending data utility order, the subset of the accepted candidate data portion identifiers having a third defined maximum size, such as forty percent of the first defined maximum size (0.4 nx). The first defined maximum size is a sum of the second defined maximum size and the third defined maximum size.

In some implementations, including the subset of the accepted candidate data portion identifiers in the first portion of the subset of data portion identifiers available in the data access and analysis system includes determining whether a respective data portion identifier from the subset of the accepted candidate data portion identifiers is included, or available, in the second portion of the subset of data portion identifiers available in the data access and analysis system. In response to determining that a respective data portion identifier from the subset of the accepted candidate data portion identifiers is included, or available, in the second portion of the subset of data portion identifiers available in the data access and analysis system, the data access and analysis system, or a component thereof, such as the semantic interface, skips, omits, excludes, or avoids including the respective data portion identifier from the subset of the accepted candidate data portion identifiers in the first portion of the subset of data portion identifiers available in the data access and analysis system.

To obtain the subset of data portion identifiers, the data access and analysis system, or a component thereof, such as the semantic interface, determines whether a sum of a size of the first portion and a size of the second portion is less than the first defined maximum size (at 5900).

To obtain the subset of data portion identifiers, in response to determining that the sum of the size of the first portion and the size of the second portion is less than the first defined maximum size, the data access and analysis system, or a component thereof, such as the semantic interface, includes, in the subset of data portion identifiers, a second subset of the collection of data portion identifiers in descending co-occurrence frequency score order (at 5910). The second subset of the collection of data portion identifiers has a fourth defined maximum size, wherein the fourth defined maximum size is a difference between the first defined maximum size and a sum of a size (number, count, or cardinality) of the first portion and a size (number, count, or cardinality) of the second portion. The second subset of the collection of data portion identifiers omits the data portion identifiers from the first subset of the collection of data portion identifiers.

In some implementations, in response to determining that the autonomous-analysis predicate data (or the ontological data) includes, or indicates, the second analytical object stored in the data access and analysis system as a representation of a defined subset, or collection, of analytical objects stored in the data access and analysis system, wherein the subset of analytical objects includes the predicate analytical object (no at 5300), the data access and analysis system, or a component thereof, such as the semantic interface, may determine whether the autonomous-analysis predicate data indicates, or identifies, one or more data portions, or columns, as key autonomous-analysis data portions, or columns, for the predicate analytical object (not expressly shown). In response to determining that the autonomous-analysis predicate data indicates, or identifies, one or more data portions, or columns, as key autonomous-analysis data portions, or columns, for the predicate analytical object, the data access and analysis system, or a component thereof, such as the semantic interface, identifies the key autonomous-analysis data portions as the second portion of the subset of data portion identifiers, and omits obtaining a collection of data portion identifiers indicated in ontological data for respective analytical objects from the subset of analytical objects (at 5500), co-occurrence frequency data (at 5600), obtaining the second portion of the subset of data portion identifiers available in the data access and analysis system (at 5700), determining whether a sum of a size of the first portion and a size of the second portion is less than the first defined maximum size (at 5900), and including in the subset of data portion identifiers a second subset of the collection of data portion identifiers in descending co-occurrence frequency score order (at 5910) (not expressly shown).

FIG. 6 is a flow diagram of an example of obtaining a set of accepted candidate data portion identifiers, a set of rejected candidate data portion identifiers, or both 6000 in a data access and analysis system. Obtaining the set of accepted candidate data portion identifiers, the set of rejected candidate data portion identifiers, or both 6000 may be implemented in a data access and analysis system, such as the data access and analysis system 3000 shown in FIG. 3. For example, the set of accepted candidate data portion identifiers, the set of rejected candidate data portion identifiers, or both 6000, or a portion thereof, may be implemented in a relational analysis unit of the data access and analysis system, such as the relational analysis unit 3700 shown in FIG. 3.

Obtaining the set of accepted candidate data portion identifiers, the set of rejected candidate data portion identifiers, or both 6000 includes obtaining the set of accepted candidate data portion identifiers, the set of rejected candidate data portion identifiers, or both by filtering a first set of candidate data portion identifiers, such as the first set of candidate data portion identifiers obtain as shown (at 5100) in FIG. 5, in accordance with the one or more defined data utility heuristics (heuristic based modification).

The defined data utility heuristics include one or more defined heuristics, or filtering rules, for determining whether to include respective candidate data portion identifiers from the first set of candidate data portion identifiers in the set of accepted candidate data portion identifiers or the set of rejected candidate data portion identifiers.

For example, the defined data utility heuristics may include a first defined data utility heuristic indicating a defined minimum cardinality of a corresponding data portion for a respective candidate data portion identifier to be included in the set of accepted candidate data portion identifiers, a defined maximum cardinality for a respective candidate data portion identifier to be included in the set of accepted candidate data portion identifiers, or both.

In another example, the defined data utility heuristics may include a second defined data utility heuristic indicating the identification of candidate data portion identifiers corresponding to candidate data portions, such as columns, previously indexed in the data access and analysis system for inclusion in the set of accepted candidate data portion identifiers.

Filtering the first set of candidate data portion identifiers includes obtaining previously stored ontological data (at 6100) for the candidate exploratory data portions corresponding to the first set of candidate data portion identifiers. Obtaining the previously indexed ontological data omits, avoids, or excludes requesting, or accessing, data from the data source, or database, wherein the candidate exploratory data portions are stored.

The previously indexed ontological data includes, for a respective candidate exploratory data portion, indexing status data, cardinality data, or both. In some implementations, metrics other than the indexing status data and the cardinality data may be used instead of, or in addition to the indexing status data, the cardinality data, or both.

The indexing status data indicates whether data previously indexed in the data access and analysis system includes the respective candidate exploratory data portion. Whether the candidate exploratory data portion is indexed in the data access and analysis system is separate and distinct from whether a corresponding column is indexed in the data source thereof such as in an external database or an internal database of the data access and analysis system, such as the distributed in-memory database 3300 shown in FIG. 3.

The cardinality of the candidate exploratory data portion indicates a number, or count, of distinct, or unique, values stored in a respective column, in the data source thereof, corresponding to the respective candidate exploratory data portion. For candidate exploratory data portions that are absent from the data indexed in the data access and analysis system, cardinality data may be unavailable or absent.

Filtering the first set of candidate data portion identifiers includes obtaining a respective (current) candidate data portion identifier (at 6200) from the first set of candidate data portion identifiers, such as in descending data utility order, such as in accordance with the data utility data included in the data indicating the candidate exploratory data portions (the first set of candidate data portion identifiers).

Filtering the first set of candidate data portion identifiers includes determining whether the defined data utility heuristics are satisfied for the respective candidate data portion identifier (at 6300).

In some implementations, determining whether the defined data utility heuristics are satisfied for the respective candidate data portion identifier (at 6300) may include determining whether a respective candidate exploratory data portion corresponding to the respective candidate data portion identifier is indexed in the data access and analysis system, such as in accordance with the corresponding indexing status data. In response to determining that the respective candidate exploratory data portion is absent from data indexed in the data access and analysis system, the data access and analysis system, or a component thereof, such as the relational analysis unit, includes the respective candidate exploratory data portion, or the corresponding respective candidate data portion identifier, in the set of rejected candidate data portion identifiers (at 6400).

In some implementations, determining whether the defined data utility heuristics are satisfied for the respective candidate data portion identifier (at 6300) may include determining whether the cardinality of a respective candidate exploratory data portion corresponding to the respective candidate data portion identifier is greater than or equal to a defined minimum cardinality, such as two (2). In response to determining that the cardinality of the respective candidate exploratory data portion is less than the defined minimum cardinality, the data access and analysis system, or a component thereof, such as the relational analysis unit, includes the respective candidate exploratory data portion in a set or list of rejected candidate data portion identifiers (at 6400).

In some implementations, determining whether the defined data utility heuristics are satisfied for the respective candidate data portion identifier (at 6300) may include determining whether the cardinality of a respective candidate exploratory data portion corresponding to the respective candidate data portion identifier is less than or equal to a defined maximum cardinality, such as 1000. In response to determining that the cardinality of the respective candidate exploratory data portion is greater than the defined maximum cardinality, the data access and analysis system, or a component thereof, such as the relational analysis unit, includes the respective candidate exploratory data portion in a set or list of rejected candidate data portion identifiers (at 6400).

Determining whether the cardinality of a respective candidate exploratory data portion corresponding to the respective candidate data portion identifier is greater than or equal to the defined minimum cardinality and less than or equal to the defined maximum cardinality may be expressed as the following:
defined minimum cardinality<=cardinality<=defined maximum cardinality.

In response to determining that that the respective candidate data portion identifier identifies a column that has a cardinality that is greater than or equal to the defined minimum cardinality and less than or equal to the defined maximum cardinality, the data access and analysis system, or a component thereof, such as the relational analysis unit, includes the respective candidate data portion identifier in the set of accepted candidate data portion identifiers (at 6500).

In some implementations, the previously indexed ontological data includes, for a respective candidate exploratory data portion, one or more sample values. Determining whether the defined data utility heuristics are satisfied for the respective candidate data portion identifier (at 6300) may include determining whether a sample value for the respective candidate exploratory data portion has a size, or length, such as a number or count of characters or symbols, which is greater than a defined maximum length, such as 250. Determining whether the defined data utility heuristics are satisfied for the respective candidate data portion identifier (at 6300) may include, in response to determining that a sample value for the respective candidate exploratory data portion has a size, or length, such as a number or count of characters or symbols, which is greater than the defined maximum length, including the respective candidate exploratory data portion in a set or list of rejected candidate data portion identifiers (at 6400).

In some implementations, other heuristics may be used. For example, in some implementations, candidate exploratory data portions including geospatial data, such as longitude, latitude, or both, may be included in the set or list of rejected candidate data portion identifiers.

Obtaining a respective (current) candidate data portion identifier (at 6200), determining whether the defined data utility heuristics are satisfied for the respective candidate data portion identifier (at 6300), and includes a respective candidate exploratory data portion in the set of rejected candidate data portion identifiers (at 6400) or the set of accepted candidate data portion identifiers (at 6500), may be performed, such as iteratively, for the first set of candidate data portion identifiers, such as on a per candidate data portion identifier basis, as indicated by the broken directional lines from including a respective candidate exploratory data portion in the set of rejected candidate data portion identifiers (at 6400) or the set of accepted candidate data portion identifiers (at 6500) to obtaining a respective (current) candidate data portion identifier (at 6200).

FIG. 7 is a block diagram of an example of a subset of analytical objects 7000 and a co-occurrence frequency graph 7100 corresponding thereto.

The subset of analytical objects 7000, indicated by the ontological data for the second analytical object (A2), includes the predicate analytical object (A1) 7010, a third analytical object (A3) 7020, a fourth analytical object (A4) 7030, a fifth analytical object (A5) 7040, and a sixth analytical object (A6) 7050.

The ontological data for the third analytical object (A3) 7020 indicates a first data portion (column) identifier (C1), a second data portion (column) identifier (C2), and a third data portion (column) identifier (C3).

The ontological data for the fourth analytical object (A4) 7030 indicates the second data portion (column) identifier (C2) and a fourth data portion (column) identifier (C4).

The ontological data for the fifth analytical object (A5) 7040 indicates the first data portion (column) identifier (C1), the fourth data portion (column) identifier (C4), and the second data portion (column) identifier (C2).

The ontological data for the sixth analytical object (A6) 7050 indicates the second data portion (column) identifier (C2) and fourth data portion (column) identifier (C4).

The co-occurrence frequency graph 7100, corresponding to the subset of analytical objects 7000, includes a first node 7110 representing the first data portion (column) identifier (C1), a second node 7120 representing the second data portion (column) identifier (C2), a third node 7130 representing the third data portion (column) identifier (C3), and a fourth node 7140 representing the fourth data portion (column) identifier (C4).

The co-occurrence frequency graph 7100 includes a first edge between the first node 7110 and the second node 7120 having an edge weight of two (2), indicating a co-occurrence of the first data portion (column) identifier (C1) and the second data portion (column) identifier (C2) (a co-occurrence pair {C1, C2}) in the third analytical object (A3) 7020 and a co-occurrence thereof in the fifth analytical object (A5) 7040.

The co-occurrence frequency graph 7100 includes a second edge between the first node 7110 and the third node 7130 having an edge weight of one (1), indicating a co-occurrence of the first data portion (column) identifier (C1) and the third data portion (column) identifier (C3) (a co-occurrence pair {C1, C3}) in the third analytical object (A3) 7020.

The co-occurrence frequency graph 7100 includes a third edge between the first node 7110 and the fourth node 7140 having an edge weight of one (1), indicating a co-occurrence of the first data portion (column) identifier (C1) and the fourth data portion (column) identifier (C4) (a co-occurrence pair {C1, C4}) in the fifth analytical object (A5) 7040.

The co-occurrence frequency graph 7100 includes a fourth edge between the second node 7120 and the third node 7130 having an edge weight of one (1), indicating a co-occurrence of the second data portion (column) identifier (C2) and the third data portion (column) identifier (C3) (a co-occurrence pair {C2, C3}) in the third analytical object (A3) 7020.

The co-occurrence frequency graph 7100 includes a fifth edge between the second node 7120 and the fourth node 7140 having an edge weight of three (3), indicating a co-occurrence of the second data portion (column) identifier (C2) and the fourth data portion (column) identifier (C4) (a co-occurrence pair {C2, C4}) in the fourth analytical object (A4) 7030, a co-occurrence thereof in the fifth analytical object (A5) 7040, and a co-occurrence thereof in the sixth analytical object (A6) 7050.

A co-occurrence frequency score for the first node 7110 and the first data portion (column) identifier (C1) is four (4), which is a sum of the edge weight of two (2) for the first edge between the first node 7110 and the second node 7120, the edge weight of one (1) for the second edge between the first node 7110 and the third node 7130, and the edge weight of one (1) for the third edge between the first node 7110 and the fourth node 7140.

A co-occurrence frequency score for the second node 7120 and the second data portion (column) identifier (C2) is five (5), which is a sum of the edge weight of two (2) for the first edge between the first node 7110 and the second node 7120, the edge weight of one (1) for the fourth edge between the second node 7120 and the third node 7130, and the edge weight of three (3) for the fifth edge between the second node 7120 and the fourth node 7140.

A co-occurrence frequency score for the third node 7130 and the third data portion (column) identifier (C3) is two (2), which is a sum of the edge weight of one (1) for the fourth edge between the second node 7120 and the third node 7130, and the edge weight of one (1) for the second edge between the first node 7110 and the third node 7130.

A co-occurrence frequency score for the fourth node 7140 and the fourth data portion (column) identifier (C4) is four (4), which is a sum of the edge weight of one (1) for the third edge between the first node 7110 and the fourth node 7140, and the edge weight of three (3) for the fifth edge between the second node 7120 and the fourth node 7140.

The second data portion (column) identifier (C2) has the highest co-occurrence frequency score (5) and the highest rank.

The first data portion (column) identifier (C1) has the second highest co-occurrence frequency score (4) and the second highest rank.

The fourth data portion (column) identifier (C4) has the third highest co-occurrence frequency score (4) and the third highest rank.

The third data portion (column) identifier (C3) has the fourth highest co-occurrence frequency score (5) and the fourth highest rank.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read only memories (ROM), one or more random-access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, which may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “determine,” “identify,” “obtain,” and “form” or any variations thereof, includes selecting, ascertaining, computing, looking up, receiving, determining, establishing, obtaining, or otherwise identifying or determining in any manner whatsoever using one or more of the devices and methods shown and described herein.

As used herein, the term “computing device” includes any unit, or combination of units, capable of performing any method, or any portion or portions thereof, disclosed herein.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, the terminology “domain,” or variations thereof, indicates a distinctly identifiable subset of a set; the terminology “domain-specific,” or variations thereof, indicates a limiting association with a distinctly identifiable subset of a set.

As used herein, the terminology “tensor” indicates an array of numbers, or an array of arrays of numbers, in n-dimensional space. As used herein, the terminology “scalar” indicates a zero-dimensional tensor, containing a single number. As used herein, the terminology “vector” indicates a one-dimensional, first-degree, or first-order, tensor, containing multiple scalars of a type of data. As used herein, the terminology “tuple” indicates a first-order tensor containing scalars of more than one type of data. As used herein, the terminology “matrix” indicates a two-dimensional, second rank, or second-order, tensor, containing multiple vectors of a type of data.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to compact disks (CDs), digital video disks (DVDs), wireless, wireline, optical fiber cable, radio frequency (RF), etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Attributes may comprise any data characteristic, category, content, etc. that in one example may be non-quantifiable or non-numeric. Measures may comprise quantifiable numeric values such as sizes, amounts, degrees, etc. For example, a first column containing the names of states may be considered an attribute column and a second column containing the numbers of orders received for the different states may be considered a measure column.

Aspects of the present embodiments are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a computer, such as a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
obtaining, by an autonomous-analysis unit of a data access and analysis system, autonomous-analysis data in accordance with autonomous-analysis predicate data, wherein the autonomous-analysis predicate data indicates a predicate analytical object stored in the data access and analysis system as a representation of a request for data analysis with respect to data stored in a database accessible by the data access and analysis system, wherein the autonomous-analysis data differs from requested results data responsive to the request for data analysis, and wherein obtaining the autonomous-analysis data includes:
obtaining, as exploratory data portion identifiers, a subset of data portion identifiers available in the data access and analysis system, wherein obtaining the subset of data portion identifiers includes:
obtaining, by a relational analysis unit of the data access and analysis system, a first portion of the subset of data portion identifiers in accordance with the request for data analysis, data portion utility data stored in the data access and analysis system, and one or more defined utility heuristics; and
obtaining the autonomous-analysis data in accordance with the exploratory data portion identifiers; and
outputting at least a portion of the autonomous-analysis data for presentation to a user.

2. The method of claim 1, wherein obtaining the first portion comprises:
obtaining, from a data utility unit of the data access and analysis system, in accordance with the request for data analysis and the data portion utility data, a first set of candidate data portion identifiers available in the data access and analysis system, wherein the first set has a defined target size.

3. The method of claim 2, wherein obtaining the first portion comprises:
obtaining the first portion from the first set by filtering the first set in accordance with the one or more defined utility heuristics.

4. The method of claim 3, wherein:
the subset of data portion identifiers has a first defined maximum size; and
filtering the first set comprises filtering the first set in accordance with a first defined utility heuristic from the one or more defined utility heuristics by:
for a respective candidate data portion identifier from the first set in descending data utility order:
in response to a determination that the respective candidate data portion identifier identifies a column that has a cardinality that is greater than or equal to a defined minimum cardinality and less than or equal to a defined maximum cardinality, including the respective candidate data portion identifier in a set of accepted candidate data portion identifiers; and
in response to a determination that the respective candidate data portion identifier identifies a column that has a cardinality that is less than the defined minimum cardinality or greater than the defined maximum cardinality, including the respective candidate data portion identifier in a set of rejected candidate data portion identifiers.

5. The method of claim 4, wherein obtaining the first portion comprises:
in response to a determination that a size of the set of accepted candidate data portion identifiers is less than the first defined maximum size, including in the set of accepted candidate data portion identifiers a subset of the set of rejected candidate data portion identifiers in descending data utility order, wherein the subset of the set of rejected candidate data portion identifiers has a size that is a difference between the size of the set of accepted candidate data portion identifiers and the first defined maximum size.

6. The method of claim 4, wherein:
the autonomous-analysis predicate data omits a second analytical object stored in the data access and analysis system as a representation of a defined subset of analytical objects stored in the data access and analysis system, wherein the defined subset of analytical objects includes the predicate analytical object; and
obtaining the first portion comprises including the set of accepted candidate data portion identifiers in the first portion.

7. The method of claim 4, wherein:
the autonomous-analysis predicate data includes a second analytical object stored in the data access and analysis system as a representation of a defined subset of analytical objects stored in the data access and analysis system, wherein the defined subset of analytical objects includes the predicate analytical object; and
obtaining the subset of data portion identifiers comprises obtaining, by a semantic interface of the data access and analysis system, a second portion of the subset of data portion identifiers in accordance with co-occurrence frequency data for the data portion identifiers.

8. The method of claim 7, wherein obtaining the second portion comprises:
obtaining, from the relational analysis unit of the data access and analysis system, a set of contextually available data portion identifiers for one or more contextually available data portions available in the data access and analysis system in accordance with the autonomous-analysis predicate data;
obtaining, from a distributed in-memory ontology unit of the data access and analysis system, a collection of data portion identifiers indicated in ontological data for respective analytical objects from the defined subset of analytical objects; and
obtaining the co-occurrence frequency data by:
obtaining co-occurrence pairs, wherein a respective co-occurrence pair from the co-occurrence pairs includes a first data portion identifier from the collection of data portion identifiers and a second data portion identifier from the collection of data portion identifiers;
obtaining co-occurrence frequency values for the co-occurrence pairs, wherein, for a respective co-occurrence pair from the co-occurrence pairs, a corresponding co-occurrence frequency value indicates a count of analytical objects from the defined subset of analytical objects, other than the predicate analytical object, for which the ontological data indicates the respective co-occurrence pair; and
obtaining co-occurrence frequency scores for the data portion identifiers from the collection of data portion identifiers, wherein, for a respective data portion identifier from the collection of data portion identifiers, a corresponding co-occurrence frequency score indicates a sum of the co-occurrence frequency values for the co-occurrence pairs that include the respective data portion identifier.

9. The method of claim 8, wherein:
obtaining the second portion comprises including, in the second portion, a first subset of the collection of data portion identifiers in descending co-occurrence frequency score order, wherein the first subset of the collection of data portion identifiers has a second defined maximum size;
obtaining the first portion comprises including, in the first portion, a subset of the set of accepted candidate data portion identifiers in descending data utility order, wherein the subset of the set of accepted candidate data portion identifiers has a third defined maximum size, wherein the first defined maximum size is a sum of the second defined maximum size and the third defined maximum size;
determining whether a sum of a size of the first portion and a size of the second portion is less than the first defined maximum size; and
in response to determining that the sum of the size of the first portion and the size of the second portion is less than the first defined maximum size, obtaining the subset of data portion identifiers comprises including, in the subset of data portion identifiers, a second subset of the collection of data portion identifiers in descending co-occurrence frequency score order, wherein the second subset of the collection of data portion identifiers has a fourth defined maximum size, wherein the fourth defined maximum size is a difference between the first defined maximum size and a sum of a size of the first portion and a size of the second portion.

10. A non-transitory computer-readable storage medium, comprising executable instructions that, when executed by a processor, facilitate performance of operations, comprising:
obtaining, by an autonomous-analysis unit of a data access and analysis system, autonomous-analysis data in accordance with autonomous-analysis predicate data, wherein the autonomous-analysis predicate data indicates a predicate analytical object stored in the data access and analysis system as a representation of a request for data analysis with respect to data stored in a database accessible by the data access and analysis system, wherein the autonomous-analysis data differs from requested results data responsive to the request for data analysis, and wherein obtaining the autonomous-analysis data includes:
obtaining, as exploratory data portion identifiers, a subset of data portion identifiers available in the data access and analysis system, wherein obtaining the subset of data portion identifiers includes:
obtaining, by a relational analysis unit of the data access and analysis system, a first portion of the subset of data portion identifiers in accordance with the request for data analysis, data portion utility data stored in the data access and analysis system, and one or more defined utility heuristics; and
obtaining the autonomous-analysis data in accordance with the exploratory data portion identifiers; and
outputting at least a portion of the autonomous-analysis data for presentation to a user.

11. The non-transitory computer-readable storage medium of claim 10, wherein obtaining the first portion includes:
obtaining, from a data utility unit of the data access and analysis system, in accordance with the request for data analysis and the data portion utility data, a first set of candidate data portion identifiers available in the data access and analysis system, wherein the first set has a defined target size.

12. The non-transitory computer-readable storage medium of claim 11, wherein obtaining the first portion includes:
obtaining the first portion from the first set by filtering the first set in accordance with the one or more defined utility heuristics, wherein filtering the first set comprises filtering the first set in accordance with a first defined utility heuristic from the one or more defined utility heuristics by:
for a respective candidate data portion identifier from the first set in descending data utility order:
in response to a determination that the respective candidate data portion identifier identifies a column that has a cardinality that is greater than or equal to a defined minimum cardinality and less than or equal to a defined maximum cardinality, including the respective candidate data portion identifier in a set of accepted candidate data portion identifiers; and
in response to a determination that the respective candidate data portion identifier identifies a column that has a cardinality that is less than the defined minimum cardinality or greater than the defined maximum cardinality, including the respective candidate data portion identifier in a set of rejected candidate data portion identifiers.

13. The non-transitory computer-readable storage medium of claim 12, wherein:
the subset of data portion identifiers has a first defined maximum size;
obtaining the first portion includes, in response to a determination that a size of the set of accepted candidate data portion identifiers is less than the first defined maximum size, including in the set of accepted candidate data portion identifiers a subset of the set of rejected candidate data portion identifiers in descending data utility order, wherein the subset of the set of rejected candidate data portion identifiers has a size that is a difference between the size of the set of accepted candidate data portion identifiers and the first defined maximum size;
the autonomous-analysis predicate data omits a second analytical object stored in the data access and analysis system as a representation of a defined subset of analytical objects stored in the data access and analysis system, wherein the defined subset of analytical objects includes the predicate analytical object; and
obtaining the first portion comprises including the set of accepted candidate data portion identifiers in the first portion.

14. The non-transitory computer-readable storage medium of claim 10, wherein:
the autonomous-analysis predicate data includes a second analytical object stored in the data access and analysis system as a representation of a defined subset of analytical objects stored in the data access and analysis system, wherein the defined subset of analytical objects includes the predicate analytical object;
obtaining the subset of data portion identifiers comprises obtaining, by a semantic interface of the data access and analysis system, a second portion of the subset of data portion identifiers in accordance with co-occurrence frequency data for the data portion identifiers, wherein obtaining the second portion comprises:
obtaining, from the relational analysis unit of the data access and analysis system, a set of contextually available data portion identifiers for one or more contextually available data portions available in the data access and analysis system in accordance with the autonomous-analysis predicate data;
obtaining, from a distributed in-memory ontology unit of the data access and analysis system, a collection of data portion identifiers indicated in ontological data for respective analytical objects from the defined subset of analytical objects; and
obtaining the co-occurrence frequency data by:
obtaining co-occurrence pairs, wherein a respective co-occurrence pair from the co-occurrence pairs includes a first data portion identifier from the collection of data portion identifiers and a second data portion identifier from the collection of data portion identifiers;
obtaining co-occurrence frequency values for the co-occurrence pairs, wherein, for a respective co-occurrence pair from the co-occurrence pairs, a corresponding co-occurrence frequency value indicates a count of analytical objects from the defined subset of analytical objects, other than the predicate analytical object, for which the ontological data indicates the respective co-occurrence pair; and
obtaining co-occurrence frequency scores for the data portion identifiers from the collection of data portion identifiers, wherein, for a respective data portion identifier from the collection of data portion identifiers, a corresponding co-occurrence frequency score indicates a sum of the co-occurrence frequency values for the co-occurrence pairs that include the respective data portion identifier.

15. The non-transitory computer-readable storage medium of claim 14, wherein:
obtaining the second portion comprises obtaining the second portion comprises including, in the second portion, a first subset of the collection of data portion identifiers in descending co-occurrence frequency score order, wherein the first subset of the collection of data portion identifiers has a second defined maximum size;
obtaining the first portion comprises including, in the first portion, a subset of the set of accepted candidate data portion identifiers in descending data utility order, wherein the subset of the set of accepted candidate data portion identifiers has a third defined maximum size, wherein the first defined maximum size is a sum of the second defined maximum size and the third defined maximum size;
determining whether a sum of a size of the first portion and a size of the second portion is less than the first defined maximum size; and
in response to determining that the sum of the size of the first portion and the size of the second portion is less than the first defined maximum size, obtaining the subset of data portion identifiers comprises including, in the subset of data portion identifiers, a second subset of the collection of data portion identifiers in descending co-occurrence frequency score order, wherein the second subset of the collection of data portion identifiers has a fourth defined maximum size, wherein the fourth defined maximum size is a difference between the first defined maximum size and a sum of a size of the first portion and a size of the second portion.

16. An apparatus for use in a data access and analysis system, the apparatus comprising:
a non-transitory computer readable medium; and
a processor configured to execute instructions stored on the non-transitory computer readable medium to:
obtain autonomous-analysis data in accordance with autonomous-analysis predicate data, wherein the autonomous-analysis predicate data indicates a predicate analytical object stored in the data access and analysis system as a representation of a request for data analysis with respect to data stored in a database accessible by the data access and analysis system, wherein the autonomous-analysis data differs from requested results data responsive to the request for data analysis, and wherein, to obtain the autonomous-analysis data, the processor is configured to execute the instructions to:
obtain, as exploratory data portion identifiers a subset of data portion identifiers available in the data access and analysis system, wherein the subset of data portion identifiers has a first defined maximum size, wherein, to obtain the subset of data portion identifiers, the processor is configured to execute the instructions to:
obtain a first portion of the subset of data portion identifiers in accordance with the request for data analysis, data portion utility data stored in the data access and analysis system, and one or more defined utility heuristics; and
obtain the autonomous-analysis data in accordance with the exploratory data portion identifiers; and
output at least a portion of the autonomous-analysis data for presentation to a user.

17. The apparatus of claim 16, wherein, to obtain the first portion, the processor is configured to execute the instructions to:
obtain, in accordance with the request for data analysis and the data portion utility data, a first set of candidate data portion identifiers available in the data access and analysis system, wherein the first set has a defined target size.

18. The apparatus of claim 17, wherein, to obtain the first portion, the processor is configured to execute the instructions to:
obtain the first portion from the first set, wherein, to obtain the first portion from the first set, the processor is configured to execute the instructions to filter the first set in accordance with the one or more defined utility heuristics, wherein, to filter the first set, the processor is configured to execute the instructions to filter the first set in accordance with a first defined utility heuristic from the one or more defined utility heuristics, wherein, to filter the first set in accordance with the first defined utility heuristic, the processor is configured to execute the instructions to:
for a respective candidate data portion identifier from the first set in descending data utility order:
in response to a determination that the respective candidate data portion identifier identifies a column that has a cardinality that is greater than or equal to a defined minimum cardinality or less than or equal to a defined minimum cardinality, include the respective candidate data portion identifier in a set of accepted candidate data portion identifiers; and
in response to a determination that the respective candidate data portion identifier identifies a column that has a cardinality that is less than the defined minimum cardinality or greater than the defined minimum cardinality, include the respective candidate data portion identifier in a set of rejected candidate data portion identifiers.

19. The apparatus of claim 18, wherein the autonomous-analysis predicate data omits a second analytical object stored in the data access and analysis system as a representation of a defined subset of analytical objects stored in the data access and analysis system, wherein the defined subset of analytical objects includes the predicate analytical object, and wherein, to obtain the first portion, the processor is configured to execute the instructions to:
in response to a determination that a size of the set of accepted candidate data portion identifiers is less than the first defined maximum size, include in the set of accepted candidate data portion identifiers a subset of the set of rejected candidate data portion identifiers in descending data utility order, wherein the subset of the set of rejected candidate data portion identifiers has a size that is a difference between the size of the set of accepted candidate data portion identifiers and the first defined maximum size; and
include the set of accepted candidate data portion identifiers in the first portion.

20. The apparatus of claim 16, wherein:
the autonomous-analysis predicate data includes a second analytical object stored in the data access and analysis system as a representation of a defined subset of analytical objects stored in the data access and analysis system, wherein the defined subset of analytical objects includes the predicate analytical object;
to obtain the subset of data portion identifiers, the processor is configured to execute the instructions to obtain a second portion of the subset of data portion identifiers in accordance with co-occurrence frequency data for the data portion identifiers;
to obtain the second portion, the processor is configured to execute the instructions to:
obtain a set of contextually available data portion identifiers for one or more contextually available data portions available in the data access and analysis system in accordance with the autonomous-analysis predicate data;
obtain a collection of data portion identifiers indicated in ontological data for respective analytical objects from the defined subset of analytical objects; and
obtain the co-occurrence frequency data, wherein, to obtain the co-occurrence frequency data, the processor is configured to execute the instructions to:
obtain co-occurrence pairs, wherein a respective co-occurrence pair from the co-occurrence pairs includes a first data portion identifier from the collection of data portion identifiers and a second data portion identifier from the collection of data portion identifiers;
obtain co-occurrence frequency values for the co-occurrence pairs, wherein, for a respective co-occurrence pair from the co-occurrence pairs, a corresponding co-occurrence frequency value indicates a count of analytical objects from the defined subset of analytical objects, other than the predicate analytical object, for which the ontological data indicates the respective co-occurrence pair; and
obtain co-occurrence frequency scores for the data portion identifiers from the collection of data portion identifiers, wherein, for a respective data portion identifier from the collection of data portion identifiers, a corresponding co-occurrence frequency score indicates a sum of the co-occurrence frequency values for the co-occurrence pairs that include the respective data portion identifier; and
include, in the second portion, a first subset of the collection of data portion identifiers in descending co-occurrence frequency score order, wherein the first subset of the collection of data portion identifiers has a second defined maximum size;
to obtain the first portion, the processor is configured to execute the instructions to include, in the first portion, a subset of the set of accepted candidate data portion identifiers in descending data utility order, wherein the subset of the set of accepted candidate data portion identifiers has a third defined maximum size, wherein the first defined maximum size is a sum of the second defined maximum size and the third defined maximum size; and
to obtain the autonomous-analysis data, the processor is configured to execute the instructions to:
determine whether a sum of a size of the first portion and a size of the second portion is less than the first defined maximum size; and
in response to a determination that the sum of the size of the first portion and the size of the second portion is less than the first defined maximum size, include, in the subset of data portion identifiers, a second subset of the collection of data portion identifiers in descending co-occurrence frequency score order, wherein the second subset of the collection of data portion identifiers has a fourth defined maximum size, wherein the fourth defined maximum size is a difference between the first defined maximum size and a sum of a size of the first portion and a size of the second portion.
